(19) United States
(12) Patent Application Publication
(10) Pub. No.: US 2026/0116081 A1
(43) Pub. Date: Apr. 30, 2026

(54) LIQUID SUPPLY APPARATUS, SYSTEM, CONTROL METHOD, AND NON-TRANSITORY COMPUTER-READABLE STORAGE MEDIUM

(71) Applicant: CANON KABUSHIKI KAISHA, Tokyo (JP)

(72) Inventors: RYOHEI MARUYAMA, Kanagawa (JP); HIROMASA YONEYAMA, Kanagawa (JP); MASAKAZU NAGASHIMA, Kanagawa (JP); KENTA IIMURA, Tokyo (JP); KEIICHI KITANO, Kanagawa (JP); YUJIRO ISHIDA, Tokyo (JP); SHU KURIHARA, Tokyo (JP); RYUTARO TAKAHASHI, Tokyo (JP)

(21) Appl. No.: 19/362,208

(22) Filed: Oct. 17, 2025

(30) Foreign Application Priority Data
Oct. 29, 2024 (JP) 2024-190075
Oct. 31, 2024 (JP) 2024-192416

(51) Int. Cl. B41J 2/20; B01F 31/31; B01F 35/21; B01F 35/22; B01F 35/221; B01F 35/222; B01F 35/513; B01F 101/35; B41J 2/175; B41J 2/195; B41J 29/377

(52) U.S. Cl. CPC B41J 2/20; B01F 31/31; B01F 35/2115; B01F 35/2209; B01F 35/221422; B01F 35/22161; B01F 35/222; B01F 35/513; B41J 2/17513; B41J 2/17553; B41J 2/195; B41J 29/377; B01F 2101/35; B41J 2002/17516

(57) ABSTRACT

A liquid supply apparatus includes a holding unit configured to hold a container that contains a liquid, a stirring unit configured to stir the liquid, and a control unit configured to control the stirring unit based on air temperature information.

### BACKGROUND

### Field of the Technology

The present disclosure relates to a liquid supply apparatus.

### Description of the Related Art

In some cases, a liquid containing a substance with sedimentability needs to be stirred to dispersion a sediment at the time of use. For example, in a printing apparatus that performs printing by discharging ink to a print medium, when using ink such as pigment ink or metallic ink, the stirring may be needed to disperse a sediment. Japanese Patent Laid-Open No. 2018-1443 discloses an apparatus that presses a container portion storing ink, thereby stirring the contained ink. Japanese Patent No. 6567186 discloses an apparatus that rotates an ink cartridge, thereby stirring ink.

The fluidity of a liquid is affected by a temperature. A variation may occur in the evenness of the liquid by stirring in accordance with the apparatus installation environment.

### SUMMARY

The present disclosure provides a technique of improving the evenness of a liquid by stirring.

According to one aspect of the present disclosure, there is provided a liquid supply apparatus comprising: a holding unit configured to hold a container that contains a liquid; a stirring unit configured to stir the liquid; and a control unit configured to control the stirring unit based on air temperature information.

Features of the present disclosure will become apparent from the following description of embodiments with reference to the attached drawings. The following description of embodiments are described by way of example.

### BRIEF DESCRIPTION OF THE DRAWINGS

FIG. 1 is a perspective view of a system according to an embodiment of the present disclosure;

FIG. 2 is a front view of the system shown in FIG. 1;

FIG. 3 is an explanatory view of the internal structure of a liquid discharge apparatus;

FIG. 4 is a partially exploded perspective view of a liquid supply apparatus;

FIG. 5 is a perspective view of a liquid container and a support unit;

FIG. 6 is an operation explanatory view of a handle and a regulating mechanism;

FIG. 7 is an operation explanatory view of the regulating mechanism;

FIG. 8 is a view showing the attachment posture and the insertion/removal mode of the support unit for a storage portion;

FIG. 9 is an operation explanatory view of a stirring unit;

FIG. 10 is an operation explanatory view of the stirring unit;

FIG. 11 is an explanatory view of a cam;

FIG. 12 is a perspective view of a case with a stirring function and the support unit in a separated state;

FIG. 13 is a perspective view of the case with the stirring function and the support unit in an attached state;

FIG. 14 is an explanatory view of a stirring operation;

FIG. 15 is an explanatory view of the stirring operation;

FIG. 16 is a front view of a storage portion having a box shape;

FIG. 17 is a perspective view of the liquid container and the support unit;

FIG. 18 is a perspective view of the stirring unit;

FIG. 19 is a perspective view of the stirring unit;

FIG. 20 is a front view of a container space;

FIG. 21 is a view showing the containing mode of a container support unit;

FIG. 22 is a front view of the stirring unit;

FIG. 23 is a perspective view of the rear portion of the stirring unit;

FIG. 24 is a view showing an example of the stirring operation;

FIG. 25 is a block diagram of the control circuit of the system shown in FIG. 1;

FIG. 26 is a flowchart showing an example of control;

FIG. 27A is a flowchart showing an example of control;

FIGS. 27B and 27C are views showing examples of stirring conditions;

FIG. 28 is a flowchart showing an example of control;

FIG. 29A is a view showing an example of the arrangement of a liquid temperature sensor;

FIGS. 29B and 29C are flowcharts showing examples of control;

FIGS. 30A and 30B are flowcharts showing an example of control;

FIG. 31A is a flowchart showing an example of control;

FIG. 31B is a view showing an example of stirring conditions;

FIG. 32 is a view showing another example of the liquid supply apparatus;

FIG. 33 is a flowchart showing an example of processing executed by a control unit;

FIG. 34 is a perspective view of a liquid supply apparatus according to another embodiment;

FIG. 35 is an explanatory view showing the internal structure of the liquid supply apparatus shown in FIG. 34;

FIG. 36 is a preferably of a liquid container;

FIG. 37 is a perspective view of a tray;

FIG. 38 is a perspective view of a tray;

FIG. 39 is a perspective view of a lock mechanism;

FIGS. 40A to 40C are operation explanatory views of the lock mechanism shown in FIG. 39;

FIG. 41 is a perspective view of a tray on which a liquid container is placed;

FIG. 42 is a front view of the connecting portion of the liquid container;

FIG. 43 is a view of the tray on which the liquid container is placed, which is viewed from the side of a rear wall portion;

FIG. 44 is a preferably of the periphery of a tray holding portion;

FIG. 45 is a perspective view of a connecting unit;

FIGS. 46A and 46B are operation explanatory views of a driving unit;

FIGS. 47A and 47B are operation explanatory views of a driving unit;

FIG. 48 is a view showing the posture of a liquid container at a maximum rotation position;

FIG. 49 is a flowchart showing an example of processing executed by a control unit; and

FIGS. 50A to 50C are views showing another example of the configuration of a stirring mechanism.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

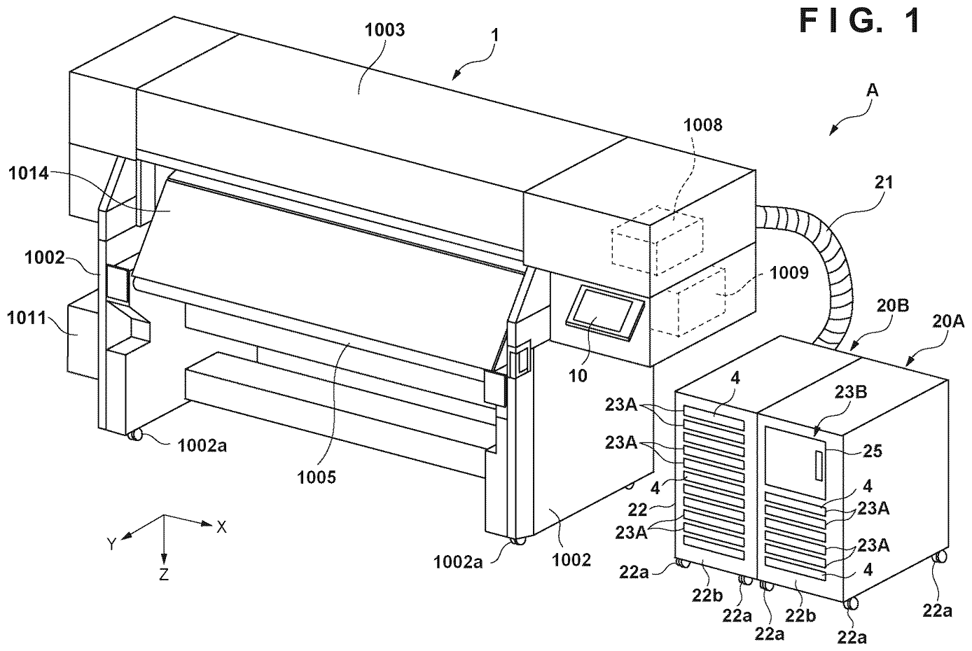

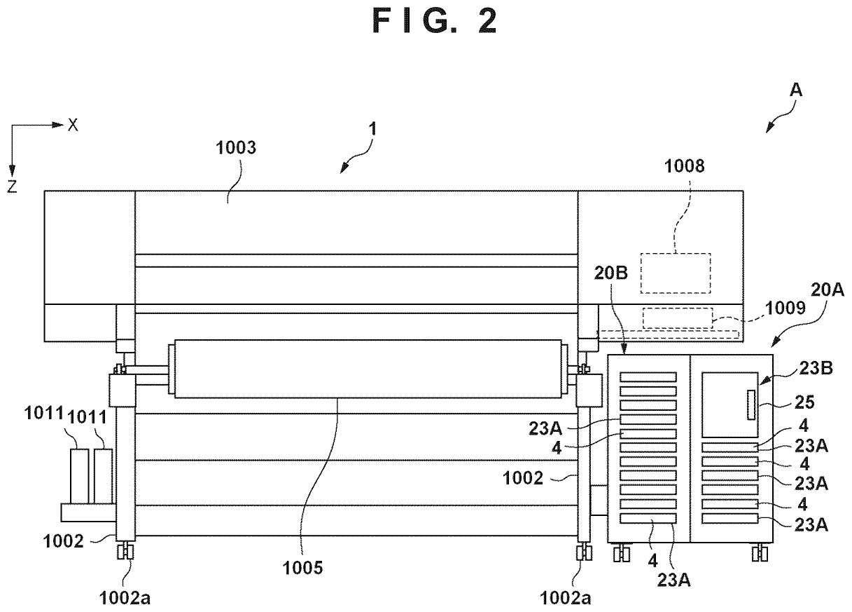

FIG. 1 is a perspective view of a system A according to an embodiment of the present disclosure, and FIG. 2 is a front view of the system A. In the drawings, arrows X, Y, and Z indicate directions crossing each other, and in this embodiment, the directions are orthogonal to each other. The left/right direction in a case where the system A is installed on a horizontal surface is the X direction, the front/back direction is the Y direction, and the up/down direction is the Z direction. In addition, the right side of the system A viewed from front is as the +X direction, the left side is the −X direction, the near side is the +Y direction, the far side is the −Y direction, the lower side (downward in the gravity direction) is the +Z direction, and the upper side (upward in the gravity direction) is the −Z direction.

The system A according to this embodiment is a printing system that includes a liquid discharge apparatus 1 and liquid supply apparatuses 20A and 20B and prints an image by discharging ink to a print medium such as paper. In this embodiment, two liquid supply apparatuses 20A and 20B are provided. The liquid supply apparatuses 20A and 20B will sometimes be referred to as liquid supply apparatuses 20 without distinction or generically. The liquid discharge apparatus 1 and the two liquid supply apparatuses 20A and 20B are arranged side by side in the X direction. A liquid that the liquid supply apparatuses 20A and 20B supply to the liquid discharge apparatus 1 is mainly ink, and the liquid discharge apparatus 1 is a printing apparatus that discharges the ink to the print medium. However, the present disclosure is not limited to the printing system, and can also be applied to various kinds of liquid discharge systems aiming at discharging a liquid to a medium.

Note that “printing” is not limited to formation of significant information such as a character or figure, and includes, in a broad sense, to form an image, design, pattern, or the like on a print medium or process a medium regardless of whether information is significant or insignificant, or whether information is so visualized as to allow a person to visually perceive it. Also, in this embodiment, the “print medium” is assumed to be sheet-shaped paper but may be a cloth, a plastic film, or the like.

### <Liquid Discharge Apparatus>

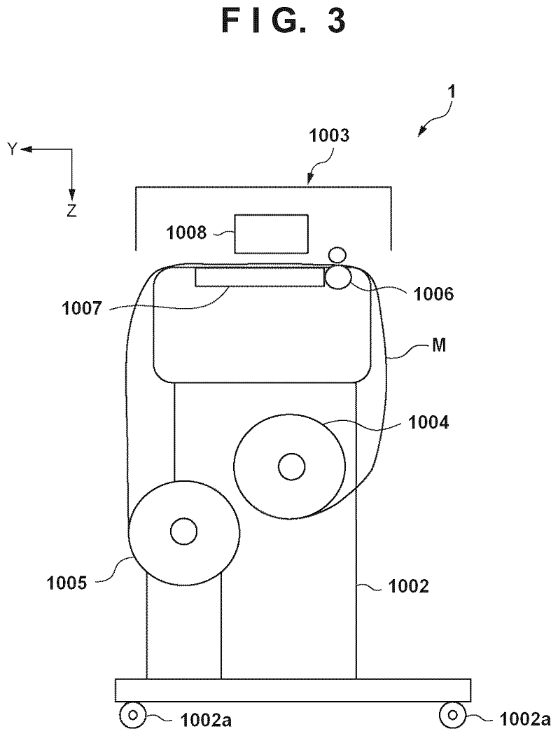

The liquid discharge apparatus 1 will be described with reference to FIG. 3 in addition to FIGS. 1 and 2. FIG. 3 is an explanatory view of the internal structure of the liquid discharge apparatus 1. The liquid discharge apparatus 1 includes a pair of left and right stands 1002, and a main body 1003 supported on the pair of stands 1002. Each stand 1002 is provided with casters 1002a, and the liquid discharge apparatus 1 can be relatively easily moved on the floor. A feeding unit 1004, a drying unit 1014, and a winding unit 1005 are arranged under the main body 1003. In this embodiment, a print medium M is roll paper, and the feeding unit 1004 includes a shaft on which the print medium M is wound. The winding unit 1005 includes a shaft for winding up the print medium M. In this embodiment, roll paper has been exemplified as the print medium M, but it may be cut paper.

A conveyance unit 1006 is provided in the main body 1003. The conveyance unit 1006 includes a driving roller and a driven roller, and the print medium M fed from the feeding unit 1004 is sandwiched in the nip portion between the rollers. When the driving roller rotates, the print medium M is conveyed onto a platen 1007. A discharge head 1008 is arranged facing the platen 1007. The discharge head 1008 is a printhead that discharges ink to form an image. The discharge head 1008 discharges the ink to the print medium M conveyed onto the platen 1007, thereby forming an image on the print medium M.

The discharge head 1008 includes, for example, a discharge energy generation element such as an electrothermal transducer (heater) or a piezoelectric element, and discharges ink from an orifice. If the electrothermal transducer is used, ink can be foamed by generated heat and discharged from the orifice using the foaming energy. The printing method of the discharge head 1008 can be a serial scan method or a full-line method. In a case of the serial scan method, the discharge head 1008 is mounted on a carriage and reciprocally moved in the X direction. Discharging ink while moving the discharge head 1008 in the X direction is called print scanning. The conveyance operation of the print medium M and print scanning of the discharge head 1008 are alternately repeated, thereby printing an image on the print medium M. In this embodiment, employment of the serial scan method is assumed. In a case of the full-line method, a long discharge head extending in the X direction is used, and an image is printed while continuously conveying the print medium M.

The print medium M with the image printed thereon passes through the drying unit 1014 and is then wound up by the winding unit 1005. The drying unit 1014 reduces liquid components contained in the ink applied, by the discharge head 1008, to the print medium M, thereby increasing the fixing properties between the print medium M and the ink. The drying unit 1014 includes a heat source such as a heater, and a blower mechanism such as a fan, and applies hot air at least from the ink application surface side to the passing print medium M, thereby drying the print medium M. To increase the drying efficiency, the hot air may be applied not only to the ink application surface but also to the opposite side of the ink application surface. Note that as for the drying method, not only the method of applying hot air but also a method of irradiating the surface of the print medium M with an electromagnetic wave (ultraviolet rays or infrared rays) or a heat conduction method using contact of a heat generating body may be used in combination. In addition, the drying unit 1014 may only blow air without having any heat source. The print medium M with the image printed thereon is cut by a user using scissors or automatically cut by a cutter (not shown).

A recovery unit 1009 is arranged in the main body 1003. The recovery unit 1009 is arranged outside the print region (outside the discharge region) of the discharge head 1008, and performs processing associated with recovery and maintaining of the discharge performance of the discharge head 1008. Examples of the processing are preliminary discharge of discharging a predetermined amount of ink before and after a printing operation and processing of sucking remaining ink or the like from the orifices of the discharge head 1008. The discharge head 1008 is moved onto the recovery unit 1009, as shown in FIG. 2, if recovery processing is necessary.

An operation panel 10 is provided on the front surface of the main body 1003. Also, the operation panel 10 is, for example, a touch panel and can accept input of various kinds of settings concerning printing, display the state of a print job, or make a notification not the user. The operation panel 10 may be provided with a voice output device, and may make a notification to the user by display and voice. The liquid discharge apparatus 1 also includes a waste liquid cartridge 1011. The waste liquid cartridge 1011 is arranged under an end portion of the main body 1003 on the opposite side of the liquid supply apparatuses 20A and 20B in the X direction.

A waste liquid (waste ink or the like) sucked by the recovery unit 1009 flows into the waste liquid cartridge 1011 to be collected. The waste liquid cartridge 1011 may be arranged near the recovery unit 1009. In this embodiment, however, the waste liquid cartridge 1011 is arranged in a free space under the end portion of the main body 1003, thereby reducing the installation area of the liquid discharge apparatus 1.

### <Liquid Supply Apparatus>

FIGS. 1 and 2 will be referred to. The liquid supply apparatus 20 is an apparatus that stores a liquid such as ink to be discharged from the discharge head 1008 and supplies the liquid such as ink to the liquid discharge apparatus 1. Also, as will be described later, the liquid supply apparatus 20 has a stirring function of stirring the liquid, and functions as a stirring apparatus in this viewpoint. Each liquid supply apparatus 20 includes a box-shaped main body 22. The main body 22 of the liquid supply apparatus 20B forms a plurality of storage portions 23A, and the main body 22 of the liquid supply apparatus 20A form a plurality of storage portions 23A and one storage portion 23B. Casters 22a are provided on the bottom surface of the main body 22, and the liquid supply apparatuses 20 can be relatively easily moved on the floor.

The liquid supply apparatus 20 includes the plurality of storage portions 23A arrayed in the Z direction. Each storage portion 23A has a form of a slot opening to a front wall portion 22b of the main body 22. In each storage portion 23A, a support unit 4 is detachably inserted in the Y direction. The support unit 4 exchangeably supports a liquid container 200 (to be also simply referred to as a container 200) to be described later. Each storage portion 23A functions as a holding portion that detachably holds the liquid container 200.

The liquid supply apparatus 20A includes the storage portion 23B. The storage portion 23B is a box-shaped storage portion that opens to the front wall portion 22b of the main body 22, has a space larger than the storage portion 23A, and is opened/closed by an opening/closing member 25 provided on the front wall portion 22b. The storage portion 23B functions as a holding portion that detachably holds the liquid container 200.

Each of the storage portions 23A and 23B is provided with a tube that connects the container 200 and the liquid discharge apparatus 1. Each tube is connected to the liquid discharge apparatus 1 through a single hose 21 that stores all tubes. Ink in the container 200 is supplied to the discharge head 1008 via the tube.

### (Liquid Container and Support Unit)

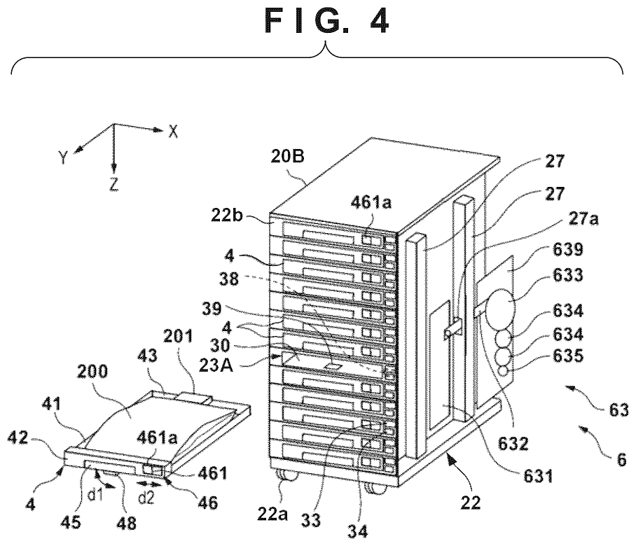

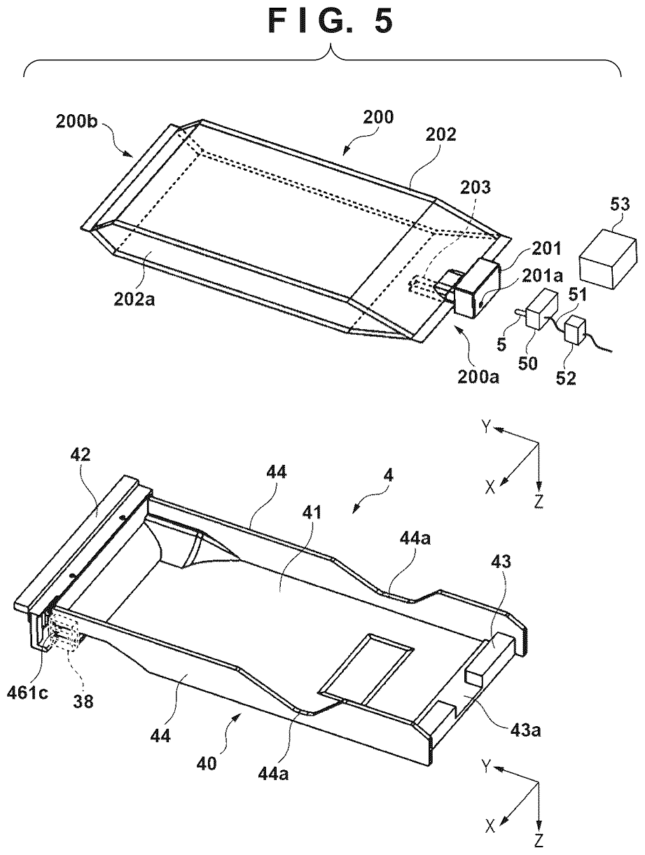

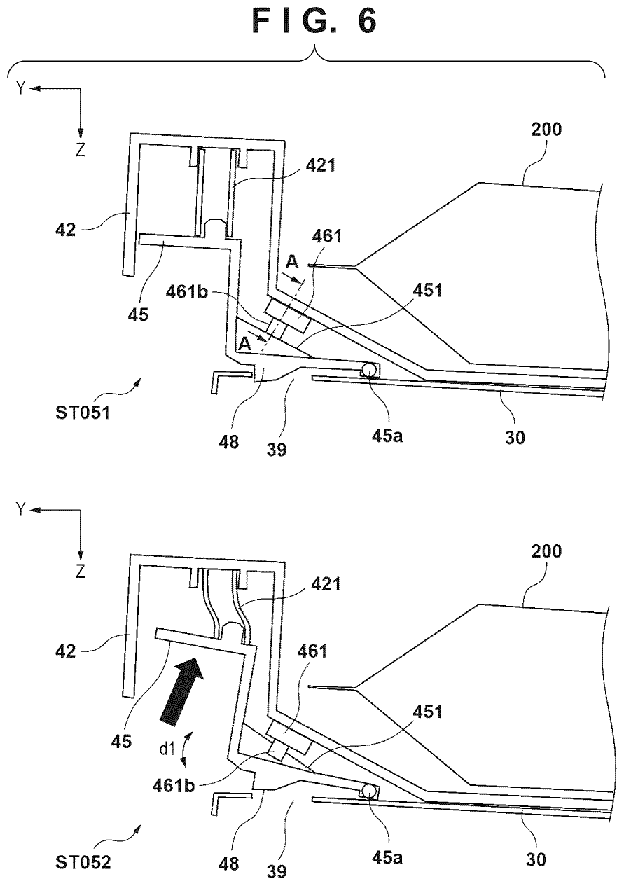

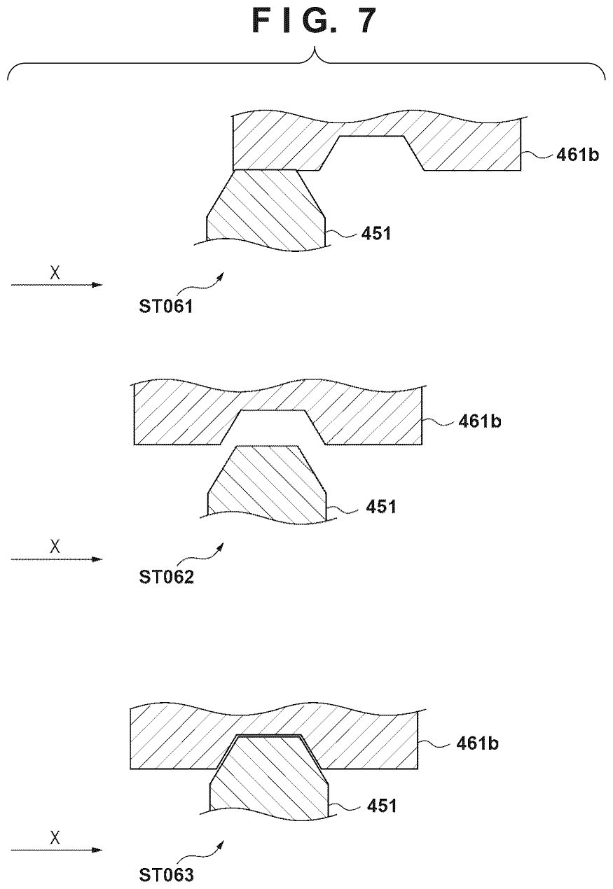

FIGS. 4 to 7 will be referred to. FIG. 4 is a partially exploded perspective view of the liquid supply apparatus 20B and shows a state in which one support unit 4 is detached from the corresponding storage portion 23A. Also, FIG. 4 shows a state in which of the outer wall portion of the liquid supply apparatus 20B, one side wall portion is detached to expose the internal mechanism. FIG. 5 is a perspective view of the liquid container 200 and the support unit 4. FIG. 6 is an operation explanatory view of a handle 45 and a regulating mechanism 46. FIG. 7 is an operation explanatory view of the regulating mechanism 46 and corresponds to a sectional view taken along a line A-A in FIG. 6.

The container 200 includes a bag-shaped container portion 202 made of a material with flexibility. Gusset portions 202a folded inside are provided on both side surfaces of the container portion 202 to increase the liquid containing amount. The container portion 202 is formed into a bag shape by welding sheets forming the upper and lower surfaces and sheets forming the gusset portions 202a to each other, thereby forming a flexible tank for containing a liquid. The shape of the container portion 202 changes in accordance with the contained liquid amount such that if the liquid amount remaining inside is large, the gusset portions 202a expand, and if the liquid amount remaining inside is small, the gusset portions 202a are folded inside. The material of the container portion 202 is, for example, a material having a multiple-layer structure such as PET. If the liquid inside has a property of reacting with air and sticking, or there is concern that the concentration or remaining amount changes due to evaporation, a layer material including an aluminum layer is advantageous as the material of the container portion 202.

The container 200 has one end portion 200a and the other end portion 200b in the longitudinal direction. In an attached state to the liquid supply apparatus 20, the end portion 200a is located on the far side of the liquid supply apparatus 20, and the end portion 200b is located on the near side. A connecting portion 201 is provided at the end portion 200a. The connecting portion 201 is provided with a memory that stores individual information of the liquid container 200. The individual information includes, for example, identification information for specifying each container 200 or type information and remaining amount information of the liquid contained in the container 200. A reader/writer 53 provided in the main body 22 in correspondence with each storage portion 23A reads/writes information from/to the memory by wireless communication.

In the connecting portion 201, a supply port 201a communicating with an intake port 203 inside the container portion 202 is formed. The liquid contained in the container portion 202 flows to the outside via the intake port 203 and the supply port 201a. A spring biased-type supply port control valve that opens/closes the supply port 201a is provided in the connecting portion 201. By the supply port control valve, the supply port 201a is maintained in the closed state normally (without application of an external force or the like).

In the container 200, the side provided with the connecting portion 201 has a length of, for example, about 180 mm, and the side (side surface) orthogonal to this side has a length of, for example, about 400 mm. In the container 200, for example, about 1.5 L liquid is stored. Note that the side with the connecting portion 201 may be not the short side but the long side. Also, the container portion 202 may have not a rectangular shape but a square shape in a planar view.

The main body 22 includes, on the far side of the storage portion 23A, a connecting unit 50 connected to the connecting portion 201. The connecting unit 50 includes a needle-type path forming member 5 inserted into the supply port 201a. The connecting unit 50 is provided for each storage portion 23A. If the path forming member 5 is inserted into the supply port 201a and connected, the supply port control valve is opened by the insertion of the path forming member 5. The path forming member 5 communicates with a tube 51. The path forming member 5 forms a path that flows the liquid contained in the container portion 202 to the liquid discharge apparatus 1 that is the supply destination, and the liquid flowed out to the path forming member 5 is supplied to the liquid discharge apparatus 1 via the tube 51. An electrically driven passage valve 52 is provided on a midway part of the tube 51. The tube 51 can be closed and opened by opening/closing of the passage valve 52.

The support unit 4 includes a support portion 40 that supports the container 200, and has a form of a tray on which the container 200 in a lying posture is placed on the whole. The support unit 4 can be displaced substantially in the Y direction between a storage position where the container 200 is stored in the main body 22 and an extraction position where the container 200 is exposed to the outside of the main body 22. In FIG. 4, one support unit 4 is located at the extraction position, and all the remaining support units 4 are located at the storage position. At the extraction position, the container 200 can be exchanged. At the storage position, the liquid contained in the container 200 can be supplied to the liquid discharge apparatus 1. In this embodiment, at the extraction position, the support unit 4 is separated from the storage portion 23A. However, the extraction position may be a position where the end portion of the support unit 4 is held in the storage portion 23A, and can be any position where the container 200 can be exchanged with respect to the support unit 4.

The support portion 40 includes a placement surface 41 on which the container 200 is placed, and the four sides of the placement surface 41 are defined by left and right side plates 44, a front end portion 42, and a rear end portion 43. A notch portion 44a is formed in each side plate 44. A concave portion 43a on which the connecting portion 201 is arranged is formed at the rear end portion 43.

At the front end portion 42, a handle 45 that is rotatable about a shaft 45a extending in the X direction is provided, and the user can rotate the handle 45 in a direction d1. The handle 45 also serves as an operation handle of an engaging portion 48. The handle 45 is provided with the engaging portion 48, and an engaging portion 39 that engages with the engaging portion 48 is formed on the bottom portion of a case 30 that forms the storage portion 23A. In this embodiment, the engaging portion 48 is a projecting portion, and the engaging portion 39 is a concave portion in which the engaging portion 48 is inserted. When the engaging portion 48 and the engaging portion 39 engage with each other, the support unit 4 can be prevented from dropping from the storage portion 23A even if a vibration acts on it due to, for example, movement of the liquid supply apparatus 20. The handle 45 is always biased, by an elastic member 421, to the side of the engaging position (the position in a state ST051 shown in FIG. 6) where the engaging portion 48 engages with the engaging portion 39. The elastic member 421 is, for example, a coil spring. When the user grasps the handle 45 and rotates it in a direction indicated by the arrow in a state ST052 in FIG. 6, the engaging portion 48 and the engaging portion 39 are disengaged, and the support unit 4 inserted into the storage portion 23A can be extracted from the storage portion 23A.

To prevent the container 200 stored in the storage portion 23A from being carelessly extracted, the regulating mechanism 46 that regulates extraction of the container 200 from the storage portion 23A is provided for each storage portion 23A. The regulating mechanism 46 according to this embodiment is a lock mechanism that locks the support unit 4 to the storage position.

The regulating mechanism 46 includes a slide member 461 incorporated in the front end portion 42. To allows the user to operate the slide member 461, an operation portion 461a that is a part of the slide member 461 is exposed from the front end portion 42. The slide member 461 is provided to be movable in the direction of an arrow d2 (X direction) between a lock position where the rotation of the handle 45 in the direction d1 is regulated and an unlock position where the rotation of the handle 45 is permitted.

The state ST051 in FIG. 6 and a state ST061 in FIG. 7 indicate a state in which the slide member 461 is located at the lock position. That is, the regulating mechanism 46 is in a regulating state in which extraction of the container 200 is regulated. The slide member 461 includes an abutment portion 461b, and the abutment portion 461b abuts against an abutment portion 451 provided on the handle 45 like a rib. In the state ST051 in FIG. 6 and the state ST061 in FIG. 7, the slide member 461 is an obstacle, and the handle 45 cannot be rotated in the disengaging direction. Hence, the support unit 4 cannot be extracted from the storage portion 23A.

A state ST062 in FIG. 7 indicates a state in which the slide member 461 is located at the unlock position. That is, the regulating mechanism 46 is in a regulation cancel state in which extraction of the container 200 is permitted. The notch portion of the abutment portion 461b and the abutment portion 451 are at positions facing each other. At this time, since the abutment portion 451 can escape to the notch portion of the abutment portion 461b, as indicated by a state ST063 in FIG. 7, the handle 45 can be rotated to the disengaging direction as indicated by the state ST052 in FIG. 6. In this way, when the user slides the slide member 46a to the unlock position and then operates the handle 45, the support unit 4 can be extracted from the storage portion 23A.

The storage portion 23A is provided with a sensor 38 that detects the state of the regulating mechanism 46. The sensor 38 according to this embodiment detects the position of the slide member 461. The sensor 38 is, for example, an optical sensor (for example, a photointerrupter) capable of detecting a detection piece 461c of the slide member 461. If the slide member 461 is located at the lock position, the detection piece 461c is located at the detection position of the sensor 38, as shown in FIG. 5, and detected by the sensor 38. If the slide member 461 is located at the unlock position, the detection piece 461c is not located at the detection position of the sensor 38 and is not detected by the sensor 38. It is therefore possible to determine, based on the detection result of the sensor 38, whether the position of the slide member 461 is the lock position or the unlock position, that is, whether the state of the regulating mechanism 46 is the regulating state or the regulation cancel state.

Opening/closing of the passage valve 52 can be interlocked with the detection result of the sensor 38. For example, if the sensor 38 detects that the position of the slide member 461 is the unlock position in a case where the passage valve 52 is in the open state, the passage valve 52 is immediately closed interlockingly with the detection. This can prevent the support unit 4 from being removed from the storage portion 23A in a state in which the passage valve 52 is open. If the support unit 4 is removed from the storage portion 23A in a state in which the passage valve 52 is open, air may enter from the path forming member 5 into the tube 51. This causes a problem such as sticking of the liquid in the tube 51 or discharge failure in the discharge head 1008. If it is detected that the position of the slide member 461 is the unlock position, the passage valve 52 is immediately closed by automatic control interlockingly with the detection, thereby preventing air from entering the tube 51.

### (Tilt of Slot)

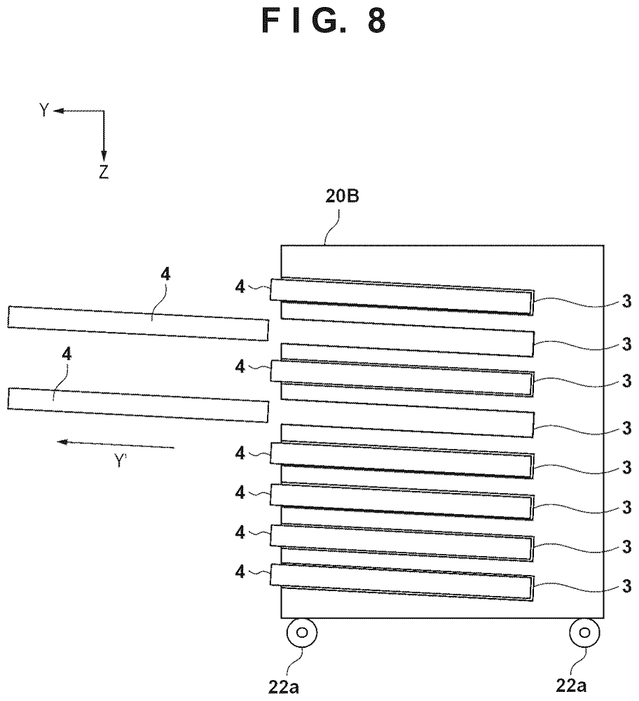

FIG. 8 is a view showing the attachment posture and the insertion/removal mode of the support unit 4 to the storage portion 23A. As shown in FIG. 8, the storage portion 23A of each stage provided in the liquid supply apparatus 20B is tilted and lowered to the lower (+Z) side toward the rear side (far side or −Y side). Note that this also applies to the storage portions 23A of the liquid supply apparatus 20A.

In the attached state, the support unit 4 is held in a tilting posture, and in the container 200, the end portion 200a is located on the lower side of the end portion 200b in the gravity direction (Z direction). The tilt angle is, for example, smaller than 45° with respect to the horizontal plane and particularly 10° or less. In the example shown in FIG. 8, the tilt angle is assumed to be 3°.

### (Liquid Stirring Mechanism)

The stirring mechanism provided in the liquid supply apparatus 20B will be described. Various kinds of liquids can be contained in the container 200 and used for image printing, maintenance of the discharge head 1008, or the like. For example, an aqueous ink, a latex ink, or a solvent-based ink such as eco-solvent can be contained in the container 200. Depending on the type of ink, particles of a color material or a resin component in the ink may be sedimented along with the elapse of time. The particle size of a color material or the type and amount of an additive such as a resin may change between ink colors, and the sedimentation speed may change depending on the ink color. Also, a reaction liquid that is discharged from the discharge head 1008 and reacts with ink to fix the ink on the surface of the print medium M can also be contained in the container 200. For the container 200 containing a liquid having such a property that the components are separated, the contained liquid is appropriately stirred, thereby improving evenness. This contributes to, for example, suppressing lowering of quality of a printed image.

In this embodiment, for the container 200 stored in the storage portion 23A, a stirring unit 6 performs a stirring operation of stirring the liquid contained in the container 200. The stirring unit 6 according to this embodiment physically presses the container portion 202 of the container 200 from the outside, thereby changing its posture (deforming it). The contained liquid is thus flowed in the container portion 202 and stirred.

Depending on the liquid contained in the container 200, it need not be stirred. In this embodiment, the storage portions 23A having a stirring function and the storage portions 23A without the stirring function are provided. More specifically, the storage portions 23A at the upper stages of the liquid supply apparatus 20B do not have the stirring function, and the storage portions 23A at the middle to lower stages have the stirring function. All storage portions 23A may have the stirring function, as a matter of course. Also, the storage portions 23A of the liquid supply apparatus 20A may have a similar stirring function.

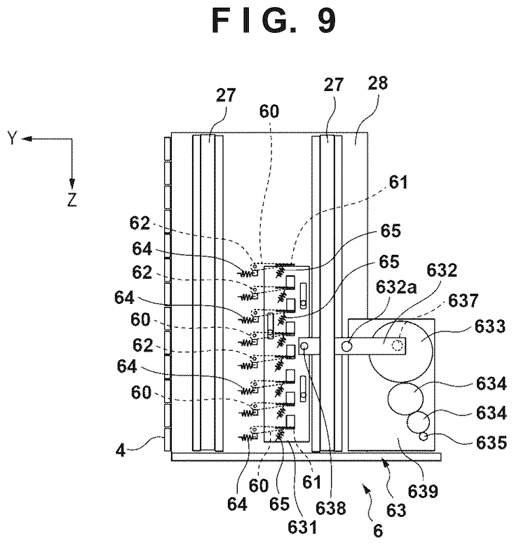

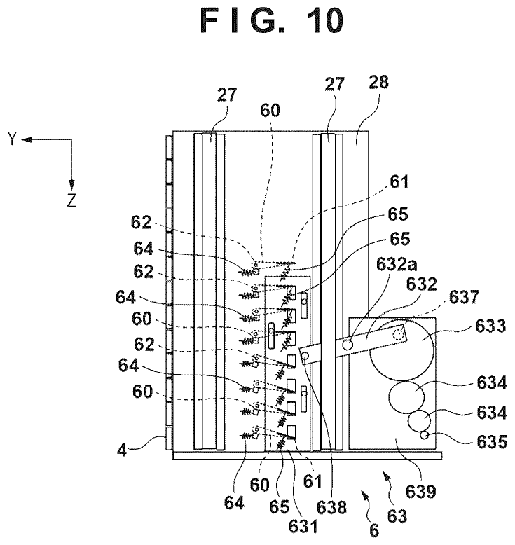

The configuration of the stirring unit 6 will be described with reference to FIGS. 4, 9, and 10. FIGS. 9 and 10 are operation explanatory views of the stirring unit 6 when the main body 22 of the liquid supply apparatus 20B is viewed from sideward. The stirring unit 6 includes a plurality of pressing members 60, and a moving mechanism 63 common to the plurality of pressing members 60. The pressing member 60 is provided for each storage portion 23A. The pressing member 60 is arranged at a position facing the support unit 4 attached to the storage portion 23A and the container 200 supported by the support unit 4. When the moving mechanism 63 synchronously rotates each pressing member 60 about a rotation shaft 62, a pressing portion 61 provided on the pressing member 60 presses the container 200 from above and relaxes the pressing. FIG. 9 shows a state in which the pressing portion 61 (and the pressing member 60) are located at a pressing relaxing position, and FIG. 10 shows a state in which the pressing portion 61 (and the pressing member 60) are located at a pressing position.

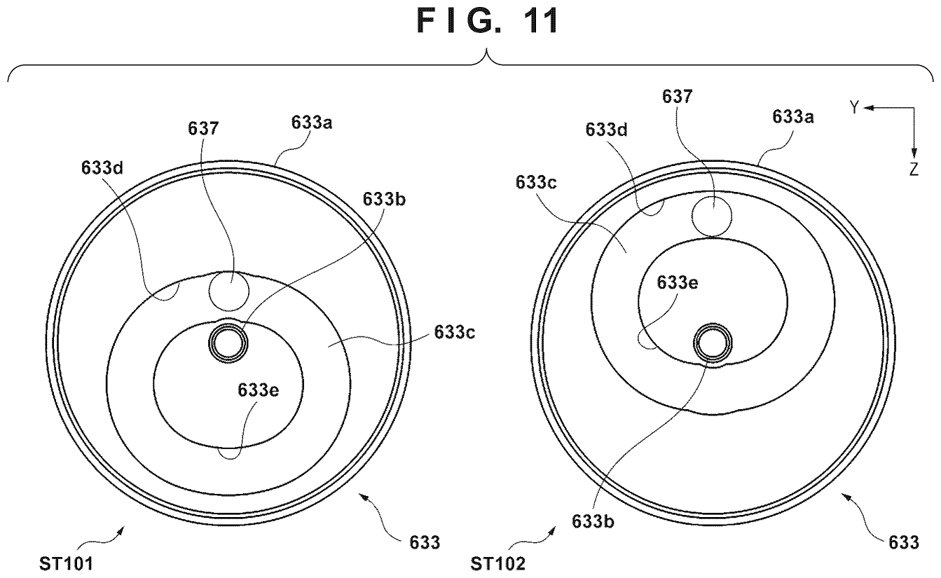

The configuration of the moving mechanism 63 will be described. The output of a motor 635 that is the driving source of the moving mechanism 63 is transmitted to a cam 633 via a plurality of gears 634. Note the rotation shaft of each component is in the X direction. The configuration of the cam 633 will be described here with reference to FIG. 11. FIG. 11 is an explanatory view of the cam 633, and a state ST102 shown in FIG. 11 indicates a state in which the cam 633 has rotated by 180° from a state ST101 in FIG. 11.

The cam 633 is a disc-shaped member that can rotate about a shaft 633b in the X direction, and a gear tooth portion 633a is formed on the outer peripheral surface. The gear tooth portion 633a meshes with the gear 634, and the cam 633 rotates when the gear 634 rotates. A groove 633c is formed in the side surface of the cam 633, and the outer and inner side surfaces of the groove 633c form an outer cam surface 633d and an inner cam surface 633e, respectively. In the groove 633c, a cam follower 637 connected to a driving transmission lever 632 is arranged. The inner cam surface 633e is located on the inner side of the cam follower 637 in the radial direction of the cam 633, and when the cam 633 rotates, the inner cam surface 633e comes into contact with the cam follower 637 and acts to move the cam follower 637 upward. Also, the outer cam surface 633d is located on the outer side of the cam follower 637 in the radial direction of the cam 633, and when the cam 633 rotates, the outer cam surface 633d comes into contact with the cam follower 637 and acts to move the cam follower 637 downward.

FIGS. 4, 9, and 10 will be referred to again. When the cam follower 637 moves up/down in accordance with the rotation of the cam 633, the driving transmission lever 632 rotates about a rotation shaft 632a. Since the driving transmission lever 632 is rotatably connected to a shaft portion 638 provided on an elevating member 631, the operation of the driving transmission lever 632 is converted into the elevating operation of the elevating member 631. When the cam 633 rotates by one revolution, the cam follower 637 performs a reciprocating operation once in the Z direction, and therefore, the elevating member 631 similarly performs a reciprocating elevating operation once via the driving transmission lever 632.

The elevating member 631 having a plate shape is attached to a side plate 28 of the main body 22 such that it can move up/down in the Z direction. In addition, two, front and rear columns 27 each having a U-shaped section and extending in the Z direction are fixed on the side plate 28. The columns 27 are attached to the side plate on the-X side as well, and the main body 22 ensures its strength as a structure by the total of four columns 27. The weight of a number of containers 200 can thus be supported.

The column 27 has a high strength and a thickness. Hence, if the moving mechanism 63 is provided outside in the X direction with respect to the columns 27 attached to the side plate 28, the size in the X direction becomes large. Hence, in this embodiment, the elevating member 631 and the driving mechanism such as the cam 633 are distributed to the front and rear sides of one the column 27 in the Y direction. The driving transmission lever 632 is inserted into a through hole 27a formed in the one column 27.

This makes it possible to suppress an increase of the size of the main body 22 in the X direction and arrange the moving mechanism 63 of the stirring unit 6 while ensuring the strength. Furthermore, the driving transmission lever 632 is attached to a plate-shaped support member 639 that supports the moving mechanism 63. By detaching fixing elements such as fastening screws, most components of the moving mechanism 63 can be detached to the rear surface side of the main body 22 as an integrated unit together with the support member 639. Hence, parts exchange by a service man can easily be performed. Note that fastening and unfastening of the fixing elements such as fastening screws can easily be done by fastening these from the rear surface side of the main body 22.

Biasing forces of two springs 64 and 65 act on each pressing member 60. The spring 64 has one end attached to the pressing member 60 and the other end attached to the storage portion 23A (case 30). Also, the spring 65 has one end attached to the pressing member 60 and the other end attached to the elevating member 631. The pressing member 60 is a movable member (particularly a rotating member) that is attached to the storage portion 23A (case 30) such that it can rotate about the rotation shaft 62 as the rotation center. The rotation shaft 62 is a shaft in a direction crossing the moving direction (Z direction) of the pressing portion 61. Both the two springs 64 and 65 bias the pressing member 60 in a direction to rotate it clockwise in FIGS. 9 and 10.

When the pressing member 60 is at the pressing relaxing position (FIG. 9), the elevating member 631 contacts the pressing member 60 and raises itself. Hence, the biasing force of the spring 65 acts between the elevating member 631 and the pressing member 60. For this reason, the biasing force of the spring 65 acts only between the elevating member 631 and the pressing member 60 and does not serve as a load for the motor 635. That is, the load applied to the moving mechanism 63 at the pressing relaxing position includes only the biasing force of the spring 64 and the weights of the components.

Also, when the pressing member 60 is at the pressing position (FIG. 10), the cam 633 has a phase 180° oppose to that at the pressing relaxing position, and the pressing portion 61 of the pressing member 60 contacts the container 200 and presses it downward. The pressing distance of the pressing portion 61, that is, the rotation amount of the pressing member 60 changes depending on the remaining amount in the container 200. In FIG. 9, the pressing members 60 at the four upper stages indicate a mode in which the containers 200 that are full of liquid are pressed. The pressing members 60 at the four lower stages indicate a mode in which the containers 200 that are deflated because of very little remaining amount are pressed. The biasing forces of both the springs 64 and 65 and the weights of the components act on the container 200. Since the springs 64 and 65 are arranged in each storage portion 23A, even if the remaining amounts in the containers 200 of the storage portions 23A are different, an optimum pressing force can be applied to each container 200.

At this time, the biasing force of the spring 64 acts on the container 200 but not on the elevating member 631. The biasing force of the spring 65 acts between the container 200 and the elevating member 631 which are in contact via the pressing member 60. The cam 633 acts to move the elevating member 631 downward to the lower side of the container 200. Thus, using the two springs 64 and 65 at different attachment positions and the cam 633 capable of moving both upward and downward, the load applied to the moving mechanism 63 at the time of operation is reduced.

Note that at the pressing position, since the extensions of the springs 64 and 65 are smaller when the container 200 is deflated because of a small remaining amount, the pressing force acting on the container 200 is also small. If the remaining amount in the container 200 is large, the reaction force from the container 200 is readily received at the time of pressing, and a larger pressing force is needed to deeply push in. Conversely, if the remaining amount is small, the reaction force from the container 200 is small. For this reason, even if the pressing force is small, it is possible to deform the container 200 and easily move the liquid inside. In other words, the push-in amount (pressing amount) of the pressing member 60 to push in the container 200 changes in accordance with the remaining amount of the liquid in the container 200. For this reason, the springs 64 and 65 are arranged at positions where the pressing force decreases along with the deflation of the container 200. Hence, the biasing forces of the springs need not be more than necessity. In this embodiment, the load applied to the pressing portion 61 is adjusted to, for example, about 500 gf when the container 200 is full of liquid or about 300 gf when the remaining amount is little.

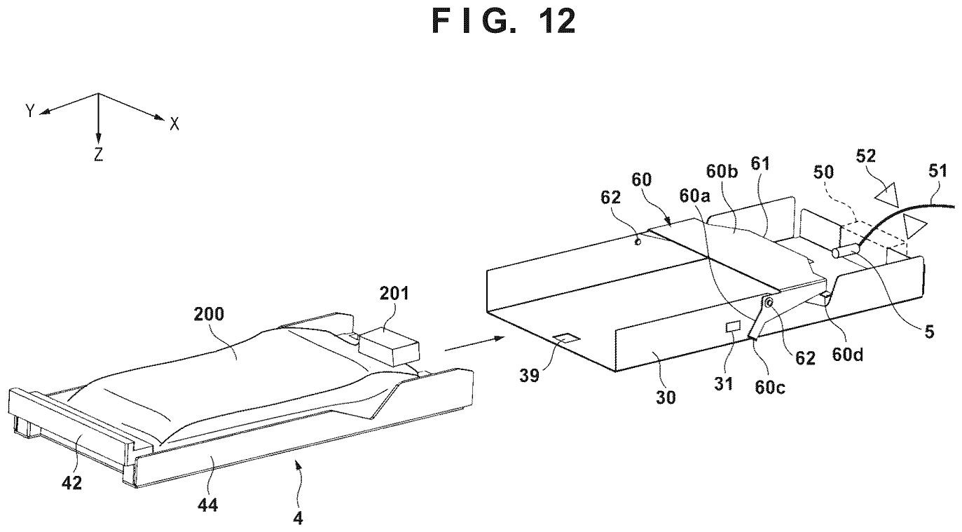

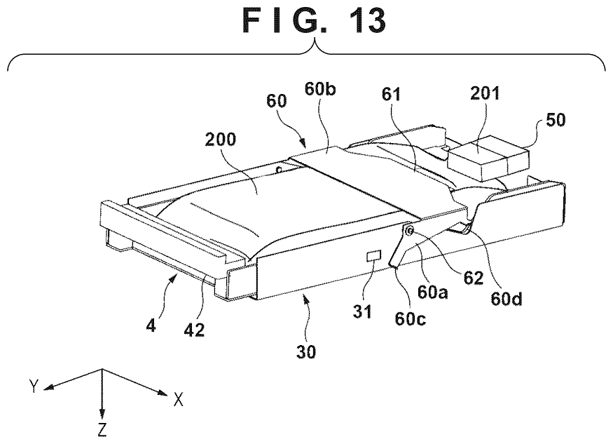

The configuration of the pressing member 60 will be described with reference to FIGS. 12 and 13. FIG. 12 is a perspective view of the case with a stirring function and the support unit in a separated state. FIG. 13 is a perspective view of the case with a stirring function and the support unit in an attached state.

The pressing member 60 includes a pair of side plates 60a located on the side portions of the case 30 in the X direction, and a top plate 60b straddling the case 30 in the X direction and connected between the pair of side plates 60a. On each side plate 60a, the pressing member 60 is rotatably supported by the case 30 via the rotation shaft 62, and the pressing portion 61 is formed at the distal end of the top plate 60b.

A lock portion 60c on which an end portion of the spring 64 is locked, and an abutment portion 60d on which an end portion of the spring 65 is locked and which abuts against the elevating member 631 at the time of rising of the elevating member 631 and causes rotation of the pressing member 60 are formed on each side plate 60a. Both the lock portion 60c and the abutment portion 60d are formed in a form of a projecting piece projecting in the X direction.

A remaining amount detection sensor 31 is provided on a side portion of the case 30. The remaining amount detection sensor 31 is, for example, an optical sensor. The remaining amount detection sensor 31 is a position detection sensor that detects the side plate 60a and thus detects the position of the pressing portion 61, and is also a sensor that detects the remaining amount in the container 200 based on the position detection result. More specifically, as for the detection position of the remaining amount detection sensor 31, it is arranged at a position to detect the side plate 60a when the container 200 deflated because of the decrease of the remaining amount is pressed. This uses the fact that the push-in amount at the time of pressing changes depending on the degree of deflation of the container 200. In this embodiment, since the pressing portion 61 is brought into contact with the container 200, the position of the side plate 60a reflects the remaining amount in the container 200, and therefore, the accuracy of remaining amount detection is high. The detection position of the remaining amount detection sensor 31 is designed such that, for example, the side plate 60a is detected when the container 200 whose remaining amount is about 100 ml is pressed.

The pressing member 60 can be formed by, for example, a plate material made of a metal (steel plate, or the like). As compared to a member of a resin or the like, since the strength is high even if it is thin, the height of the storage portion 23A can be suppressed. The rotation shaft 62 of the pressing member 60 is arranged on the outer side of the container 200 in the X direction, and is provided at a position where the rotation shaft 62 and the container 200 overlap in the X direction when the container 200 is full of liquid. With these contrivances to suppress the size in the Z direction, even if the pressing member 60 is installed in the storage portion 23A of each stage to impart the stirring function, the containers 200 of multiple stages can be stored in a limited space under the housing of the system A.

Also, the width of the pressing member 60 in the X direction is smaller at the pressing portion 61 than near the rotation shaft 62. Thus, if the pressing portion 61 presses a tank, it is possible to prevent portions other than the pressing portion 61 from contacting the container 200 and prevent the container 200 from being damaged.

When the width of the pressing member 60 in the X direction is made smaller at the pressing portion 61 than near the rotation shaft 62, the following advantage can be obtained. As described above, the gusset portions 202a are provided on the side surfaces of the container 200. The gusset portion 202a includes a welded portion between flexible members, and has higher rigidity as compared to the other portions. To deflate the container 200 by folding the gusset portions 202a inside in accordance with a decrease of the remaining amount, an adequate pressing force is needed. In a state in which the remaining amount in the container 200 is large, the gusset portions 202a are expanded in the up/down direction, and the gusset portions 202a are sometimes expanded not inside but outside. To squeeze the gusset portions 202a, an adequate pressing force is needed.

When the pressing portion 61 is arranged inside the gusset portions 202a in the X direction, it is possible to efficiently press and deform the container 200 for stirring. That is, the pressing portion 61 is arranged to press the center side of the container 200 with respect to the gusset portions 202a. The height of the gusset portions 202a is, for example, about 20 mm on both side surfaces. When the pressing portion 61 is located inside the gusset portions 202a on both side surfaces, it hardly receives the reaction force of the gusset portions 202a and can efficiently press the container 200. The pressing efficiency can further be improved by designing the width of the pressing portion 61 in the X direction such that it is fitted, for example, 10 mm or more inside from the gusset portions 202a. This is because when the pressing portion 61 is apart from the gusset portions 202a in the X direction, the influence of the reaction force of the gusset portions 202a is smaller. Note that the width of the pressing portion 61 in the X direction is preferably designed apart from the gusset portions 202a by at least 1 mm, and may be designed apart by, for example, 5 mm or 10 mm.

As a form for minimizing the width of the pressing portion 61 in the X direction, for example, the pressing portion 61 may be in point contact with the container 200. However, in a case where the container 200 is long in the Y direction, as in this embodiment, if the pressing portion 61 is in point contact with the container 200, the fluidity of the liquid in the container 200 may lower. More specifically, if the width of the pressing portion 61 in the X direction is too small, the flow of the liquid corresponding to the push-in amount of the pressed container 200 is dispersed even outside in the X direction, the flow amount of the liquid in the Y direction decreases.

Hence, for example, if the width of the pressing portion 61 in the X direction is set to ⅓ or more the width of the container portion 202 of the container 200 in the X direction, the fluidity of the liquid in the Y direction can be improved in the container portion 202 at the time of pressing. For example, if the width of the container portion 202 in the X direction is 180 mm, the width of the pressing portion 61 in the X direction is set to 60 mm or more, thereby improving the fluidity of the liquid in the Y direction in the container portion 202 at the time of pressing.

To summarize, if the width of the container portion 202 in the X direction is 180 mm, and the height of the gusset portions 202a is 20 mm, the width of the pressing portion 61 in the X direction is preferably 60 mm to 120 mm and may be particularly 90 mm.

### (Stirring Operation)

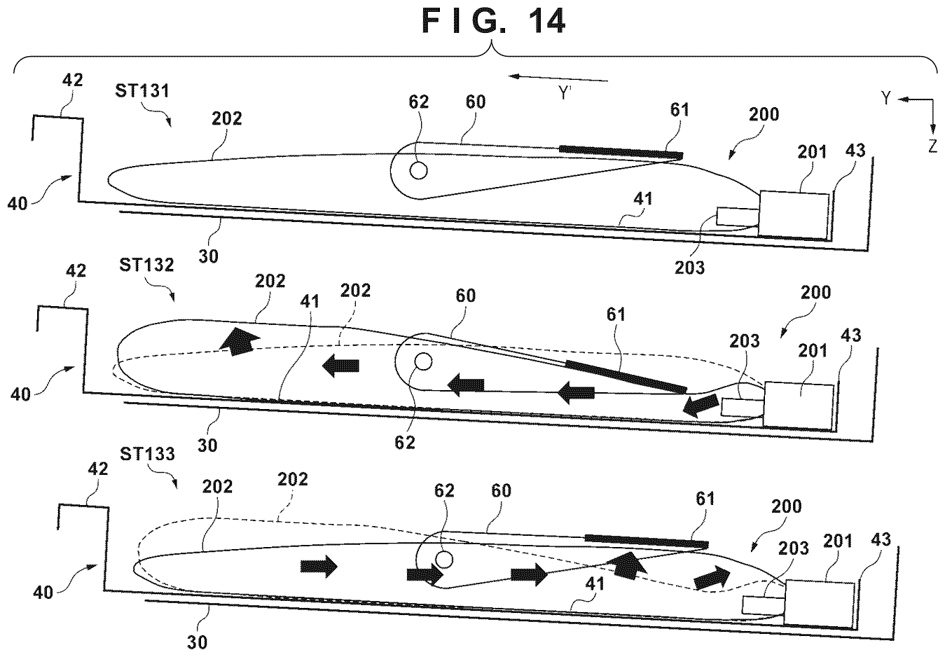

The stirring operation of the liquid in the container 200 by pressing the pressing portion 61 against the container 200 will be described with reference to FIG. 14. FIG. 14 is an explanatory view of the stirring operation. As shown in FIG. 8, the attachment posture of the support unit 4 is tilted in this embodiment. In FIG. 14, a direction parallel to the tilt angle direction of the attachment posture is defined as a Y′ direction. In the following explanation, the side of the connecting portion 201 of the container 200 will sometimes be referred to as a −Y′ direction, and the opposite side will sometimes be referred to as a +Y′ direction. Note that arrows in FIG. 14 indicate the direction of liquid flow that occurs in the container portion 202 of the container 200.

In this embodiment, the stirring operation includes a pressing operation and a pressing relaxing operation. The pressing portion 61 is arranged facing the placement surface 41 of the support unit 4. The pressing portion 61 is reciprocally moved between the pressing relaxing operation and the pressing operation. The posture of the container portion 202 is thus changed to cause the flow of the liquid inside and stir it.

A state ST131 in FIG. 14 indicates a state in which the pressing portion 61 (and the pressing member 60) is at the pressing relaxing position. In this embodiment, at the pressing relaxing position, the pressing portion 61 is apart from the placement surface 41 and is located at a height not to contact the container portion 202, and does not press the container portion 202. Hence, it can also be said that the pressing relaxing position is a pressing cancel position.

The moving mechanism 63 is driven from the state ST131 in FIG. 14, and the pressing operation is performed, as indicated by a state ST132 in FIG. 14. In the pressing operation, the pressing member 60 rotates, and the pressing portion 61 moves to a position where it is closer to the placement surface 41 than at the pressing relaxing position and presses the container portion 202 to the side of the placement surface 41. Thus, the posture of the container portion 202 changes such that it is partially recessed, and the liquid inside is flowed to the side of the end portion 200b and stirred.

In this embodiment, the container 200 is attached in a tilting posture to the storage portion 23A while directing the connecting portion 201 to the lower side in the Z direction. Hence, at the stage of the state ST131 in FIG. 14, the liquid in the container 200 is readily distributed while being localized on the side of the connecting portion 201 by the weight of its own, and the container portion 202 expands more on the side of the connecting portion 201 than at the central portion in the Y′ direction. The pressing portion 61 is designed to press the side of the end portion 43 provided with the connecting portion 201 out of the end portions 42 and 43 of the container 200. Since the pressing portion 61 presses the expanded portion of the container portion 202 or a portion close to it, the flow of the liquid in the container portion 202 can be promoted. The portion that the pressing portion 61 presses may be the most expanded portion of the container portion 202.

Note that if the tilt angle is too large, the localization of the liquid in the container 200 is large, and the reaction force by the weight of the gathered liquid increases. As a result, when pressing by the pressing member 60, the load applied to the pressing member 60 increases. For this reason, as described above, the tilt angle is preferably set to less than 45° and particularly preferably 10° or less. The tilt angle in this embodiment is set to 3°. The tilt angle may be set in accordance with the liquid amount that can be contained in the container 200. For example, if the liquid amount is small, the tilt angle may be set large as compared to a case where the liquid amount is large.

Since the pressing portion 61 presses the container portion 202 on the side of the connecting portion 201, stirring can effectively be performed when the liquid flows to the opposite side. The rotation shaft 62 of the pressing member 60 is located on the opposite side of the connecting portion 201 in the Y′ direction of the container 200 when viewed from the pressing portion 61. In the pressing operation, the rotation direction of the pressing member 60 is the clockwise direction in the state ST132 shown in FIG. 14. That is, the pressing member 60 rotates clockwise about the rotation shaft 62 as the rotation center. When the rotation direction is thus set, a vector in the +Y′ direction is generated, and the liquid can readily be flowed in the +Y′ direction. That is, the liquid readily flows, in the container portion 202, to the end portion on the side opposite to the side of the connecting portion 201.

As described above, in this embodiment, the pressing portion 61 is designed to press the side of the end portion 43 provided with the connecting portion 201 out of the end portions 42 and 43 of the container 200. A portion of the container portion 202 near the intake port 203 of the container 200 is pressed, and stirring of the liquid around there is particularly promoted. In printing, the liquid in the container 200 flows out from a region close to the intake port 203 to the tube 51. By pressing the portion near the intake port 203 and stirring the liquid, the liquid whose concentration is more even can be sent to the tube 51.

The moving mechanism 63 is driven from the state ST132 in FIG. 14, and the pressing relaxing operation is performed, as indicated by a state ST133 in FIG. 14. In the pressing relaxing operation, the pressing member 60 rotates, and the pressing portion 61 returns from the pressing position to the pressing relaxing position. The pressing member 60 rotates counterclockwise about the rotation shaft 62 as the rotation center in the state ST133 in FIG. 14. That is, when transiting from the state ST132 in FIG. 14 to the state ST133 in FIG. 14, the pressing member 60 reverses the rotation direction. When pressing by the pressing member 60 is relaxed, the container portion 202 is going to restore its original shape while the liquid in the container portion 202 flows. That is, the pressing relaxing operation is an operation of returning the posture of the container portion 202 changed by the pressing operation to the original posture. The posture need not be completely the same as the original position, as a matter of course. After that, the pressing operation can be performed again.

The pressing operation and the pressing relaxing operation are repetitively performed, thereby stirring the liquid in the container portion 202. That is, when the pressing portion 61 is at the pressing position, as indicated by the state ST132 in FIG. 14, the portion of the container 200 near the pressing portion 61 is recessed, the liquid flows in the +Y′ direction, and a portion of the container 200 on the opposite side of the connecting portion 201 is expanded. After that, when pressing is relaxed, as in the state ST133 shown in FIG. 14, the ink flowed by the pressing flows in the −Y′ direction by the weight of its own. By repeating the pressing operation and the pressing relaxing operation, the liquid is reciprocally moved in the Y′ direction in the container portion 202 and stirred. The flow of the liquid caused by the pressing relaxing operation uses the weight of the liquid. When the weight of the liquid is used, the mechanism necessary for stirring the liquid can have a simple configuration.

Note that during the series of pressing operations shown in FIG. 14, the passage valve 52 can be either in the open state or the closed state. That is, control is performed such that the passage valve 52 is in the open state in a path where supply of the liquid to the discharge head 1008 is performed, and the passage valve 52 is in the closed state in a path where supply of the liquid to the discharge head 1008 is not performed. Hence, during the series of pressing operations shown in FIG. 14, a printing operation by the discharge head 1008 can be performed concurrently.

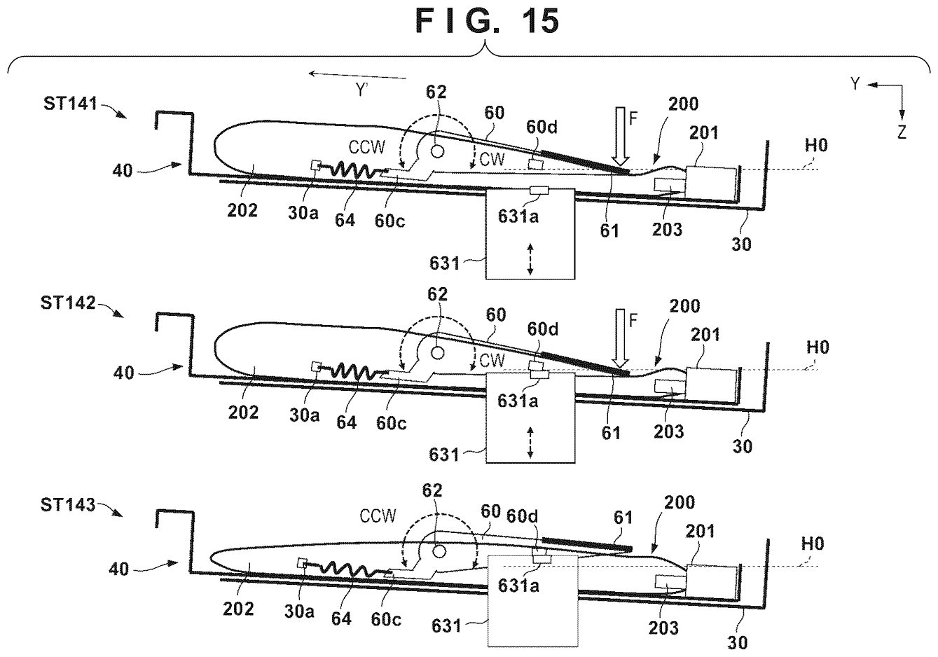

The operations of the pressing member 60 and the moving mechanism 63 in the series of pressing operations shown in FIG. 14 will be described with reference to FIG. 15. The pressing member 60 rotates about the rotation shaft 62, and the pressing portion 61 is set in the pressing state by rotation in the CW direction and set in the pressing relaxing state by rotation in the CCW direction.

The action of the spring 64 will be described. The lock portion 60c is formed on the pressing member 60, and a lock portion 30a is formed on the case 30. The spring 64 is provided between the lock portions 60c and 30a. By the tensile force of the spring 64, the pressing member 60 is biased to rotate in the CW direction, and the pressing portion 61 is set in the pressing state.

The elevating member 631 is provided with an abutment portion 631a. As indicated by a state ST142 in FIG. 15, when the elevating member 631 moves upward, the abutment portion 631a of the elevating member 631 abuts against the abutment portion 60d of the pressing member 60. This position is defined as an abutment reference height H0. As indicated by a state ST143 in FIG. 15, when the elevating member 631 further moves upward, the pressing member 60 rotates about the rotation shaft 62 in the CCW direction, and the pressing portion 61 is set in the pressing relaxing state.

Conversely, when the elevating member 631 moves downward, the abutment portion 631a of the elevating member 631 is separated from the abutment portion 60d of the pressing member 60. By the tensile force of the spring 64, the pressing member 60 is biased to rotate in the CW direction, and the pressing portion 61 is set in the pressing state again. In this way, the pressing member 60 rotates between the pressing position and the pressing relaxing position by the elevating motion of the elevating member 631.

In a state ST141 shown in FIG. 15, rotation of the pressing member 60 stops at a position where a pressing load F of the pressing portion 61 by the spring 64 balances the reaction force of the container 200. For this reason, if the remaining amount of the liquid in the container 200 decreases, the position (pressing position) where the forces balance lowers accordingly. Since the pressing height of the pressing member 60 changes depending on the remaining amount of the liquid in the container 200, it is possible to press the container 200 and stir the liquid, following the remaining amount of the liquid in the container 200.

Next, when repeating the stirring operation, liquid stirring performance can be adjusted by the period. In the pressing relaxing operation, the liquid in the container portion 202 flows a little later after the rotation of the pressing member 60. In the pressing relaxing operation, the higher the fluidity of the liquid is, the higher the stirring effect is. Also, if the pressing operation is performed after the liquid sufficiently flows, the liquid containing amount of the container portion 202 becomes large near the pressing portion 61, and the container portion 202 expands. Hence, by pressing there, the stirring performance can further be improved. The frequency of the stirring operation is, for example, a frequency slower than several Hz and, particularly, a frequency slower than 1 Hz. If the frequency of the stirring operation is too low, that is, if the period is too long, the total time of the stirring operation increases, and the power consumption of the motor 635 may increase. Hence, the frequency of the stirring operation may be set in the range of, for example, 0.5 to 0.7 Hz and, particularly, to 0.6 Hz. That is, a configuration in which the series of operations is performed at a period of, for example, about 1.6 to 1.7 sec is preferable.

In addition, when the remaining amount decreases, and the container 200 is deflated, the ink on the upper side (+Y′ side) of the tilting container 200 flows by the weight of its own to the −Y′ side, and the containing amount in this portion decreases. To the contrary, the liquid stays on the lower side (−Y′ side). In this state, the flow distance of the liquid in the +Y′ direction at the time of the pressing operation is short, and the time of return of the liquid in the pressing relaxing operation is also short. Hence, the period of the stirring operation may be shortened in accordance with the decrease of the remaining amount in the container 200.

In the stirring operation, the pressing operation and the pressing relaxing operation may be repeated while providing a time interval between the pressing relaxing operation and the next pressing operation. It is possible to ensure a long flow time of the liquid in the container portion 202 from the pressing relaxing operation to the start of the next pressing operation and further promote the flow of the liquid by the weight of its own. For example, when the operation is stopped for 0.1 to 0.5 sec in the state ST132 shown in FIG. 14 and the state ST133 shown in FIG. 14, it is possible to promote the flow of the liquid and improve the stirring efficiency. The time of stop is appropriately set in accordance with the liquid amount that can be contained in the container portion 202.

There are several methods for adjusting the period of the stirring operation. First, there is a method using a dwell angle that is a range where the cam follower 637 in contact with the inner cam surface 633e or the outer cam surface 633d is not displaced even if the cam 633 rotates. For example, the dwell angle at a position where the cam follower 637 is at the highest point is set to 40°, and the dwell angle at the lowest point is also set to 40°. In particular, when a dwell angle of 40° is ensured at the highest point, the pressing relaxing position can be maintained.

Also, an index angle that is an angle range for raising or lowering the cam follower 637 may largely be set to 140°. As effects, this decreases the load at the time of rotation of the cam 633, and the connected pressing member 60 is slowly transitioned from the pressing state to the pressing relaxing position, thereby ensuring time to move ink to the vicinity of the pressing portion 61. These make it possible to sufficiently move the ink at the time of pressing cancel and enhance the stirring effect (stirring efficiency or stirring performance).

As another method, the motor 635 is temporarily stopped at the pressing relaxing position. If time corresponding to the dwell angle of 40° is implemented by motor stop, the dwell angle can be made smaller. Hence, the index angle can be made larger, and the load at the time of cam rotation can further be reduced.

As for the timing to execute the stirring operation, it can be executed at any timing during the operation of supplying the liquid to the liquid discharge apparatus 1, during the recovery operation of the discharge head 1008 in the liquid discharge apparatus 1, during standby of the printing operation, and the like. The stirring period to repetitively perform the stirring operation may be set based on time or based on the operation count. For example, several ten minutes may be defined as one set, and the stirring operation may repetitively be performed only one set a day. Alternatively, for example, several ten times may be defined as one set, and the stirring operation may repetitively be performed only one set a day. The necessary stirring period or execution timing may be set in consideration of the sedimentation speed of the color material in the liquid.

Referring to FIG. 8, the container 200 and the support unit 4 are attached to the storage portion 23A, and these are tilted with respect to the horizontal plane, as described above. From the viewpoint of the liquid stirring effect, it is advantageous that the tilt angle is smaller than 45°, and it is more advantageous that the tilt angle is, for example, smaller than 20°, particularly, 10° or less. In the example shown in FIG. 8, the tilt angle is assumed to be 3°.

Stirring by pressing is possible even if the tilt angle is close to 90°, but the weight of the ink acts in the direction of resisting the flow of the liquid by pressing. Hence, a larger pressing force is needed to make the liquid sufficiently flow. If the tilt angle is less than 45°, the vector of the flow of the liquid toward the-Y direction is relatively small because of the weight of the liquid. As for the expansion amount of the portion of the container portion 202 on the −Y side at the time of pressing operation, if the tilt angle is 10 or less, a large expansion amount can be obtained by a smaller pressing force. If the expansion amount of the container portion 202 at the time of pressing is large, the flow amount of the liquid inside is large. That is, the efficiency of pressing is high.

Note that in this embodiment, at the pressing relaxing position, the pressing portion 61 is located at a height not to contact the bag container portion 202. However, the pressing portion 61 may contact the container portion 202, and the pressing portion 61 may be located at a position to press the container portion 202 with a pressing amount smaller than that at the pressing position. In such a slightly pushed-in state at the pressing relaxing position, the upper limit position of the pressing member 60 in the Z direction can be suppressed low, and the size of the liquid discharge apparatus 1 in the Z direction can be reduced.

Also, in this embodiment, the pressing member 60 is provided in the case 30 of the storage portion 23A. However, the pressing member 60 may be provided on the support unit 4. In this case, a configuration that enables driving transmission between the moving mechanism 63 and the pressing member 60 when the support unit 4 is attached to the storage portion 23A is added.

Additionally, in this embodiment, a configuration in which the container 200 is pressed by the pressing portion 61 has been described. For example, the container 200 may be deformed by repeating pressing and stop of compressed air. Also, the container 200 may be deformed by pressurizing and depressurizing the space around the container 200.

### (Indicator Device)

An indicator device provided in the liquid supply apparatus 20B will be described with reference to FIG. 4. On the main body 22, a state indicator 33 and a type indicator 34 are provided for each storage portion 23A. The state indicator 33 and the type indicator 34 are arranged on the front wall portion 22b to be adjacent to the opening of the corresponding storage portion 23A. Note that although not illustrated, the liquid supply apparatus 20A also includes the state indicator 33 and type indicator 34, which are the same as described above, for each storage portion 23A.

In this embodiment, the state indicator 33 is an electronic indicator and makes a notification concerning the state of the container 200 attached to the corresponding storage portion 23A. More specifically, the state indicator 33 is formed by a plurality of light emitting elements, and it is possible to notify the user of the state of the corresponding container 200 by combining drive modes (for example, light-on and blinking, light-on and light-off, blinking and light-off, or the like).

The state of the container 200 to be notified to the user is, for example, the remaining amount of the liquid in the container 200. The consumed amount (discharge amount) of the liquid contained in the container 200 can be estimated from the discharge control amount of the discharge head 1008. The remaining amount of the liquid in the container 200 is estimated based on the estimated consumed amount, and if the remaining amount is less than a threshold, one of two light emitting elements 21a and 21b is made to blink. Thus, the user can be notified of the exchange time of the container 200 and promoted to prepare the container 200 that is full of liquid.

The type indicator 34 indicates information concerning the type of the liquid assigned to the corresponding storage portion 23A. The type indicator 34 may be an electronic indicator. In this embodiment, however, it is a nonelectronic indicator and is a plate material or sheet (color label) made of paper or plastic with the color of the liquid. By the type indicator 34, the user can visually understand to which storage portion 23A the container 200 containing what kind of liquid should be attached.

### (Box-Shaped Storage Portion)

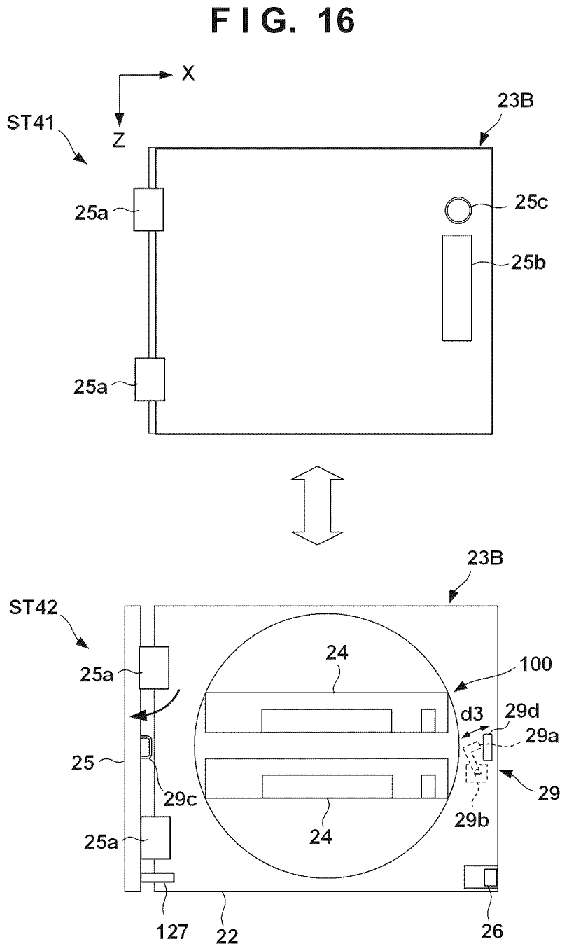

The configuration of the storage portion 23B will be described. FIG. 16 is a front view of the storage portion 23B. A state ST41 indicates a state in which the opening/closing member 25 is closed, and a state ST42 indicates a state in which the opening/closing member 25 is open.

The opening/closing member 25 is a door whose one end portion in the X direction is supported by the front wall portion 22b via a plurality of hinges 25a, and a handle 25b that the user can grasp is provided at the other end portion in the X direction. If the user pulls the handle 25b to the near side from the state ST41, the opening/closing member 25 rotates about the hinges 25a serving as a rotation center, and the inside of the storage portion 23B is exposed, as shown in the state ST42. Note that in this embodiment, the opening/closing member 25 is of a rotation type but may be of a sliding type.

A stirring unit 100 is incorporated in the storage portion 23B. A plurality of support units 24 that support the containers 200 are detachably inserted into the stirring unit 100 in the Y direction. In this embodiment, two support units 24 can be attached to the stirring unit 100. The stirring unit 100 has a function of stirring the liquid in the containers 200 supported by the support units 24. Details of the stirring unit 100 will be described later.

A sensor 26 that detects the open/closed state of the opening/closing member 25 is provided on the main body 22. The sensor 26 detects a detection piece 127 provided on the opening/closing member 25. The sensor 26 is, for example, an optical sensor and is arranged to detect the detection piece 127 in the closed state of the opening/closing member 25 and not to detect the detection piece 127 in the open state of the opening/closing member 25.

To prevent the container 200 stored in the storage portion 23B from being carelessly extracted, a regulating mechanism 29 that regulates extraction of the container 200 from the storage portion 23B is provided. The regulating mechanism 29 according to this embodiment is a lock mechanism that locks the opening/closing member 25 to the main body 22.

The regulating mechanism 29 includes a latch claw 29a provided on the main body 22, and an electric actuator 29b that rotates the latch claw 29a. The actuator 29b is, for example, a rotary solenoid. The actuator 29b rotates the latch claw 29a in the direction of an arrow d3 between a lock position at which an end portion of the latch claw 29a enters an opening portion 29d provided in the main body 22 and an unlock position at which the end portion of the latch claw 29a retreats from the opening portion 29d. FIG. 16 shows a state in which the latch claw 29a is located at the unlock position.

The opening/closing member 25 is provided with a U-shaped striker 29c that enters the opening portion 29d in the closed state. In the closed state of the opening/closing member 25, if the latch claw 29a rotates to the lock position, the striker 29c and the latch claw 29a engage with each other, and the opening/closing member 25 cannot be opened. That is, the regulating mechanism 29 is in a regulating state in which extraction of the container 200 is regulated. In the closed state of the opening/closing member 25, if the latch claw 29a rotates to the unlock position, the engagement between the striker 29c and the latch claw 29a is canceled, and the opening/closing member 25 can be opened. That is, the regulating mechanism 29 is in a regulation cancel state in which extraction of the container 200 is permitted.

An operation button 25c that the user can operate is provided on the opening/closing member 25. The operation button 25c is a push button type switch. If the operation button 25c is operated in a state in which the closed state of the opening/closing member 25 is detected by the sensor 26, the actuator 29b is controlled such that the latch claw 29a rotates between the lock position and the unlock position for each operation.

### (Support Unit)

FIG. 17 is a perspective view of the liquid container 200 and the support unit 24. The support unit 24 basically has the same configuration as the support unit 4. The support unit 24 includes a support portion 240 that supports the container 200, and has a form of a tray, as a whole, on which the container 200 in a lying posture is placed. The support portion 240 includes a placement surface 241 on which the container 200 is placed, and the four sides of the placement surface 241 are defined by left and right side plates 244, a front end portion 242, and a rear end portion 243. A notch portion 244a is formed in each side plate 244. A concave portion 243a on which the connecting portion 201 is arranged is formed at the rear end portion 243. A rib 244b extending in the Y direction is provided on each side plate 244.

### (Liquid Stirring Mechanism)

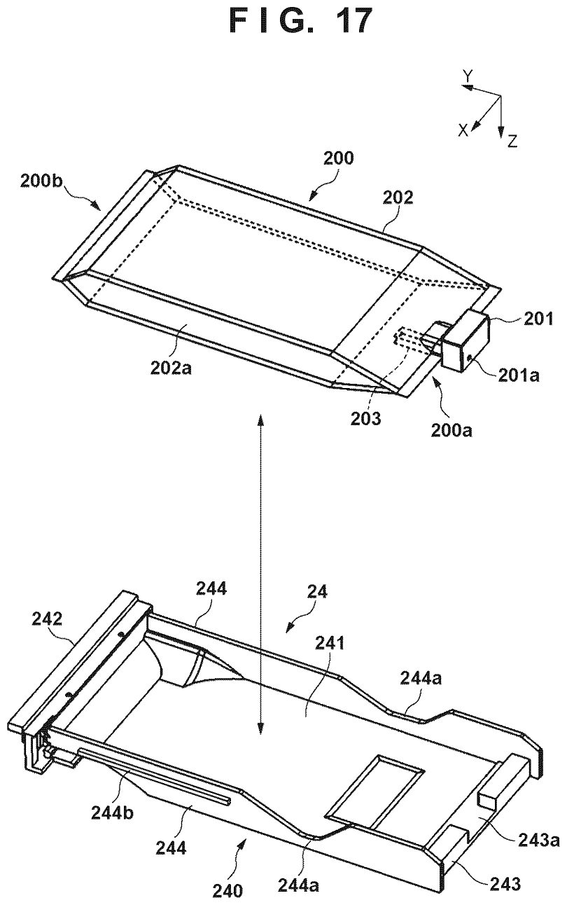

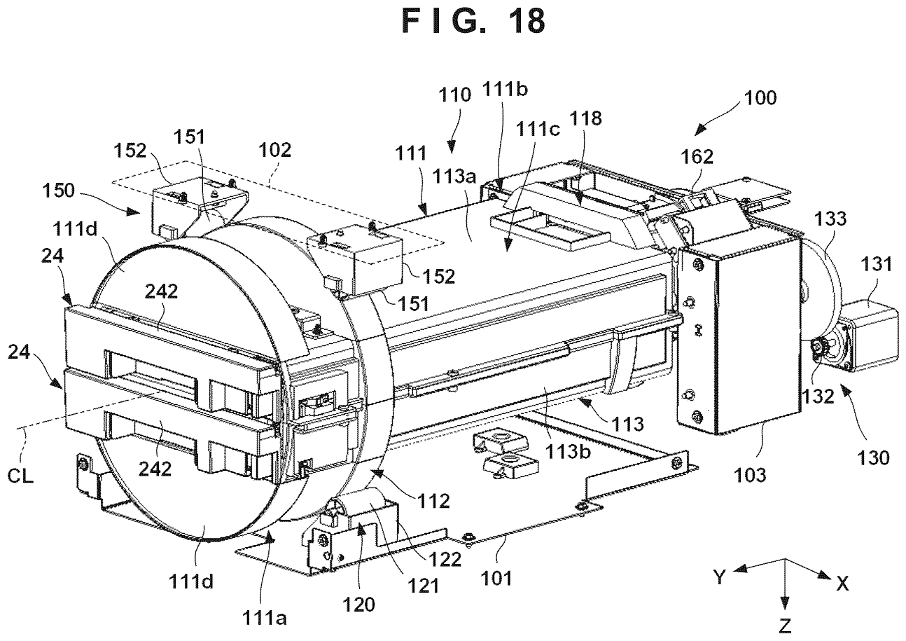

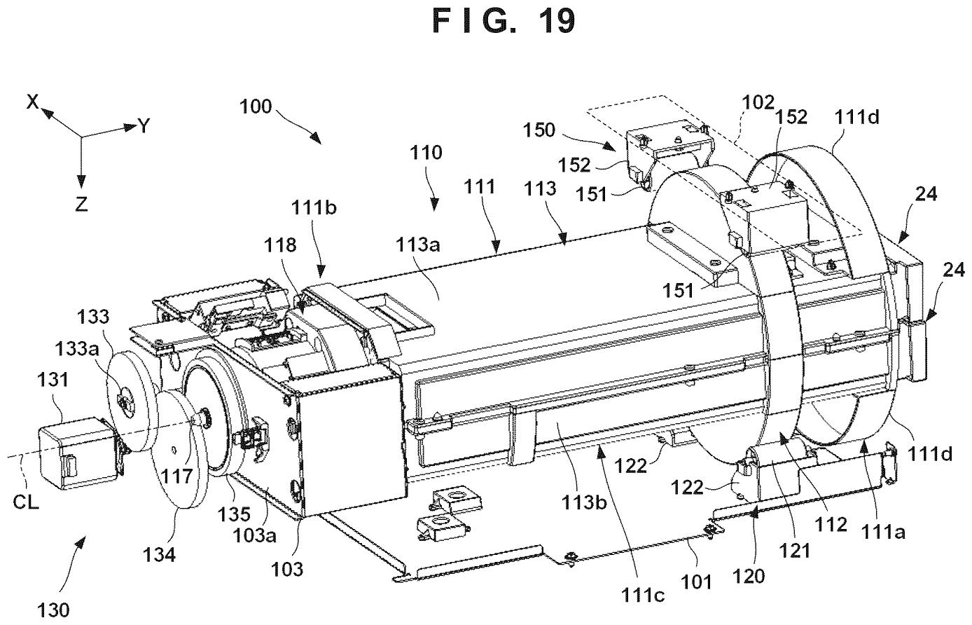

FIGS. 18 and 19 are perspective views of the stirring unit 100. FIG. 18 is a perspective view of the stirring unit 100 viewed from the front side, and FIG. 19 is a perspective view of the stirring unit 100 viewed from the rear side.

The stirring unit 100 includes a container unit 110 that stores a liquid, a support unit 120 that rotatably supports the container unit 110, and a driving unit 130 that rotates the container unit 110 supported by the support unit 120. These components are supported by the main body 22 of the liquid supply apparatus 20A via frames including frames 101 to 103.

In this embodiment, the container unit 110 is rotated about a rotational centerline CL indicated as a virtual line, thereby stirring the liquid contained in the container unit 110. When the container unit 110 is rotated, the liquid can be stirred more effectively. The rotational centerline CL is a line passing through the container unit 110, and the direction is the Y direction in this embodiment.

In this embodiment, two support units 24 are formed such that these can freely be inserted/removed to/from the container unit 110 from the front side of the container unit 110. Thus, liquids in the two containers 200 can simultaneously be stirred. The two support units 24 are attached to the container unit 110 while overlapping as two, upper and lower stages. Note that the number of attachable support units 24 may be three or more or may be one.

The driving unit 130 is arranged on the rear side of the container unit 110, and a relatively wide space is ensured on the front side of the container unit 110. This improves the insertion/removal properties of the support unit 24 for the user with respect to the container unit 110. Also, since the stirring unit 100 has a structure extending in the Y direction as a whole, the stirring unit 100 can be made compact in the X direction.

FIGS. 18 and 19 will be referred to. The container unit 110 includes a container member 111 and a shaft fixing member 118, which are connected in the direction of the rotational centerline CL.

The container member 111 is a hollow member that contains the container 200. The container member 111 includes, in the direction of the rotational centerline CL (Y direction), a front end portion 111a that is one end portion, and a rear end portion 111b that is the other end portion. Between the front end portion 111a and the rear end portion 111b, an outer wall portion 111c of the container member 111 is formed by a cylindrical tube-shaped portion 112 and a polygonal tube-shaped portion 113. The cylindrical tube-shaped portion 112 is formed on the side of the front end portion 111a with respect to the rear end portion 111b, and the polygonal tube-shaped portion 113 is formed on the side of the front end portion 111a and the side of the rear end portion 111b from the cylindrical tube-shaped portion 112. The cylindrical tube-shaped portion 112 forms a cylindrical outer peripheral surface. The polygonal tube-shaped portion 113 substantially has a rectangular tube shape. In front view of the stirring unit 100, fan-shaped cover members 111d that cover the components on the rear side of the front end portion 111a are attached to the front end portion 111a.

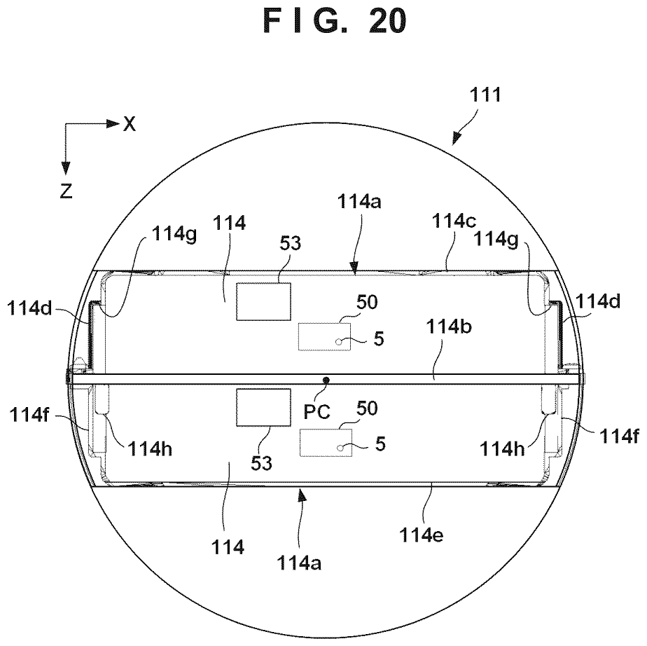

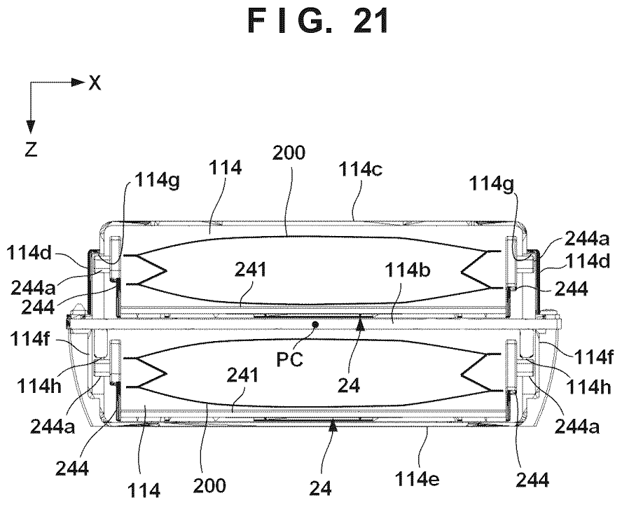

FIGS. 20 and 21 will be referred to, in addition to FIGS. 18 and 19. FIG. 20 is a front view of upper and lower container spaces 114 formed by the container member 111, and shows a state in which the support units 24 are detached from the container spaces 114. FIG. 21 is a front view of the upper and lower container spaces 114, and particularly shows a form (sectional shape) in which the support units 24 are contained in the container spaces 114. The container spaces 114 are formed throughout the cylindrical tube-shaped portion 112 and the polygonal tube-shaped portion 113. Note that matters concerning directions in the following explanation assume a case where the container unit 110 is located at the initial position, unless it is specifically stated otherwise.

The internal space of the container member 111 is divided into two, upper and lower stages by a partition wall 114b extending in the X and Y directions, and the container spaces 114 along the rotational centerline CL are formed on the upper and lower sides of the partition wall 114b. At the front end portion 111a of the container member 111, opening portions 114a serving as an exit and entrance of the container spaces 114 open.

The support unit 24 can displace in the Y direction between a containing position where the container 200 is contained in the container space 114 and an extraction position where the container 200 is exposed to the outside of the container unit 110. At the extraction position, the container 200 can be exchanged. Since the container 200 can be exchanged, a liquid replenishing work can quickly be performed, and the support unit 24 can repetitively be used. Also, in this embodiment, since structures that obstruct the exchange work rarely exist near the opening portion 114a, the exchange workability of the container 200 is high.

Note that in this embodiment, at the extraction position, the support unit 24 is apart from the container space 114. However, the extraction position may be a position where the end portion of the support unit 24 is held inside the container space 114, and can be any position where the container 200 can be exchanged with respect to the support unit 24.

On the far side of the container space 114 (the side of the end portion 111b of the container member 111), the connecting unit 50 or the reader/writer 53 described with reference to FIG. 5 is provided.

The container space 114 according to this embodiment is a flat space having a cuboid shape, which extends in the Y direction and whose height in the Z direction is shorter than the width in the X direction. Note that the container space 114 may be a flat space having a cuboid shape, which extends in the Y direction and whose height in the Z direction is longer than the width in the X direction.

The container space 114 on the upper side is defined by a top wall 114c, left and right side walls 114d, and the partition wall 114b serving as a bottom wall, and the container space 114 on the lower side is defined by a bottom wall 114e, left and right side walls 114f, and the partition wall 114b serving as a top wall. The partition wall 114b serving as the bottom wall of the container space 114 on the upper side and the bottom wall 114e of the container space 114 on the lower side can be provided with engaging portions corresponding to an engaging portion 234 that holds the support unit 24 described with reference to FIG. 7 at the containing position.

A guide portion 114g is formed on each of the left and right side walls 114d of the container space 114 on the upper side. The guide portion 114g has a sectional shape having a shoulder shape with a step or tilt, and extends in the Y direction. At the time of insertion/removal of the support unit 24 to/from the container space 114, the guide portion 114g functions as a rail that comes into slidable contact with the rib 244b of the support unit 24, and guides the displacement of the support unit 24 in the insertion/removal direction. In addition, the guide portion 114g abuts against the rib 244b in a direction (the Z direction at the initial position) crossing the direction of the rotational centerline CL, thereby regulating displacement of the support unit 24 in the crossing direction. This can suppress looseness of the support unit 24 in the container space 114 at the time of rotation of the container unit 110.

Similarly, a guide portion 114h is formed on each of the left and right side walls 114f of the container space 114 on the lower side. The guide portion 114h has a convex shape projecting downward from the partition wall 114b, and extends in the Y direction. At the time of insertion/removal of the support unit 24 to/from the container space 114, the guide portion 114h functions as a rail that comes into slidable contact with the rib 244b of the support unit 24, and guides the displacement of the support unit 24 in the insertion/removal direction. In addition, the guide portion 114h abuts against the rib 244b in a direction (the Z direction at the initial position) crossing the direction of the rotational centerline CL, thereby regulating displacement of the support unit 24 in the crossing direction. This can suppress looseness of the support unit 24 in the container space 114 at the time of rotation of the container unit 110.

A rotation center PC of the container unit 110 is located on the partition wall 114b. The rotation center PC is an arbitrary point on the rotational centerline CL. According to the configuration of this embodiment, since the rotational centerline CL passes between the two container spaces 114, the liquids in the two containers 200 can be stirred more evenly by the container unit 110.

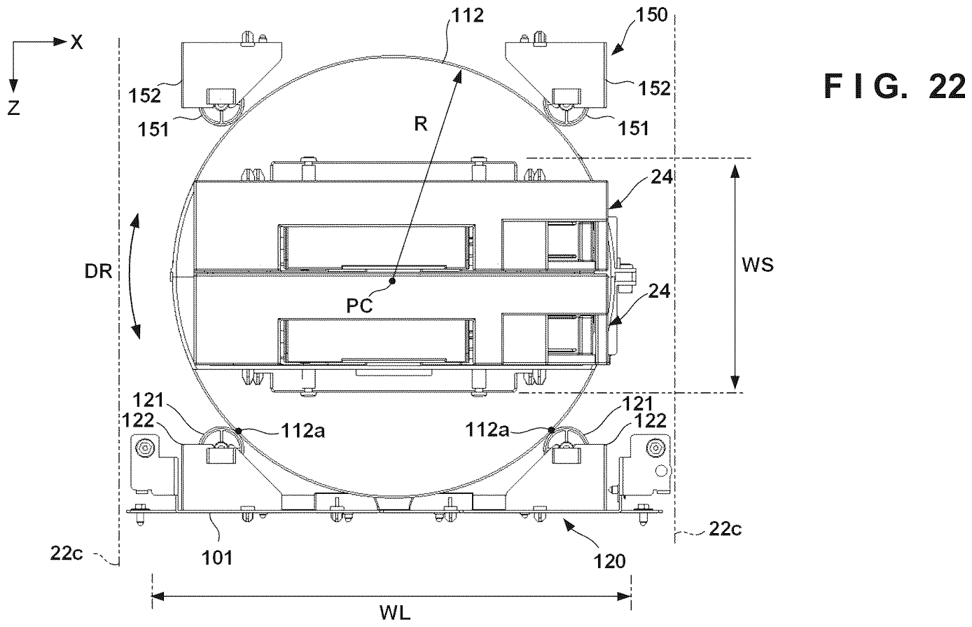

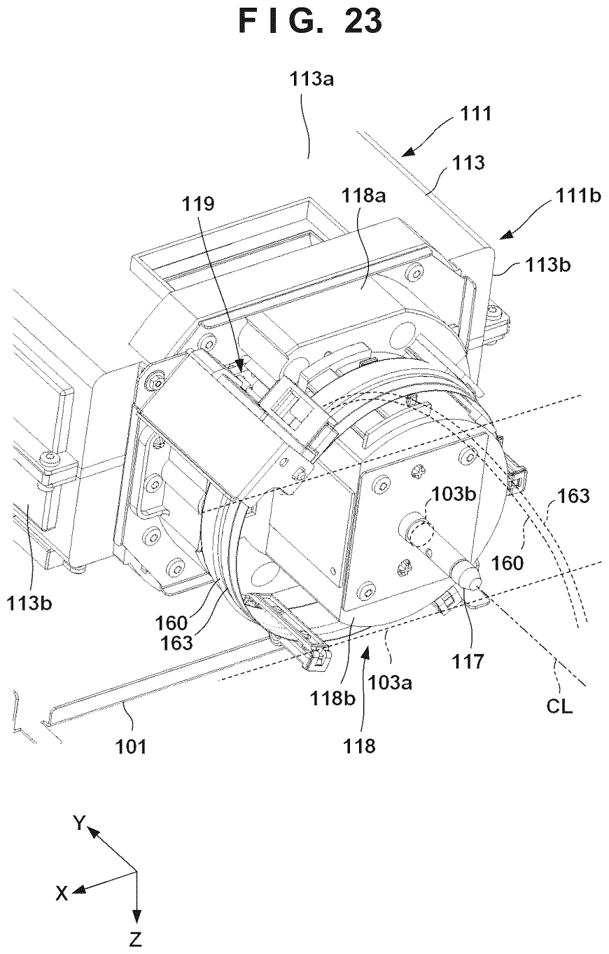

A structure that rotatably supports the container unit 110 will be described with reference to FIGS. 18, 19, 22, and 23. FIG. 22 is a front view of the stirring unit 100 and mainly shows the rotation support structure of the container unit 110. FIG. 23 is a perspective view showing the rear portion of the container unit 110 in a state in which the driving unit 130 is detached.

If the container unit 110 includes a shaft between two end portions on the rotational centerline CL, the existence of the shaft and bearings may lower the degree of freedom of design or lower the convenience for the user. For example, in a structure in which the support unit 24 is inserted/removed into/from the container unit 110, as in this embodiment, the insertion/removal point or the insertion/removal direction may be restricted. Also, in a structure in which a large capacity of liquid is stored and stirred, the rigidity of the shaft and the bearings need to be increased in consideration of the weight of the liquid.

In this embodiment, the problem is solved by combining the support unit 120 that is a shaftless support structure, and a support structure with shaft (a shaft member 117 and a bearing member 103a to be described later).

The support unit 120 is a mechanism that rotatably supports the container unit 110 by abutting against the outer wall portion 111c of the container unit 110. In the support unit 120 according to this embodiment, a plurality of abutment portions 121 abut against the cylindrical tube-shaped portion 112 of the container member 111, thereby rotatably supporting the container unit 110 about the rotational centerline CL. In this embodiment, the support unit 120 includes two abutment portions 121, and the two abutment portions 121 abut against the cylindrical tube-shaped portion 112 at abutment positions 112a apart in the circumferential direction of the cylindrical tube-shaped portion 112.

Each abutment portion 121 according to this embodiment is a roller that is supported by a bearing 122 about an axis in a direction (Y direction) parallel to the rotational centerline CL. The bearing 122 is supported by the frame 101. The peripheral surface of the abutment portion (roller) 121 abuts against the cylindrical tube-shaped portion 112, and the container unit 110 can roll in the direction of an arrow DR in FIG. 12 in the spot in a state in which it is placed between the two abutment portions (rollers) 121. Since the container unit 110 is supported from below by the two abutment portions 121, even if the container unit 110 stores a large capacity of liquid, and the weight of the liquid is large, structural stability can be obtained without needing to greatly increase the rigidity.

The cylindrical tube-shaped portion 112 is formed on the side of the front end portion 111a with respect to the rear end portion 111b of the container member 111, and the support unit 120 rotatably supports the container unit 110 at a position on the side of the front end portion 111a with respect to the rear end portion 111b. The container unit 110 is supported by the shaftless support unit 120 near the opening portions 114a serving as an exit and entrance to insert/remove the support units 24 into/from the container spaces 114. Since there is neither a shaft nor a bearing in the front portion of the stirring unit 100, the convenience of the insertion/removal work of the support unit 24 by the user can be improved. Also, in the insertion/removal work of the support unit 24, a load in the gravity direction readily acts near the opening portions 114a in some cases. However, since the two abutment portions 121 support the container unit 110 from below near the opening portions 114a, it is possible to stably receive the load.

In addition, since the container member 111 has a structure including the cylindrical tube-shaped portion 112 and the polygonal tube-shaped portion 113, it is possible to reduce the weight and decrease the moment of inertia of rotation as compared to a case where the whole structure is formed by the cylindrical tube-shaped portion 112. The polygonal tube-shaped portion 113 includes long side portions 113a and short side portions 113b, which form the outline of the rectangle. In this embodiment, a width WL of the long side portion 113a, a width WS of the short side portion 113b, and a radius R of the cylindrical tube-shaped portion 112 hold relationships given by WL>WS, and WS<2×R. Since the width WS of the polygonal tube-shaped portion 113 is smaller than the diameter (2×R) of the cylindrical tube-shaped portion 112, it is possible to reduce the weight and decrease the moment of inertia of rotation.

On the other hand, a relationship given by WL>2×R holds, and the cylindrical tube-shaped portion 112 and the abutment positions 112a are located inside a virtual circle VC that passes through the outermost portion of the container unit 110 and has the rotation center PC as the center. Hence, the stirring unit 100 can be made compact. A side wall 22c of the storage portion 23B can be made closer to the container unit 110, and the stirring unit 100 can be made compact in the X direction.

The shaft member 117 is provided in the rear portion of the container unit 110 (the side of the rear end portion 111b). The shaft member 117 is fixed at an end portion of the shaft fixing member 118 and extended on the rotational centerline CL. The shaft fixing member 118 is a hollow body including a flange portion 118a fixed to the rear end portion 111b of the container member 111, and a trunk portion 118b extending backward from the flange portion 118a, and the shaft member 117 is fixed to the end portion of the trunk portion 118b. The frame 103 includes a plate-shaped bearing member 103a, and the shaft member 117 is inserted to a shaft hole 103b and supported. Since not only the support unit 120 but also the shaft member 117 and the bearing member 103a rotatably support the container unit 110, a shift of the rotation center PC of the container unit 110 can be prevented, and more stable rotation can be implemented. Since the shaft member 117 and the bearing member 103a are located on the opposite side of the container unit 110 with respect to the opening portions 114a, the convenience of the insertion/removal work of the container support unit 24 by the user is not deteriorated.

The stirring unit 100 also includes a regulating unit 150 that regulates the displacement of the container member 111 in a direction crossing the rotational centerline CL. The regulating unit 150 according to this embodiment regulates the displacement of the container member 111 upward in the Z direction. When inserting/removing the support unit 24, if a force in an upward direction acts on the front side of the container unit 110, and the posture tilts, a load in a bending direction acts on the shaft member 117. When the regulating unit 150 is provided, such a posture change can be prevented.

The regulating unit 150 according to this embodiment includes a plurality of abutment portions 151 that face the cylindrical tube-shaped portion 112 in the Z direction at positions on the upper side of the rotational centerline CL. If the container member 111 is going to displace upward, the plurality of abutment portions 151 abut against the cylindrical tube-shaped portion 112 and physically stop the displacement. The plurality of abutment portions 151 may always abut against the cylindrical tube-shaped portion 112, or may be located at positions slightly apart in the Z direction in a normal state (in a case where no external force is applied).

In this embodiment, the regulating unit 150 includes two abutment portions 151, and the two abutment portions 151 are arranged apart in the circumferential direction of the cylindrical tube-shaped portion 112. Each abutment portion 151 according to this embodiment is a roller that is supported by a bearing 152 about an axis in a direction (Y direction) parallel to the rotational centerline CL. The bearing 152 is supported by the frame 102.

The X-and Y-direction positions of the two abutment portions 151 are the same as those of the two abutment portions 121 of the support unit 120. Same components can be used for the two sets of the abutment portions 151 and the bearings 152 and the two abutment portions 121 and the bearings 122 of the support unit 120. Component types can be reduced by sharing the components.

The structure of the driving unit 130 will be described with reference to FIGS. 18 and 19. The driving unit 130 is arranged on the outer side (rear side) of the rear end portion 111b of the container member 111 in the direction of the rotational centerline CL. Since the driving unit 130 is arranged on the opposite side of the container unit 110 with respect to the opening portions 114a, mechanisms existing around the opening portions 114a can be decreased, and the convenience of the insertion/removal work of the support unit 24 by the user can be improved.

The driving unit 130 includes a motor 131 as a driving source. The motor 131 is fixed to a frame (not shown). A gear 132 is attached to the output shaft of the motor 131. In this embodiment, the motor 131 is a stepping motor. The rotation amount of the container unit 110 can be controlled by the rotation amount of the motor 131. The motor 131 may be a DC motor, and in this case, a rotation amount sensor such as a rotary encoder may be provided to control the rotation amount.

The driving unit 130 includes gears 133, 134, and 135. The gears 133 and 134 are rotatably supported by a frame (not shown). Each of the gears 133 and 134 is a two-stage gear, the gear 132 and the large gear of the gear 133 mesh with each other, and the large gear of the gear 134 meshes with the small gear of the gear 133. In addition, the gear 135 meshes with the small gear of the gear 134. Between the small gear and the large gear of the gear 133, a torque limiter 133a capable of blocking driving transmission between these is provided. By the torque limiter 133a, it is possible to prevent an overload from acting on the motor 131. Also, if the user erroneously touches the container unit 110 during rotation of the container unit 110, the torque limiter 133a blocks transmission of the driving force, and it is therefore possible to prevent a high load from acting on the user's hand.

The gear 135 is fixed to the shaft member 117. When the motor 131 is driven, the driving force is transmitted to the shaft member 117, and the container unit 110 rotates. The bearing member 103a is located between the gear 135 and the shaft fixing member 118, and the container unit 110 is positioned by these in the direction of the rotational centerline CL. Note that in this embodiment, a gear mechanism is used as the mechanism for transmitting the driving force from the motor 131 to the shaft member 117, but a transmission mechanism of another type such as a belt transmission mechanism may be used.

A structure configured to discharge the liquid from the container 200 via the path forming member 5 will be described with reference to FIGS. 19 and 23. Between the rear end portion 111b of the container member 111 and the shaft fixing member 118, a discharge unit 119 is provided at the rear end portion 111b. In the discharge unit 119, a passage valve corresponding to the passage valve 52 in FIG. 5 is provided for each container space 114 and communicates with the corresponding path forming member 5.

In this embodiment, it is assumed that the containers 200 containing a liquid of the same type are stored in the two container members 111. For this reason, the passage valves communicate with a common tube 160, and the liquid is supplied to the liquid discharge apparatus 1 via the tube 160. In a partial section, the tube 160 is routed together with an electric cable (for example, a flexible flat cable) 163. The electric cable 163 includes, for example, the electric wires of the motor and the sensor.

### (Stirring Operation)

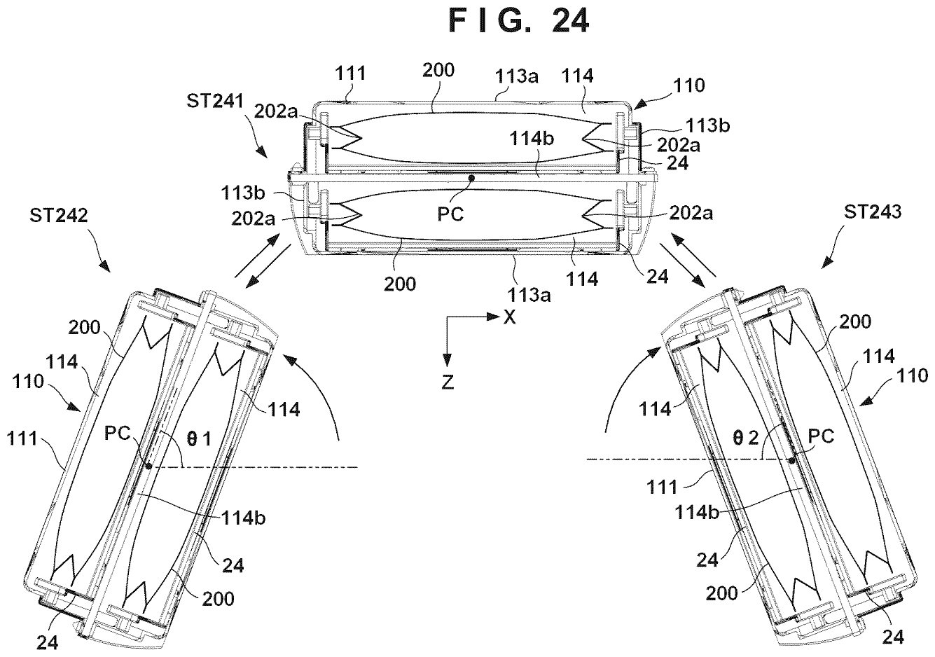

FIG. 24 shows an example of a stirring operation (the rotation operation of the container unit 110) by driving of the driving unit 130. A state ST241 indicates a state in which the container unit 110 is located at the initial position. At the initial position, the container member 111 is in a horizontal posture with the long side portions 113a being horizontal. The support portion 240 of the support unit 24 and the container 200 in each container space 114 are also in the horizontal posture, and the gusset portions 202a on both side surfaces of the container 200 are located at the same height.

A state ST242 indicates a tilting state in which the container unit 110 rotates counterclockwise from the initial position by an angle θ1. The position of the container unit 110 in this state is called a left tilting position. As for the gusset portions 202a on both side surfaces of the container 200, the gusset portion 202a on the right side in FIG. 24 is located at a position higher than that of the gusset portion 202a on the left side. The liquid in the container 200 flows from the side of the gusset portion 202a on the right side to the side of the gusset portion 202a on the left side.

A state ST243 indicates a tilting state in which the container unit 110 rotates clockwise from the initial position by an angle θ2. The position of the container unit 110 in this state is called a right tilting position. As for the gusset portions 202a on both side surfaces of the container 200, the gusset portion 202a on the left side in FIG. 24 is located at a position higher than that of the gusset portion 202a on the right side. The liquid in the container 200 flows from the side of the gusset portion 202a on the right side to the side of the gusset portion 202a on the left side.

When the posture of the container unit 110 is repetitively changed as, for example, state ST241→state ST242→state ST241→state ST243→state ST241→ . . . , the liquid in the container 200 can be stirred.

When changing the posture of the container unit 110 from the state ST242 to the state ST243, rotation may be temporarily stopped in the state ST241 halfway. Conversely, the posture of the container unit 110 may continuously be changed from the state ST241 to the state ST243 without stopping rotation in the state ST241 halfway. This also applies to a case where the posture of the container unit 110 is changed from the state ST243 to the state ST242.

Alternatively, between the state ST242 and the state ST243, without stopping rotation in the state ST241 halfway, the posture of the container unit 110 may continuously be changed a plurality of times, and after that, rotation may be stopped for a predetermined time in the state ST241. This operation may repetitively be performed. While power consumption of the motor 131 is reduced by stopping rotation for a predetermined time in the state ST241, the rotation is resumed before sedimentation of the particles in the liquid progresses, thereby maintaining the evenness of the liquid.

The angle θ1 and the angle θ2 may be the same angle or may be different angles. The angle θ1 and the angle θ2 may be the same angle if the stirring operation is performed under a certain condition, and may be different angles if the stirring operation is performed under another condition. If the angle θ1 and the angle θ2 are different angles, the magnitude relationship may alternately be switched between θ1>θ2 and θ1<θ2.

### <Control Circuit>

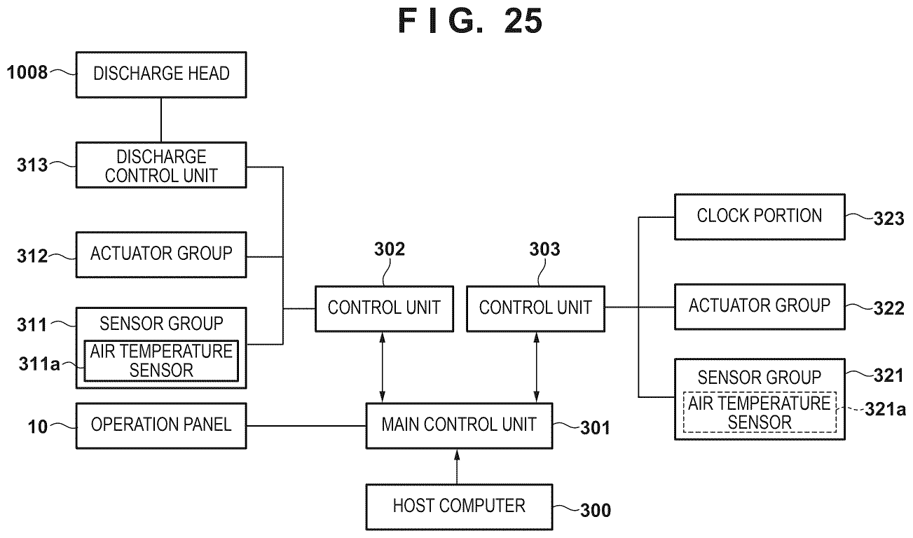

The configuration of the control circuit of the system A will be described with reference to FIG. 25. FIG. 25 is a block diagram of the control circuit of the system A. A main control unit 301 controls the entire system A in accordance with an instruction from a host computer 300 or the operation panel 10. A control unit 302 controls the liquid discharge apparatus 1 based on an instruction of the main control unit 301, and a control unit 303 controls the liquid supply apparatuses 20A and 20B based on an instruction of the main control unit 301. The main control unit 301 and the control units 302 and 303 each include, for example, at least one processor, at least one memory device, and at least one input/output interface. The memory device is, for example, a semiconductor memory such as a RAM or a ROM. The input/output interface performs input/output of signals between the processor and an external device (a sensor, a motor, or the like).

A discharge control unit 313 performs control of the discharge head 1008, particularly, discharge control of the liquid. An actuator group 312 includes a conveyance motor that is the driving source of the conveyance unit 1006, a carriage motor that is the driving source of the moving mechanism of a carriage (not shown), a winding motor that is the driving source of the winding unit 1005, and a recovery motor that is the driving source of the recovery unit 1009. The actuator group 312 further includes a cutter motor that is the driving source of a cutter (not shown) configured to cut the print medium M after image printing. A sensor group 311 includes various kinds of sensors provided in the liquid discharge apparatus 1. In this embodiment, the sensor group 311 includes an air temperature sensor 311a. The air temperature sensor 311a is a temperature sensor that is provided inside or outside the liquid discharge apparatus 1 and detects the air temperature in the installation environment of the system A. The detection result of the air temperature sensor 311a is provided to the control unit 303 as well via the control unit 302 and the main control unit 301.

A clock portion 323 is a counter that outputs a count result of an elapsed time to the control unit 303. If a liquid stirring period is managed by time, the count result of the clock portion 323 can be used. Also, the stirring timing can be decided using the count result of the clock portion 323.

An actuator group 322 includes the motors 131 and 635, the passage valve 52, an actuator 29b, and the like. A sensor group 321 includes the operation button 25c, the sensor 26, the sensor 31, the sensor 38, and the like. In this embodiment, the air temperature sensor 311a is provided in the liquid discharge apparatus 1. Instead, an air temperature sensor 321a may be provided inside or outside the liquid supply apparatus 20. The air temperature sensor 321a is a temperature sensor that detects the air temperature in the installation environment of the system A.

### (Example of Processing of Control Circuit)

### (Execution Processing of Stirring Operation)

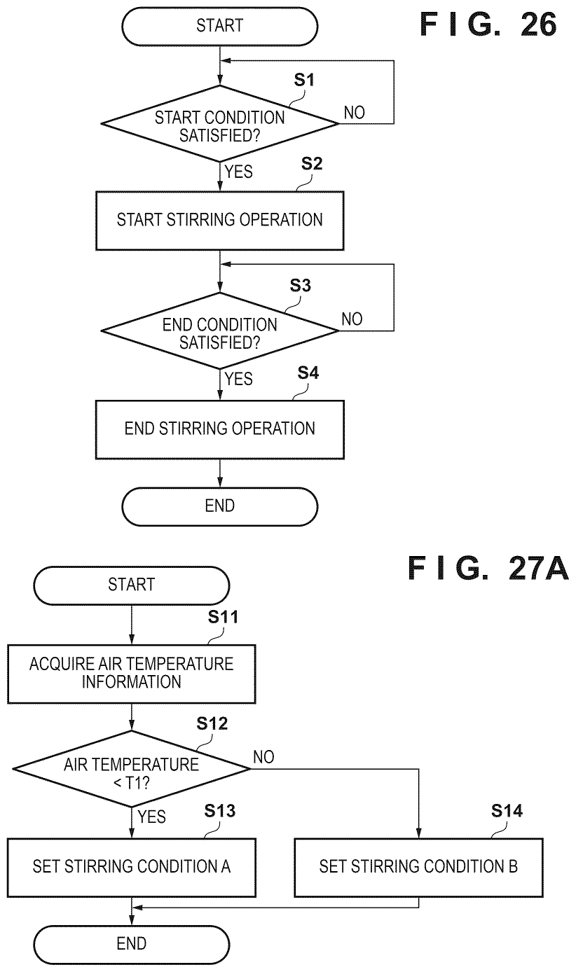

Concerning the stirring operation of each of the stirring units 6 and 100, an example of processing executed by the control unit 303 will be described. FIG. 26 is a flowchart showing an example of processing executed by the control unit 303, and this is processing applied to control of the stirring units 6 and 100. The processing shown in FIG. 26 is executed periodically and repetitively.

In step S1, it is determined whether a start condition is satisfied. If the start condition is satisfied, the process advances to step S2. In this embodiment, the start condition is defined by a stirring condition to be described later. Except for the stirring condition, the start condition may be satisfied in a case where the user instructs to perform stirring via the operation panel 10 or the like.

In step S2, the stirring operation is started based on the stirring condition to be described later. In a case of the stirring unit 6, the motor 635 is driven to drive the moving mechanism 63, thereby rotating the pressing member 60. The pressing portion 61 reciprocally moves between the pressing relaxing position and the pressing position, and the pressing operation and the pressing relaxing operation are repeated. In a case of the stirring unit 100, the motor 131 is driven, thereby rotating the container unit 110 between the initial position, the right tilting position, and the left tilting position.

In step S3, it is determined whether an end condition is satisfied. If the end condition is satisfied, the process advances to step S4. In this embodiment, the end condition is defined by a stirring condition to be described later. The end condition may be satisfied in a case where the user instructs to end the stirring via the operation panel 10 or the like. In step S4, the stirring operation is ended. The processing is thus ended.

### (Stirring Condition Selection Processing)

The stirring condition of the stirring units 6 and 100 will be described. The fluidity of the liquid in the container 200 is affected by the temperature. The temperature of the liquid is affected by the air temperature in the environment in which the liquid supply apparatus 20 is installed. If the stirring operation for the container 200 is performed based on the same condition regardless of the air temperature, the evenness of the liquid inside varies. For example, if the stirring operation is performed in a situation in which the fluidity is poor under a low temperature, the sediment in the container 200 may not be sufficiently dispersed. If the stirring condition is adapted to the stirring operation under the low temperature, power may wastefully be consumed in the stirring operation in a situation in which the fluidity is high under a high temperature.

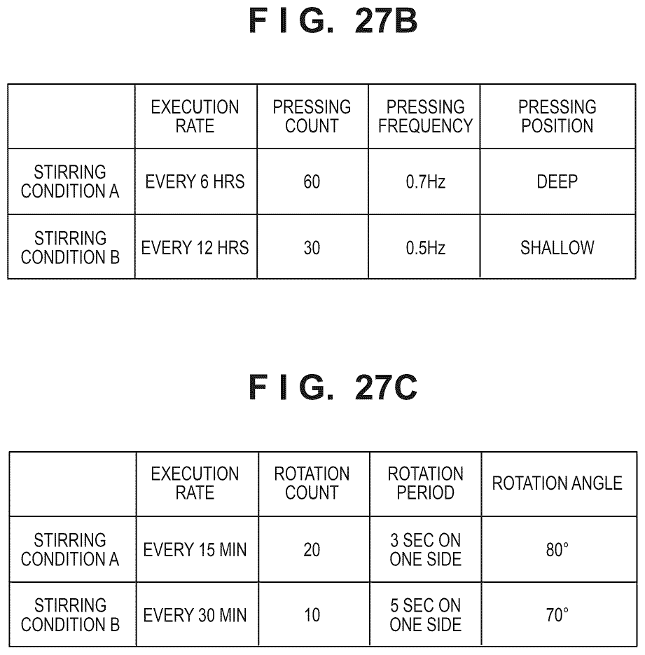

In this embodiment, the stirring condition is changed based on air temperature information indicating the air temperature in the installation environment of the system A. As one mode of changing the stirring condition, in this embodiment, a plurality of types of stirring conditions are prepared, and one of those is selected and set based on the air temperature information. FIG. 27A is a flowchart showing an example of stirring condition selection processing executed by the control unit 303. This is processing applied to control of the stirring units 6 and 100. The processing shown in FIG. 27A is executed periodically and repetitively.

In step S11, air temperature information is acquired. In this embodiment, the detection result of the air temperature sensor 311a is acquired as air temperature information. However, as described with reference to FIG. 25, if the air temperature sensor 321a is provided, the detection result of the air temperature sensor 321a may be acquired as air temperature information. Also, an air temperature that the user inputs from the operation panel 10 may be acquired as air temperature information.

In step S12, it is determined whether the air temperature indicated by the air temperature information acquired in step S11 is less than a threshold temperature T1. If the air temperature is less than the threshold temperature T1, the process advances to step S13. If the air temperature is equal to or more than the threshold temperature T1, the process advances to step S14. The threshold temperature T1 is a temperature in the range of, for example, 12 to 18 degrees Celsius (more specifically, for example, 15°).

In this embodiment, two types of stirring conditions are prepared. In step S13, a stirring condition A is selected. In step S14, a stirring condition B is selected. The selection result of the stirring condition is set by storing it in a predetermined storage area of the memory device of the control unit 303.

In this embodiment, the stirring condition A is a condition of higher stirring performance than the stirring condition B. Since the fluidity of the liquid lowers under an environment with a relatively low air temperature, the stirring condition A of high stirring performance is selected. Under an environment with a relatively high air temperature, the stirring condition B of low stirring performance is selected to reduce power consumption.

FIG. 27B shows an example of the stirring conditions A and B associated with the stirring unit 6. The stirring condition includes “execution rate”, “pressing count”, “pressing frequency”, and “pressing position”. “Execution rate” is the start condition of the stirring operation and defines, in the example shown in FIG. 27B, time from the preceding stirring operation to the current stirring operation. In the stirring condition A, since the time is shorter than the stirring condition B, the stirring operation is performed at a higher rate. That is, the stirring performance is high.

“Pressing count” is the end condition of the stirring operation and is, in the example shown in FIG. 27B, the count that the pressing portion 61 moves from the pressing relaxing position to the pressing position (in other words, the count of reciprocation between the pressing relaxing position and the pressing position). In the stirring condition A, since the pressing count is larger than the stirring condition B, the stirring performance is high.

“Pressing frequency” is the reciprocal of time of one reciprocation of the pressing portion 61 between the pressing relaxing position and the pressing position. The lower the frequency is, the lower the moving speed of the pressing portion 61 is. Since the flowing of the liquid is reliably executed, the stirring performance is high. In the stirring condition A, since the pressing frequency is lower than the stirring condition B, the stirring performance is high.

“Pressing position” is the stroke of the pressing portion 61 moving form the pressing relaxing position to the pressing position. “Deep” indicates that the stroke is long, that is, the pressing amount is large. “Shallow” indicates that the stroke is short, that is, the pressing amount is small. In the stirring condition A, since the pressing position is deeper than the stirring condition B, the stirring performance is high.

FIG. 27C shows an example of the stirring conditions A and B associated with the stirring unit 100. The stirring condition includes “execution rate”, “rotation count”, “rotation period”, and “rotation angle”. “Execution rate” is the start condition of the stirring operation and defines, in the example shown in FIG. 27C, time from the preceding stirring operation to the current stirring operation. In the stirring condition A, since the time is shorter than the stirring condition B, the stirring operation is performed at a higher rate. That is, the stirring performance is high.

“Rotation count” is the end condition of the stirring operation and is, in the example shown in FIG. 27C, the rotation count of the container unit 110 exemplified in FIG. 24 between the initial position, the right tilting position, and the left tilting position. In the stirring condition A, since the rotation count is larger than the stirring condition B, the stirring performance is high.

“Rotation period” is time of reciprocation of the container unit 110 between the initial position and the right tilting position (this also applies to time of reciprocation between the initial position and the left tilting position). The shorter the period is, the higher the rotation speed of the container unit 110 is, and the higher the stirring performance is. In the stirring condition A, since the rotation period is shorter than the stirring condition B, the stirring performance is high.

“Rotation angle” is the angle of the right tilting position of the container unit 110 with respect to the initial position (this also applies to the angle of the left tilting position with respect to the initial position). The larger the angle is, the larger the posture change amount of the container 200 is, and the more the liquid inside is stirred. In the stirring condition A, since the rotation angle is larger than the stirring condition B, the stirring performance is high.

As described above, in this embodiment, since the stirring condition is changed based on the air temperature, it is possible to improve the evenness of the liquid by stirring.

### Second Embodiment

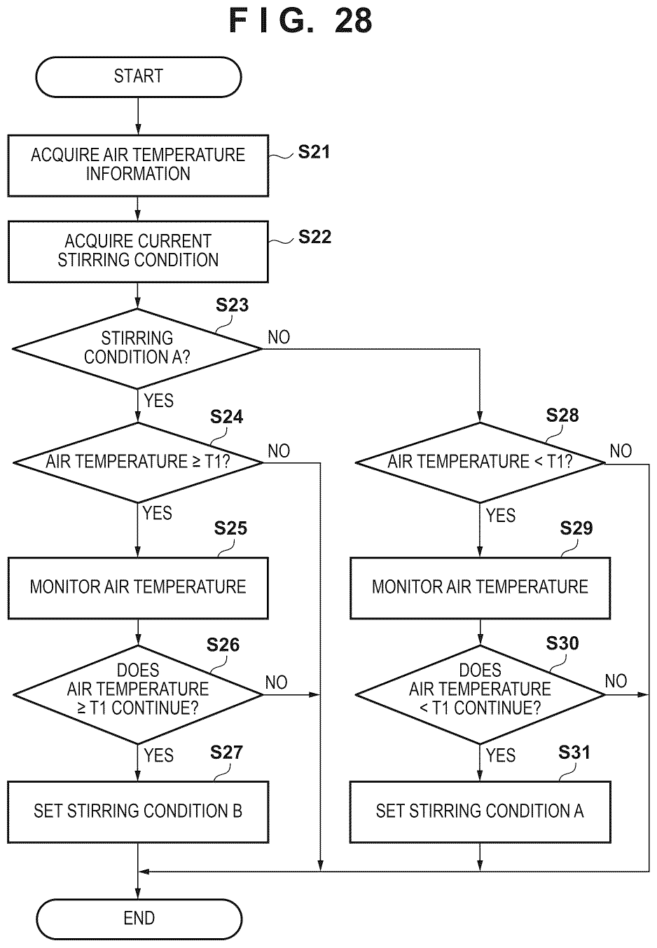

Since a liquid is contained in a container 200, and the container 200 is stored in a liquid supply apparatus 20, a predetermined time is needed until a change of the air temperature affects the liquid in the container 200. In this embodiment, if the magnitude relationship between an air temperature indicated by air temperature information and a threshold temperature T1 continues for a predetermined time, the stirring condition is switched. FIG. 28 is a flowchart showing an example of stirring condition selection processing replacing FIG. 27A. The processing shown in FIG. 28 is executed periodically and repetitively.

In step S21, air temperature information is acquired. This is the same processing as in step S11 of FIG. 27A. In step S22, the current type of stirring condition stored in a memory device is acquired. In step S23, it is determined whether the type acquired in step S22 is a stirring condition A or a stirring condition B. If it is the stirring condition A, the process advances to step S24. If it is the stirring condition B, the process advances to step S28.

In step S24, it is determined whether an air temperature indicated by the air temperature information acquired in step S21 is equal to or more than the threshold temperature T1. If the air temperature is equal to or more than the threshold temperature T1, the process advances to step S25. If the air temperature is less than the threshold temperature T1, the processing is ended (selection of the stirring condition A is maintained).

In step S25, monitoring of the air temperature is executed. Here, the air temperature information is repetitively acquired, and it is determined whether a state in which the air temperature indicated by the air temperature information is equal to or more than the threshold temperature T1 continues for a predetermined time Ta (for example, 12 hours). In step S26, it is determined, as a result of monitoring in step S25, whether the state in which the air temperature indicated by the air temperature information is equal to or more than the threshold temperature T1 continues for the predetermined time Ta. If the state continues, the process advances to step S27. If the state does not continue, the processing is ended (selection of the stirring condition A is maintained). In step S27, the setting of the stirring condition is switched from the stirring condition A to the stirring condition B.

In step S28, it is determined whether the air temperature indicated by the air temperature information acquired in step S21 is less than the threshold temperature T1. If the air temperature is less than the threshold temperature T1, the process advances to step S29. If the air temperature is equal to or more than the threshold temperature T1, the processing is ended (selection of the stirring condition B is maintained).

In step S29, monitoring of the air temperature is executed. Here, the air temperature information is repetitively acquired, and it is determined whether a state in which the air temperature indicated by the air temperature information is less than the threshold temperature T1 continues for a predetermined time Tb (for example, 12 hrs). In step S30, it is determined, as a result of monitoring in step S29, whether the state in which the air temperature indicated by the air temperature information is less than the threshold temperature T1 continues for the predetermined time Tb. If the state continues, the process advances to step S31. If the state does not continue, the processing is ended (selection of the stirring condition B is maintained). In step S31, the setting of the stirring condition is switched from the stirring condition B to the stirring condition A.

As described above, in this embodiment, if the magnitude relationship between the air temperature indicated by the air temperature information and the threshold temperature T1 continues for a predetermined time, the stirring condition is switched. It is therefore possible to select a stirring condition more suitable for the actual temperature of the liquid contained in the container 200.

Note that the predetermined time Ta in steps S25 and S26 and the predetermined time Tb in steps S29 and S30 may be the same time or different times. In a case of different times, for example, times like 6 hrs and 12 hrs may be selected from a plurality of times. As for the relationship between the predetermined time Ta and the predetermined time Tb, if the predetermined time Tb is shorter than the predetermined time Ta, the stirring condition can quickly be changed when the air temperature lowers, and the evenness of the liquid can be improved. Also, if the predetermined time Ta is shorter than the predetermined time Tb, the stirring condition can quickly be changed when the air temperature rises, and power consumption can be reduced.

### Third Embodiment

In the first and second embodiments, two types of stirring conditions, that is, the stirring condition A and the stirring condition B have been exemplified. However, three or more types of stirring conditions may be used. Also, each of the stirring conditions exemplified in FIGS. 27B and 27C includes four types of conditions, but these may be three or less, or five or more types. Also, the number of types of stirring conditions may be different between a stirring unit 6 and a stirring unit 100.

### Fourth Embodiment

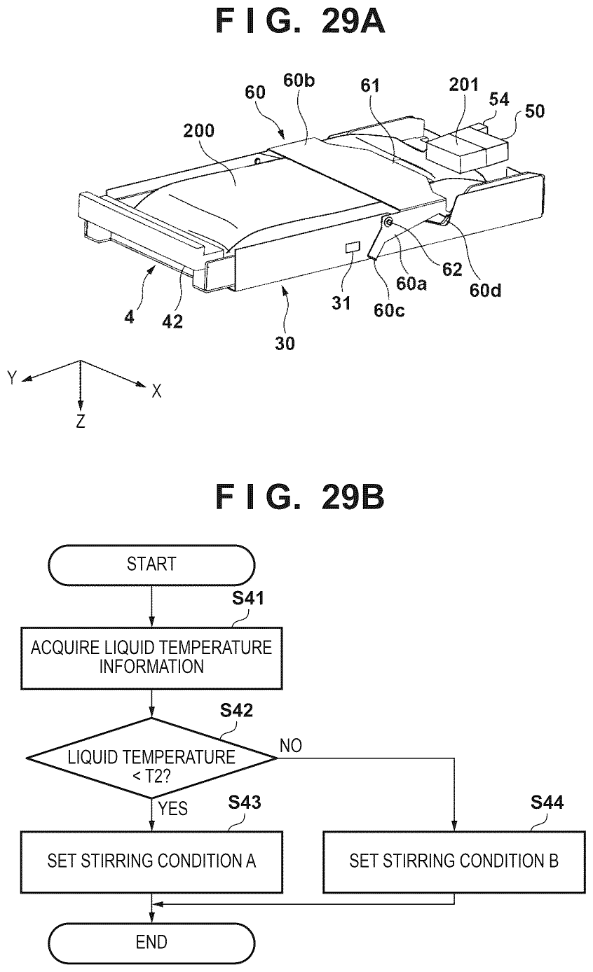

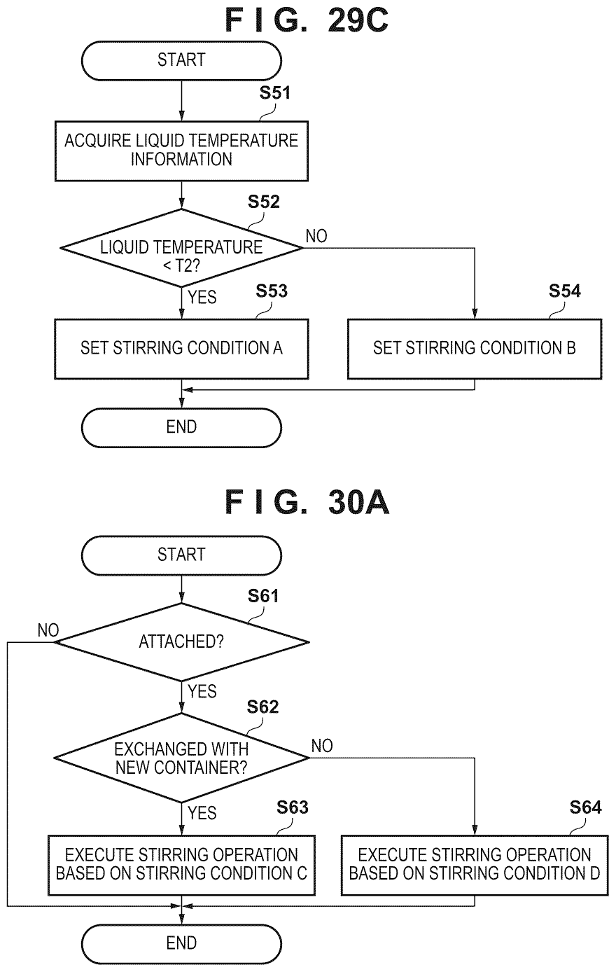

In the first to third embodiments, the stirring condition is changed based on the air temperature. However, the stirring condition may be changed by detecting the temperature of a liquid contained in a container 200. FIG. 29A shows an example of the arrangement of a liquid temperature sensor 54 that detects the temperature of a liquid. The liquid temperature sensor 54 is provided in a connecting unit 50 of each storage portion 23A having a stirring function by a stirring unit 6, and detects the temperature of a liquid passing through the connecting unit 50. By detecting the liquid temperature in the connecting unit 50, the liquid temperature can be detected at a position close to the container 200, and the accuracy of detecting the temperature of the liquid in the container 200 can be improved. Note that although not illustrated, even for a storage portion 23B having a stirring function by a stirring unit 100, the liquid temperature sensor 54 is similarly provided in each connecting unit 50.

FIGS. 29B and 29C are each a flowchart showing an example of stirring condition selection processing replacing FIG. 27A. FIG. 29B shows stirring condition selection processing of the stirring unit 6, and FIG. 29C shows stirring condition selection processing of the stirring unit 100. The processing shown in each of FIGS. 29B and 29C is executed periodically and repetitively.

FIG. 29B will be described. In step S41, the detection result of the liquid temperature sensor 54 of each storage portion 23A having the stirring function by the stirring unit 6 is acquired as liquid temperature information. In step S42, it is determined whether one of liquid temperatures indicated by the liquid temperature information acquired in step S41 is less than a threshold temperature T2. If one of the liquid temperatures is less than the threshold temperature T2, the process advances to step S43. If the liquid temperatures are equal to or more than the threshold temperature T2, the process advances to step S44. The threshold temperature T2 is a temperature in the range of, for example, 12 to 18 degrees Celsius (more specifically, for example, 15°).

In step S43, a stirring condition A is selected. In step S44, a stirring condition B is selected. As the stirring conditions A and B, those exemplified in FIG. 27B can be employed.

FIG. 29C will be described. The processing shown in FIG. 29C is substantially the same as the processing shown in FIG. 29B. In step S51, the detection result of each liquid temperature sensor 54 of the storage portion 23B is acquired as liquid temperature information. In step S52, it is determined whether one of liquid temperatures indicated by the liquid temperature information acquired in step S51 is less than the threshold temperature T2. If one of the liquid temperatures is less than the threshold temperature T2, the process advances to step S53. If the liquid temperatures are equal to or more than the threshold temperature T2, the process advances to step S54.

In step S53, the stirring condition A is selected. In step S54, the stirring condition B is selected. As the stirring conditions A and B, those exemplified in FIG. 27C can be employed.

Note that in this embodiment, in step S42, the stirring condition A or the stirring condition B is selected based on whether one of liquid temperatures indicated by the liquid temperature information acquired in step S41 is less than the threshold temperature T2. However, the stirring condition A or the stirring condition B may be selected based on whether liquid temperatures indicated by the detection results of the liquid temperature sensors 54 of a plurality of storage portions 23A having the stirring function by the stirring unit 6 are less than the threshold temperature T2. For example, the stirring condition A or the stirring condition B may be selected based on whether liquid temperatures indicated by the detection results of half or more liquid temperature sensors 54 are less than the threshold temperature T2. Alternatively, the stirring condition A or the stirring condition B may be selected based on whether the temperatures of liquids in all containers 200 are less than the threshold temperature T2. This also applies to the processing of step S52.

In this embodiment, the liquid temperature sensor 54 is provided. However, a viscosity sensor that detects the viscosity of the liquid may be provided in place of the liquid temperature sensor 54. If the viscosity of the liquid is less than a threshold, the stirring condition A may be selected, and if the viscosity is equal to or more than the threshold, the stirring condition B may be selected.

### Fifth Embodiment

In a new container 200, sedimentation may progress, and the liquid amount is large. A stirring operation may be executed after changing the stirring condition depending on whether the container 200 stored in each of storage portions 23A and 23B is exchanged with a new container 200.

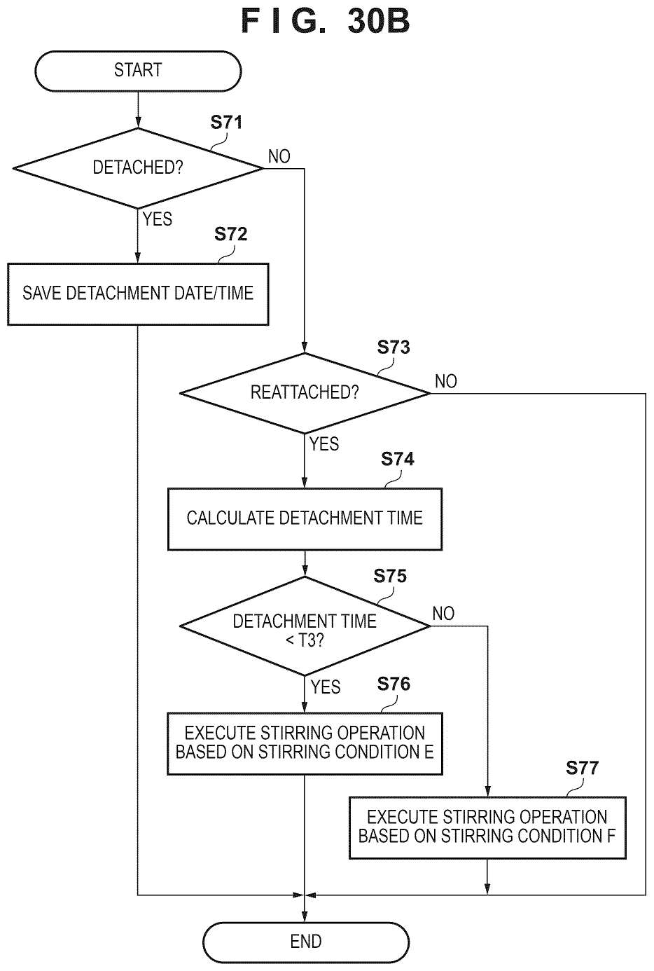

FIG. 30A is a flowchart showing an example of processing executed by a control unit 303 for the stirring operation of each of stirring units 6 and 100. The processing shown in FIG. 30A is executed periodically and repetitively.

In step S61, it is determined whether the container 200 is attached in one of storage portions 23A and 23B having a stirring function by the stirring unit 6. For example, if a reader/writer 53 cannot read the memory of the container 200 anymore, it can be determined that the container 200 is extracted. Also, if the read of the memory is not possible anymore, and the read is then possible, it can be determined that the container 200 is stored (attached). Upon determining that the container 200 is attached, the process advances to step S62.

In step S62, it is determined whether the container 200 determined to be attached in step S61 is a new container. Upon determining that the container 200 is a new container, the process advances to step S63. Otherwise (if the same container 200 is reattached), the process advances to step S64. Here, for example, the reader/writer 53 reads the memory of the container 200, and it is determined whether the container 200 is new. If the container 200 different from the original container 200 is stored, it may be considered that the container is exchanged with the new container 200. Alternatively, it may be determined, based on remaining amount information stored in the memory, whether the container is new.

In step S63, of the stirring units 6 and 100, the stirring condition of the stirring unit corresponding to the storage portion with the container 200 exchanged is set to a stirring condition C, and the stirring operation is executed. For example, if the container 200 of the storage portion 23A having the stirring function by the stirring unit 6 is exchanged with a new one, the stirring condition of the stirring unit 6 is set to the stirring condition C, and the stirring operation by the stirring unit 6 is immediately executed. If the container 200 of the storage portion 23B is exchanged with a new one, the stirring condition of the stirring unit 100 is set to the stirring condition C, and the stirring operation by the stirring unit 100 is executed. In step S64, the stirring condition of the stirring unit corresponding to the storage portion with the container 200 exchanged is set to a stirring condition D, and the stirring operation is immediately executed. The stirring condition C is a condition of higher stirring performance than the stirring condition D.

With the above-described processing, since the stirring operation of higher stirring performance is performed for the new container 200, the liquid in the container 200 can be homogenized in an early stage.

### Sixth Embodiment

If a container 200 is detached from a storage portion 23A or 23B and then attached again, sedimentation of the color material of the liquid may progress in accordance with the time of detachment. The stirring condition may be selected in accordance with the detachment time. FIG. 30B is a flowchart showing an example of processing executed by a control unit 303 for the stirring operation of each of stirring units 6 and 100. The processing shown in FIG. 30B is executed periodically and repetitively.

In step S71, it is determined whether the container 200 is detached in one of the storage portions 23A and 23B having a stirring function by the stirring unit 6. If at least one container is detached, the process advances to step S72. Upon determining that no container is detached, the process advances to step S73. As for whether the container 200 is detached, for example, if a reader/writer 53 cannot read the memory of the container 200 anymore, it can be determined that the container 200 is extracted.

In step S72, the date/time of detachment is stored in the memory device of the control unit 303 in correspondence with the storage portion 23A or 23B for which it is determined in step S71 that the container 200 is detached.

In step S73, it is determined whether the container 200 determined to be detached in step S71 is attached again. Upon determining that the container 200 is attached again, the process advances to step S74. Upon determining that the container 200 is not attached again, the processing is ended. As for whether the container 200 is attached, for example, if the reader/writer 53 can read the memory of the container 200, it can be determined that the container 200 is attached.

In step S74, the time of detachment (detachment time) is calculated from the detachment date/time stored in step S72 and the current date/time. In step S75, it is determined whether the detachment time calculated in step S74 is less than a threshold time T3. The threshold time T3 is, for example, 168 hrs (one week). Upon determining that the detachment time is less than the threshold time T3, the process advances to step S76. Upon determining that the detachment time is equal to or more than the threshold time T3, the process advances to step S77.

In step S76, of the stirring units 6 and 100, the stirring condition of the stirring unit corresponding to the storage portion with the container 200 reattached is set to a stirring condition E, and the stirring operation is executed. For example, if the container 200 of the storage portion 23A having the stirring function by the stirring unit 6 is reattached, the stirring condition of the stirring unit 6 is set to the stirring condition E. If the container 200 of the storage portion 23B is reattached, the stirring condition of the stirring unit 100 is set to the stirring condition E. In step S77, of the stirring units 6 and 100, the stirring condition of the stirring unit corresponding to the storage portion with the container 200 reattached is set to a stirring condition F, and the stirring operation is executed. The stirring condition F is a condition of higher stirring performance than the stirring condition E.

With the above-described processing, since the stirring operation of higher stirring performance is performed for the container 200 that is detached from a liquid supply apparatus 20 for a long elapsed time, the liquid in the container 200 can be homogenized.

### Seventh Embodiment

The effect of a stirring operation for a container 200 may be affected by the remaining amount. For example, if the remaining amount is large, the flow of the liquid in the container 200 during the stirring operation may be little. Along with consumption of the liquid, the flow of the liquid during the stirring operation becomes large. On the other hand, if there is a little remaining amount, the liquid amount is too small, and the flow decreases. Hence, the stirring condition may be selected in accordance with the remaining amount in the container 200. As an example, the stirring performance is set high at the initial stage with a large remaining amount, the stirring performance is set low at the middle stage with existence of an appropriate remaining amount, and the stirring performance is set high at the final stage with a little remaining amount.

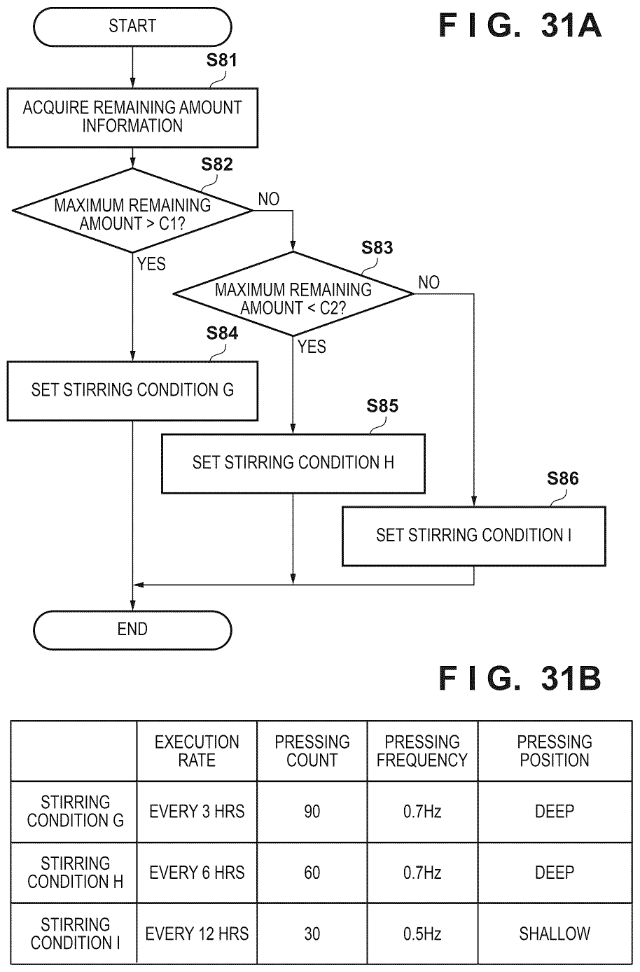

FIG. 31A is a flowchart showing an example of stirring condition selection processing according to this embodiment. Selection of the stirring condition of a stirring unit 6 will be described here, and this also applies to a stirring unit 100. The processing according to this embodiment can be used in combination with the selection processing according to the first to fourth embodiments.

In step S81, remaining amount information indicating the remaining amount of the liquid in the container 200 stored in each storage portion 23A having a stirring function by the stirring unit 6 is acquired. The remaining amount information is acquired from the memory of the container 200 via a reader/writer 53. The remaining amount of the liquid can be estimated from the detection result of a remaining amount detection sensor 31 or a consumed amount (the dot count value of the liquid discharged from a discharge head 1008 in a printing operation or recovery operation). The remaining amount information is appropriately updated by the reader/writer 53.

In step S82, it is determined whether the maximum remaining amount in the remaining amounts indicated by the acquired remaining amount information exceeds a threshold C1. The threshold C1 is, for example, a half value of the initial liquid amount in the container 200. Upon determining that the maximum remaining amount exceeds the threshold C1, the process advances to step S84. Upon determining that the maximum remaining amount is equal to or less than the threshold C1, the process advances to step S83. In step S83, it is determined whether the maximum remaining amount is less than a threshold C2 (<C1). The threshold C2 is, for example, a 1/30 value of the initial liquid amount in the container 200. Upon determining that the maximum remaining amount is less than the threshold C2, the process advances to step S85. Upon determining that the maximum remaining amount is equal to or more than the threshold C2, the process advances to step S86.

In step S85, a stirring condition G is selected and set. In step S86, a stirring condition H is selected and set. In step S87, a stirring condition I is selected and set. FIG. 31B shows an example of the stirring conditions G to I. The stirring condition G has the highest stirring performance, and the stirring condition I has the lowest stirring performance. According to the processing example shown in FIG. 31A, if the remaining amount is large, the stirring condition G of highest stirring performance is selected, and if the remaining amount is little, the stirring condition H of intermediate stirring performance is selected. If there exists an appropriate remaining amount, the stirring condition I of lowest stirring performance is selected.

Note that in this embodiment, the thresholds C1 and C2 are compared with the maximum remaining amount but may be compared with the minimum remaining amount or average remaining amount. Alternatively, after a stirring condition is selected for each container 200, the most selected stirring condition in the stirring conditions G to I may be selected finally. Selectable stirring conditions may be not the three types of stirring conditions G to I but two types or four or more types.

### Eighth Embodiment

A plurality of liquid supply apparatuses 20A may be provided, and a liquid with a high viscosity may be stored in one liquid supply apparatus 20A. FIG. 32 shows an example in which two liquid supply apparatuses 20A are juxtaposed. A liquid supply apparatus 20B may further be provided.

Each liquid supply apparatus 20A includes a stirring unit 6. A stirring condition may be set for each liquid supply apparatus 20A.

As another embodiment, one liquid supply apparatus 20A may include a plurality of stirring units 6 corresponding to different storage portions 23A. A liquid with a different viscosity may be assigned to each stirring unit 6, and the stirring conditions of the stirring units 6 may be different.

### Ninth Embodiment

An example of the stirring operation of a stirring unit 6, which is started in step S2 of FIG. 26 and improves a liquid stirring efficiency, will be described. In this embodiment, the moving stroke of a pressing portion 61 is not changed between a pressing operation and a pressing relaxing operation, but the operation time is changed. The time of the pressing operation is shorter than that of the pressing relaxing operation. More specifically, the time required for the pressing portion 61 to move from the pressing relaxing position to the pressing position is shorter than the time required for the pressing portion 61 to move from the pressing position to the pressing relaxing position in the reverse operation. When the time of the pressing operation is relatively short, a container portion 202 is pushed in at a high speed, and the fluidity of the liquid inside, particularly, the color material can be increased. When the time of the pressing relaxing operation is relatively long, the color material that has started flowing by the pressing operation can be diffused to a more distant point and the moving time by the weight of the color material can be ensured. It is possible to perform the next pressing operation in a state in which the color material is diffused to the more distant point. Hence, the stirring efficiency of the liquid in the container portion 202 can be improved.

Note that this embodiment can be combined with the stirring condition setting based on air temperature information described in the first embodiment.

An operation time T1 of the pressing operation is, for example, 0.5 sec or more and 1.0 sec or less. The ratio of the operation time T1 of the pressing operation to an operation time T2 of the pressing relaxing operation is a ratio in the range of, for example, 1.0:1.5 to 1.0:3.0. In this embodiment, since a container 200 is attached to a storage portion 23A in such a posture that a connecting portion 201 is tilted downward in the Z direction, the stirring efficiency can be improved by making the operation time T2 of the pressing relaxing operation longer.

As an example, the operation times T1 and T2 are adjusted by changing the driving condition of a motor 635 between the pressing operation and the pressing relaxing operation. In this embodiment, the operation times are adjusted by the rotation speed of the motor 635. In the pressing operation, the rotation speed of the motor 635 is made higher than in the pressing relaxing operation. When the rotation speed of the motor 635 is made low in the pressing relaxing operation, the load of the motor 635 decreases, and power consumption can be reduced.

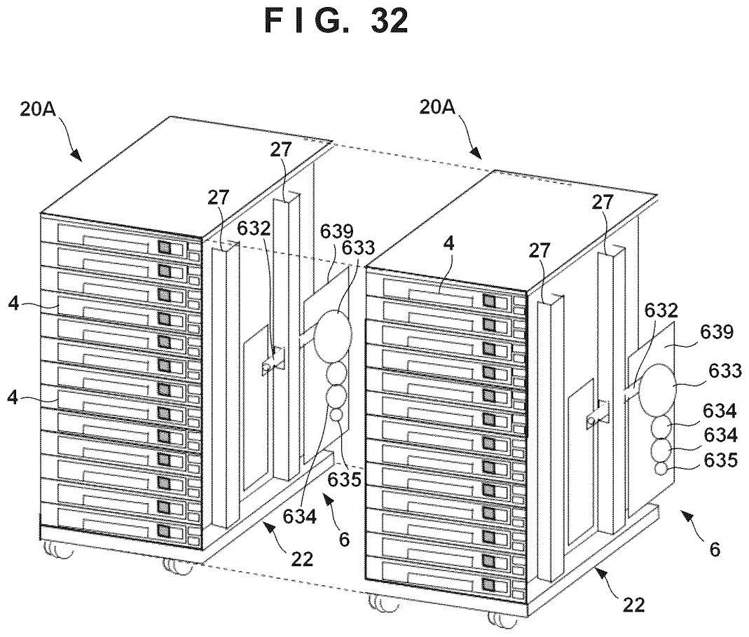

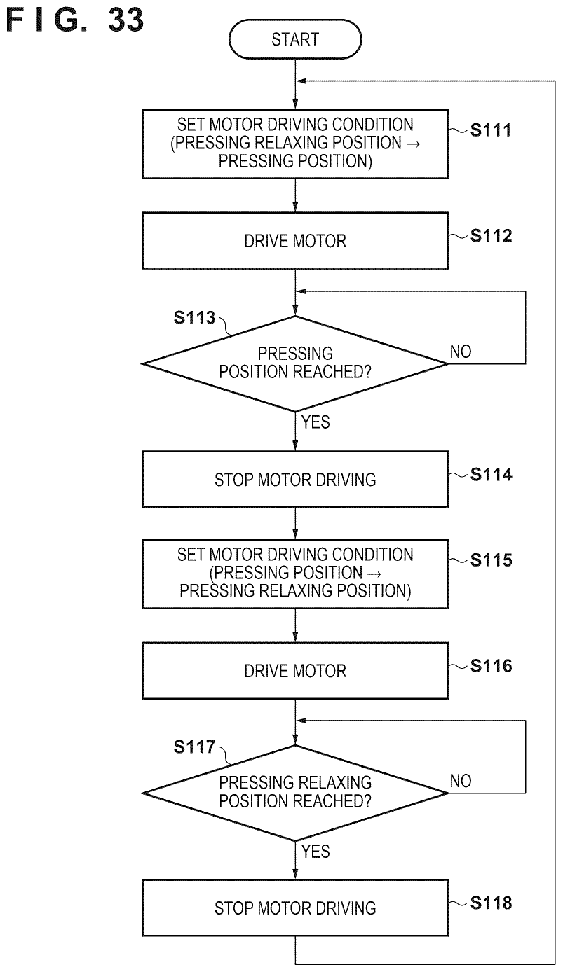

FIG. 33 is a flowchart showing an example of processing of a control unit 303 associated with the stirring operation of the stirring unit 6 started in step S2. In the example of the processing shown in FIG. 33, the processing is assumed to be started when the pressing portion 61 is located at the pressing relaxing position, and the processing is repetitively executed until it is determined in step S3 that an end condition is satisfied.

In step S111, the driving condition of the motor 635 is set. Here, a rotation speed V1 of the motor 635 in the pressing operation is set. In step S112, the motor 635 is driven based on the driving condition set in step S111. The pressing portion 61 moves as indicated by a state ST132 in FIG. 14, and the liquid in the container portion 202 flows.

In step S113, it is determined whether the pressing portion 61 reaches the pressing position. This determination can be done based on the detection result of a remaining amount detection sensor 31. As another example, the determination may be done based on the rotation amount of the motor 635 or the driving time of the motor 635. Upon determining that the pressing portion 61 reaches the pressing position, the process advances to step S114.

In step S114, driving of the motor 635 is stopped. In step S115, the driving condition of the motor 635 is set. Here, a rotation speed V2 (<V1) of the motor 635 in the pressing relaxing operation is set. In step S116, the motor 635 is driven based on the driving condition set in step S115. The pressing portion 61 moves as indicated by a state ST133 in FIG. 14, and the liquid in the container portion 202 flows.

In step S117, it is determined whether the pressing portion 61 reaches the pressing relaxing position. This determination can be done based on the rotation amount of the motor 635 or the driving time of the motor 635. Upon determining that the pressing portion 61 reaches the pressing relaxing position, the process advances to step S118. In step S118, driving of the motor 635 is stopped.

The above-described processing is repetitively executed until it is determined in step S3 that the end condition is satisfied. Upon determining that the end condition is satisfied, the processing shown in FIG. 33 may be ended after the pressing portion 61 moves to the pressing relaxing position.

### <Modification of Ninth Embodiment>

In the processing shown in FIG. 33, driving of the motor 635 is stopped in steps S114 and S118. However, the rotation speed may be switched without stopping driving.

In this embodiment, as described above, since the container 200 is attached to the storage portion 23A in such a posture that the connecting portion 201 is tilted downward in the Z direction, the stirring efficiency can be improved by making the operation time T2 of the pressing relaxing operation longer. In this viewpoint, the stirring efficiency can be improved if the rotation speed V2 is lower.

In the processing shown in FIG. 33, the rotation speeds V1 and V2 have been exemplified as the driving condition of the motor 635. However, the difference of the driving condition between the pressing operation and the pressing relaxing operation may be the difference of the average rotation speed.

In the processing shown in FIG. 33, the operation times T1 and T2 are adjusted by changing the driving condition of the motor 635 but may be structurally changed by, for example, the mechanism of the stirring unit 6.

### 10th Embodiment

In the first embodiment, the moving mechanism 63 is shared by all pressing members 60. However, while sharing a moving mechanism 63, a mechanism for switching transmission/blocking of the driving force to each pressing member 60 may be provided for each pressing member 60, and the pressing members 60 may individually be rotated. Alternatively, an independent moving mechanism may be provided for each pressing member 60, and the pressing members 60 may independently be rotated. Also, the motion of the pressing member 60 in a stirring operation may be not a rotary motion but a translation motion.

### 11th Embodiment

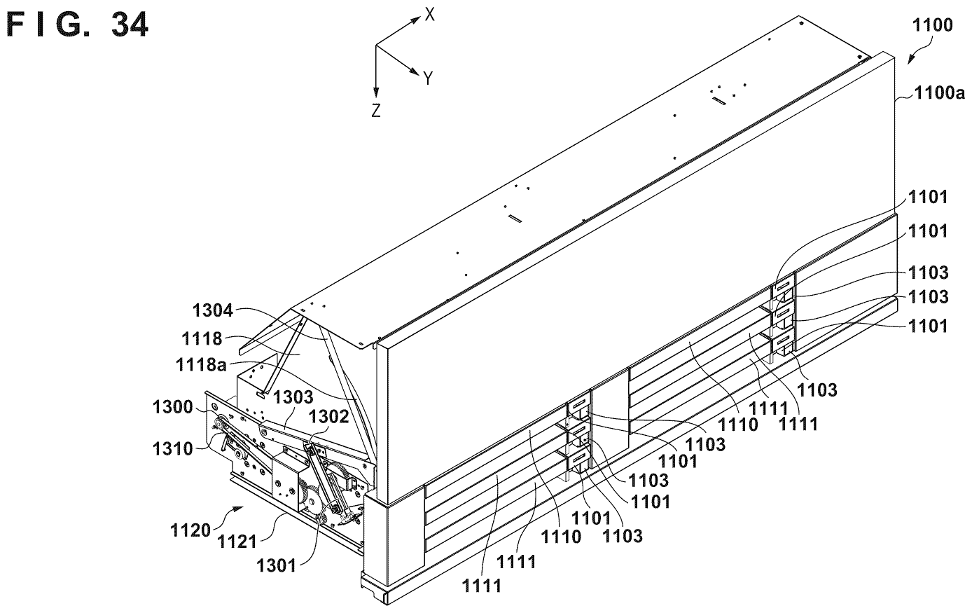

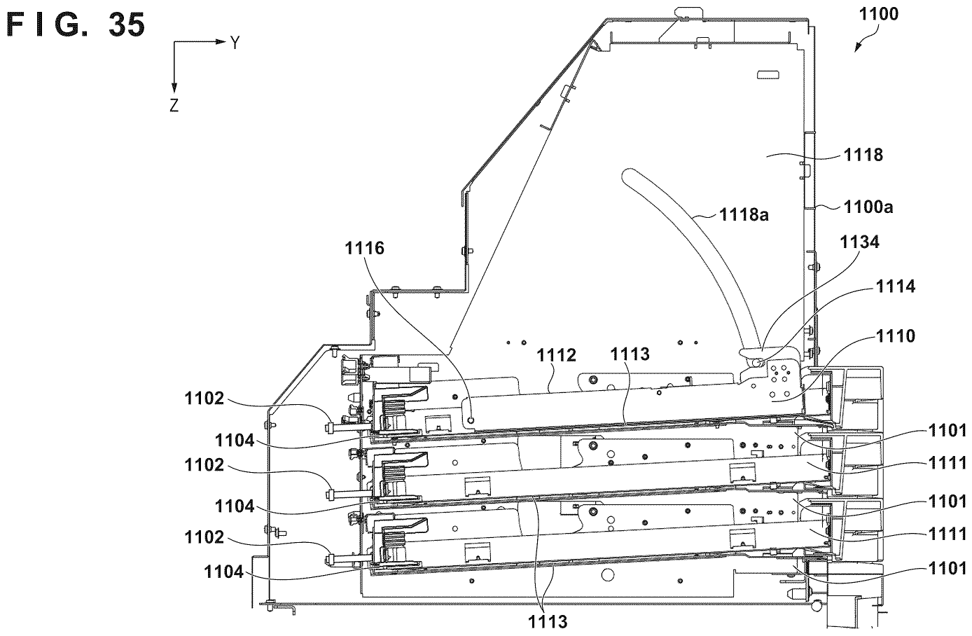

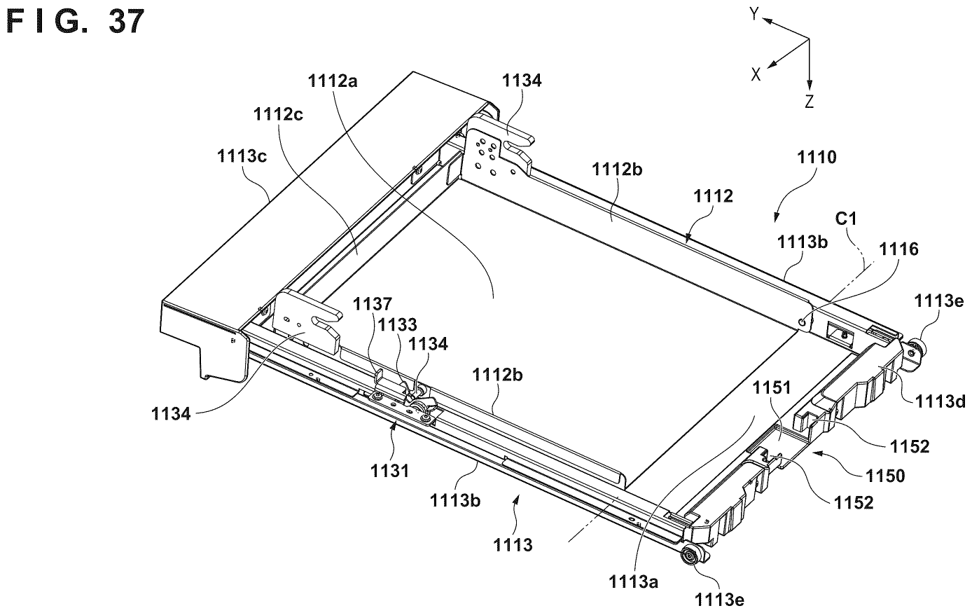

A liquid supply apparatus with a different stirring mechanism will be described. FIG. 34 is a perspective view of a liquid supply apparatus 1100, and FIG. 35 is an explanatory view showing the internal structure of the liquid supply apparatus 1100. A main body 1100a of the liquid supply apparatus 1100 includes a plurality of storage portions 1101 each capable of storing a liquid container 1200 (FIG. 37) that contains ink. In this embodiment, six storage portions 1101 are provided. The six storage portions 1101 are arranged in three stages in the Z direction and two columns in the X direction. Each storage portion 1101 is a space having a flat rectangular parallelepiped shape in which the lengths in the X and Y directions are longer than the length in the Z direction. Note that in this embodiment, the length of the storage portion 1101 in the Y direction is longer than the length in the X direction. A connecting unit 1104 connected to the liquid container 1200 is provided at an end portion on the far side of each storage portion 1101 (an end portion in the Y direction).

A tray 1110 or a tray 1111 is detachably attached to each storage portion 1101. In this embodiment, the liquid container 1200 is placed on the tray 1110 or the tray 1111 and detachably stored in the storage portion 1101. In the storage portions 1101 of three stages, the tray 1110 is attached to the storage portion 1101 of the uppermost stage, and the trays 1111 are attached to the storage portions 1101 of the middle and lower stages. Hence, two trays 1110 and four trays 1111 are used. The trays 1110 and 1111 basically have the same structure. The tray 1110 has a structure for stirring ink in the liquid container 1200, as will be described later.

Each storage portion 1101 is also provided with an operation member 1103 that regulates detachment of the tray 1110 or the tray 1111 and locks the tray to a corresponding storage portion 1101. The operation member 1103 is provided to be slidable in the X direction, and the user can operate this.

### (Liquid Container)

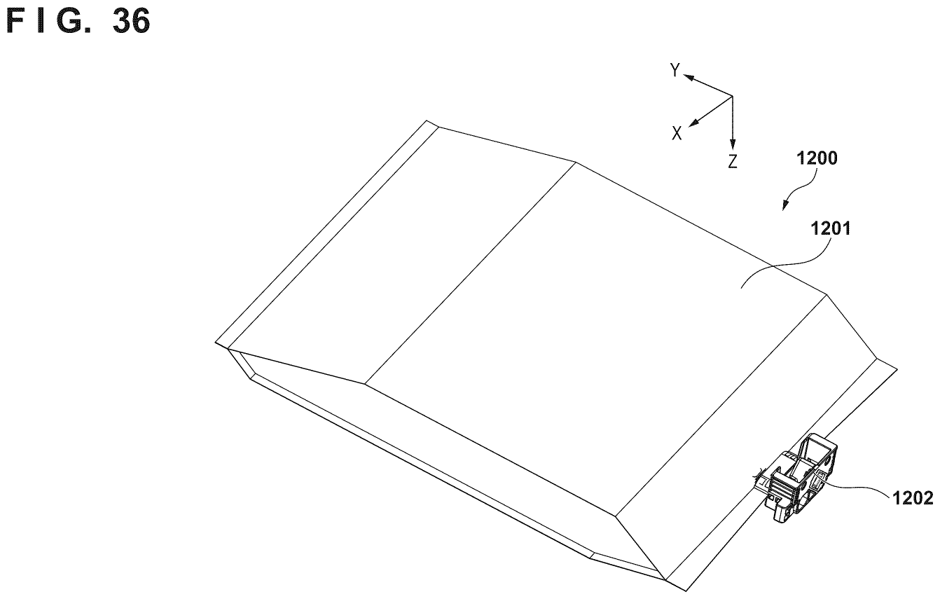

The liquid container 1200 (to be also simply referred to as a container 1200) will be described. FIG. 36 is a perspective view of the container 1200. The container 1200 includes a container portion 1201 that contains ink, and a connecting portion 1202 connected to the connecting unit 1104 of the storage portion 1101. The container portion 1201 is a bag-type ink pack made of a material having flexibility. As for the flexibility of the container portion 1201, it may only be deflected by the weight of its own, or may hold the shape against the weight of its own and only be deflected when a load larger than the weight of its own is applied.

The container portion 1201 is formed into a bag shape by welding sheets forming the upper and lower surfaces and sheets forming gusset portions on the left and right sides (the side portions in the X direction) to each other, thereby forming a flexible tank that has a rectangular shape in a planar view and contains a liquid. The material of the container portion 1201 is, for example, a material having a multiple layer structure such as PET, and the multiple layer structure may include an aluminum layer.

The connecting portion 1202 is provided at an end portion of the container portion 1201 in the Y direction and at the central portion in the X direction. The connecting portion 1202 is detachably connected to the connecting unit 1104 and forms an ink path between the container portion 1201 and the connecting unit 1104.

### (Trays)

The trays 1110 and 1111 will be described. FIG. 37 is a perspective view of the tray 1110. The tray 1110 includes a tray main body 1113. The tray main body 1113 is a member that includes a bottom wall portion 1113a, left and right side wall portions 1113b, a front wall portion 1113c, and a rear wall portion 1113d and has a shallow rectangular box shape with its top portion open. A roller 1113e is rotatably supported on each side wall portion 1113b. Insertion/removal of the tray 1110 into/from the storage portion 1101 can smoothly be performed by rolling of the rollers 1113e.

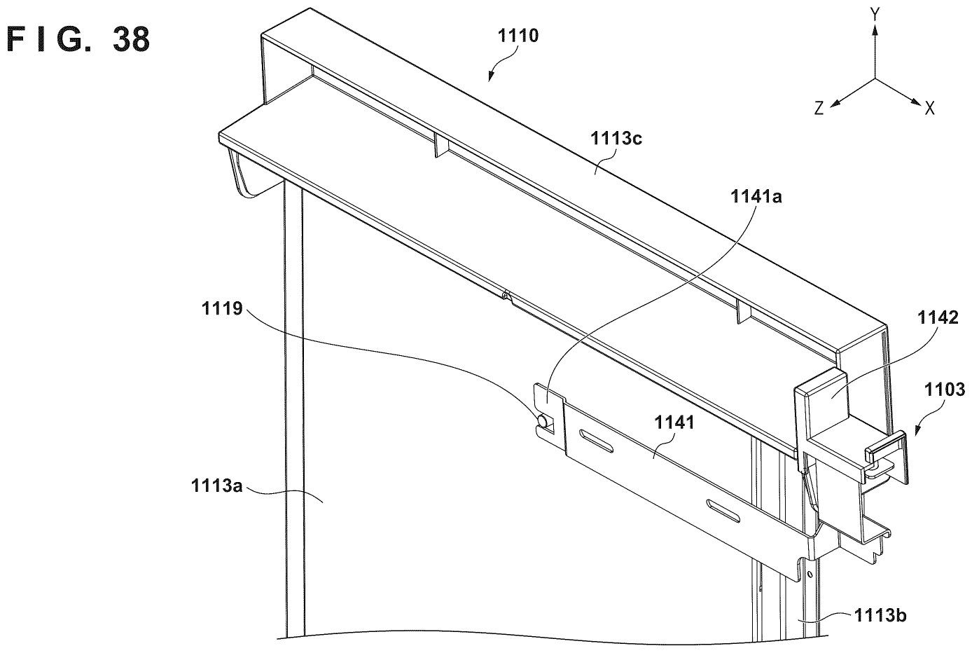

FIGS. 34 and 38 will be referred to. FIG. 38 is a perspective view of the tray 1110, and shows a part of the bottom surface of the bottom wall portion 1113a. An engaging portion 1119 that engages with the operation member 1103 is provided on the bottom surface of the bottom wall portion 1113a of the tray main body 1113. The engaging portion 1119 according to this embodiment is a projection having a columnar shape. The operation member 1103 includes an arm member 1141 with a C-shaped engaging portion 1141a that engages with the engaging portion 1119, and a knob portion 1142 that the user can grip.

The arm member 1141 is a plate-shaped member extended in the X direction along the bottom surface of the bottom wall portion 1113a, and is connected to the knob portion 1142. FIG. 38 shows a state in which the engaging portions 1119 and 1141a engage with each other, and movement of the tray 1110 in the Y direction (that is, detachment from the storage portion 1101) is regulated. When the knob portion 1142 is moved in the X direction from the state shown in FIG. 38, the arm member 1141 is displaced in the X direction, and the engagement between the engaging portion 1119 and the engaging portion 1141a can be canceled. The tray 1110 can thus be extracted from the storage portion 1101. This engagement mechanism can prevent the tray 1110 from being unintentionally removed from the storage portion 1101.

Referring back to FIG. 37, a placement member 1112 is mounted on the tray main body 1113. The placement member 1112 is a member that includes a bottom wall portion 1112a overlaid on the bottom wall portion 1113a, left and right side wall portions 1112b located inside the left and right side wall portions 1113b, and a front wall portion 1112c located inside the front wall portion 1113c and has a shallow rectangular box shape with its top portion and rear end portion open. The tray 1110 according to this embodiment has a double tray structure in which the tray main body 1113 is the outer tray, and the placement member 1112 is the inner tray.

The bottom wall portion 1112a of the placement member 1112 is shorter than the bottom wall portion 1113a of the tray main body 1113 in the Y direction, and the edge (rear edge) of the bottom wall portion 1112a in the Y direction is apart from the rear wall portion 1113d of the tray main body 1113. The placement member 1112 is rotatably supported by the tray main body 1113 via a shaft 1116. The left and right side wall portions 1112b are supported by the left and right side wall portions 1113b of the tray main body 1113 via the shafts 1116 (FIG. 37 shows only one shaft 1116). The placement member 1112 can rotate, with respect to the tray main body 1113, about a rotation centerline C1passing through the shafts 1116 as the rotation center. In this viewpoint, the placement member 1112 can also be called a movable member or a rotation member. FIG. 37 shows a state in which the placement member 1112 is located at an initial position with respect to the tray main body 1113. At the initial position, the bottom surface of the bottom wall portion 1112a of the placement member 1112 abuts against the upper surface of the bottom wall portion 1113a of the tray main body 1113 and these are overlaid in the Z direction.

An engaging member 1134 is fixed to each side wall portion 1112b of the placement member 1112. A driving unit 1120 to be described later inputs a rotation biasing force to the engaging member 1134, and the placement member 1112 thus rotates. The engaging member 1134 has a C shape open to one side (rear side) in the Y direction.

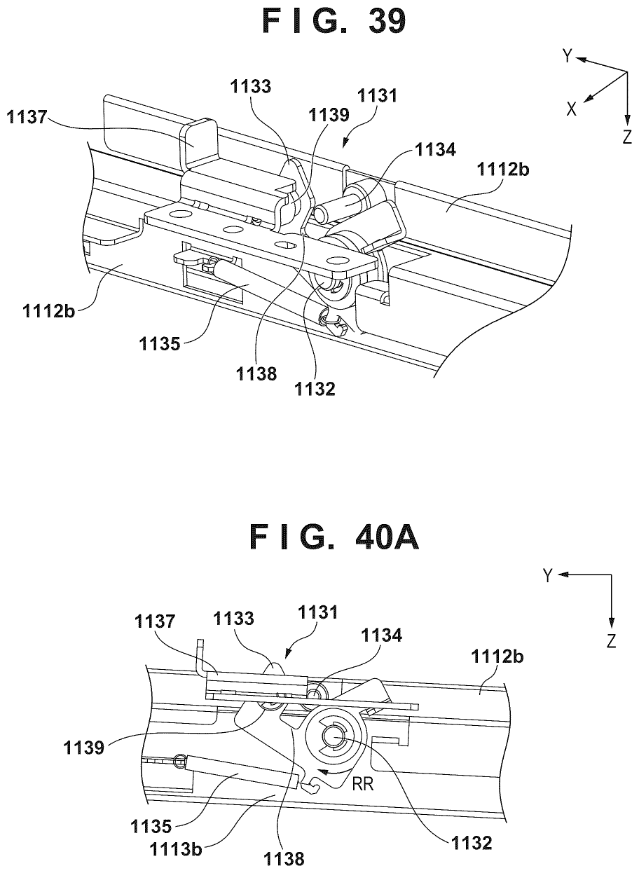

The tray main body 1113 is also provided with a lock mechanism 1131 that locks the placement member 1112 to the tray main body 1113 and regulates its rotation from the initial position. The lock mechanism 1131 operates in synchronism with attachment/detachment of the tray 1110 to/from the storage portion 1101. When attaching the tray 1110 to the storage portion 1101, the lock mechanism 1131 allows the placement member 1112 to rotate. When the tray 1110 is detached from the storage portion 1101, the lock mechanism 1131 regulates rotation of the placement member 1112. FIG. 39 is a perspective view of the lock mechanism 1131.

The lock mechanism 1131 includes a rotation shaft 1132 provided on one side wall portion 1113b of the tray main body 1113, and a lock member 1133 rotatably supported by the tray main body 1113 via the rotation shaft 1132. The lock mechanism 1131 further includes a biasing member 1135 that biases the lock member 1133 in a rotation direction RR. The biasing member 1135 is an elastic member such as a coil spring connected between the side wall portion 1113b and the lock member 1133. An unlock member 1137 is fixed to the storage portion 1101, and the engaging member 1134 is provided on the placement member 1112. The engaging member 1134 is a shaft member projecting from the side wall portion 1112b in the X direction. The lock member 1133 includes a lock portion 1138 having a roller shape engaging with the engaging member 1134, and an abutment portion 1139 having a shape of a concave portion abutting against the unlock member 1137.

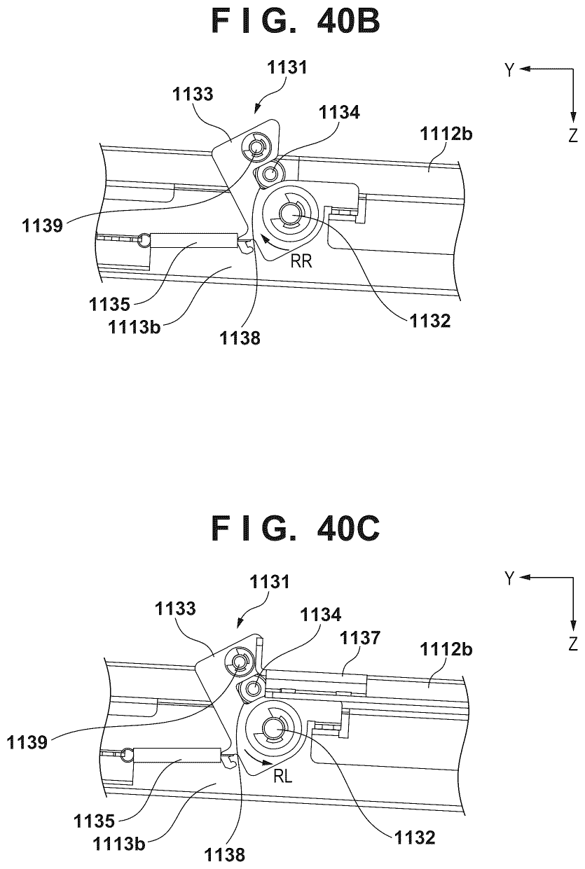

FIGS. 40A to 40C are operation explanatory views of the lock mechanism 1131. FIG. 40A shows the state of the lock mechanism 1131 in a state in which the tray 1110 is stored in the storage portion 1101. The lock member 1133 receives a biasing force to rotate in the rotation direction RR from the biasing member 1135, and the abutment portion 1139 contacts the unlock member 1137. The abutment portion 1139 contacts the unlock member 1137 to impede engagement between the lock portion 1138 and the engaging member 1134. The placement member 1112 is in an unlocked state, that is, in a state in which the placement member 1112 can rotate from the initial position with respect to the tray main body 1113.

FIG. 40B shows the state of the lock mechanism 1131 in a state in which the tray 1110 is extracted from the storage portion 1101. The lock member 1133 receives the biasing force to rotate in the rotation direction RR from the biasing member 1135, and the lock portion 1138 engages with the engaging member 1134. When the lock portion 1138 engages with the engaging member 1134, the placement member 1112 is in a locked state, that is, in a state in which rotation with respect to the tray main body 1113 is regulated and the placement member 1112 is locked to the initial position.

FIG. 40C shows the state of the lock mechanism 1131 in a halfway state in which the tray 1110 is being inserted into the storage portion 1101. The lock member 1133 receives the biasing force to rotate in the rotation direction RR from the biasing member 1135, and the lock portion 1138 engages with the engaging member 1134. Along with the insertion operation of the tray 1110 into the storage portion 1101, the abutment portion 1139 contacts the unlock member 1137, and the lock member 1133 rotates in a rotation direction RL. When the tray 1110 is stored in the storage portion 1101, the lock mechanism 1131 is set in the state shown in FIG. 40A, and the engagement between the lock portion 1138 and the engaging member 1134 is canceled.

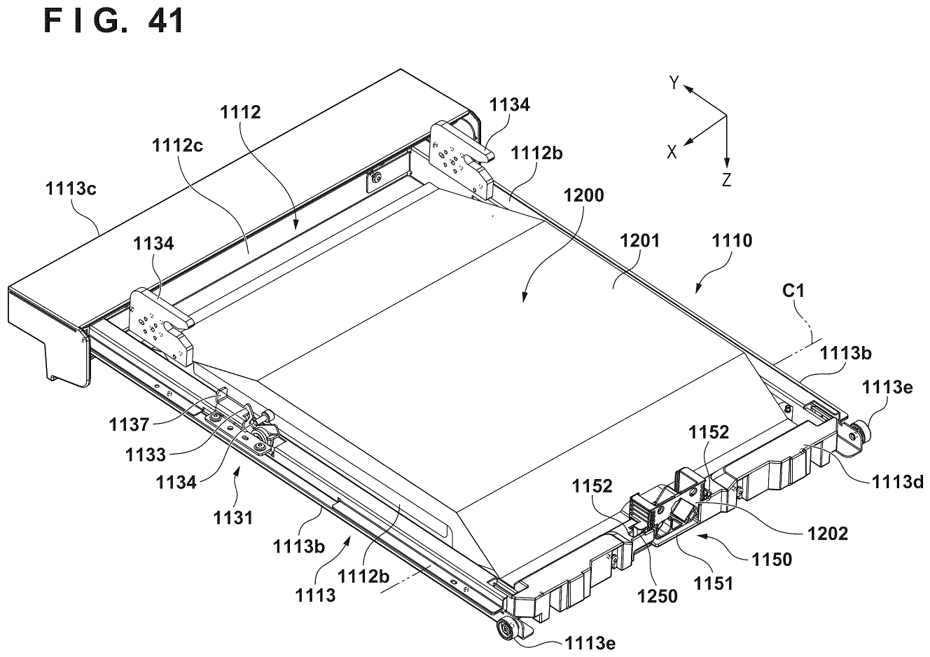

FIGS. 37 and 41 will be referred to. FIG. 41 is a perspective view of the tray 1110 on which the container 1200 is placed. The container portion 1201 of the container 1200 is placed on the placement member 1112. A part of the container portion 1201 on the side of the connecting portion 1202 is placed on the tray main body 1113, and the rotation centerline C1is apart from the connecting portion 1202 in the Y direction and passes through the container portion 1201.

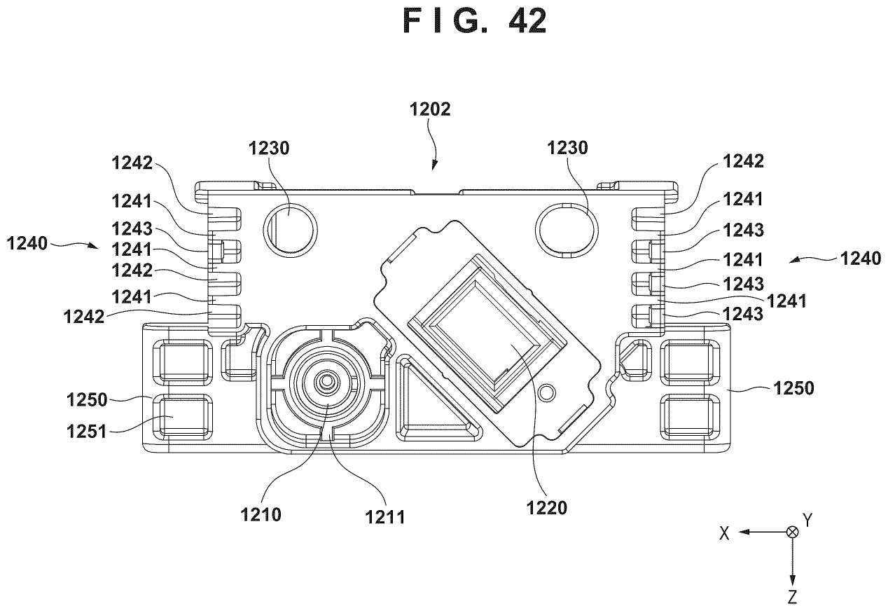

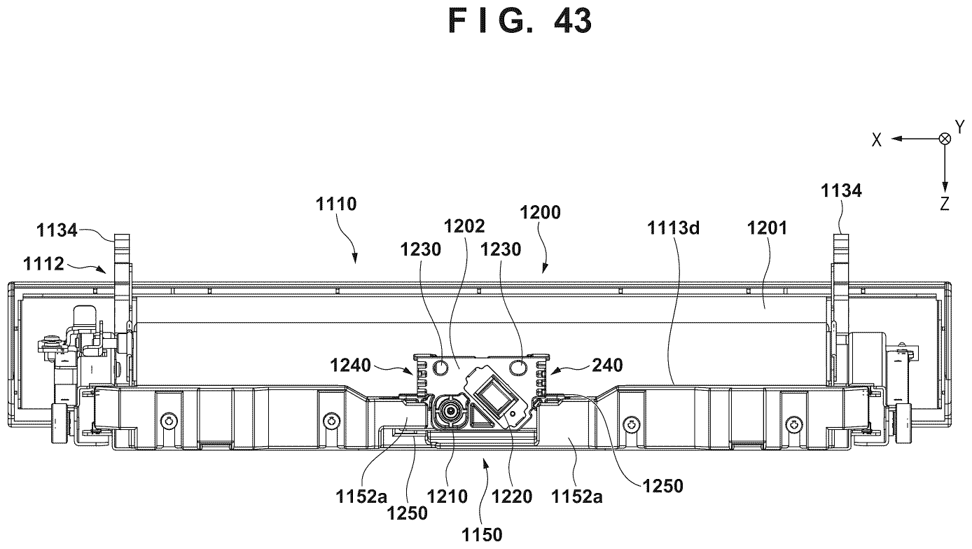

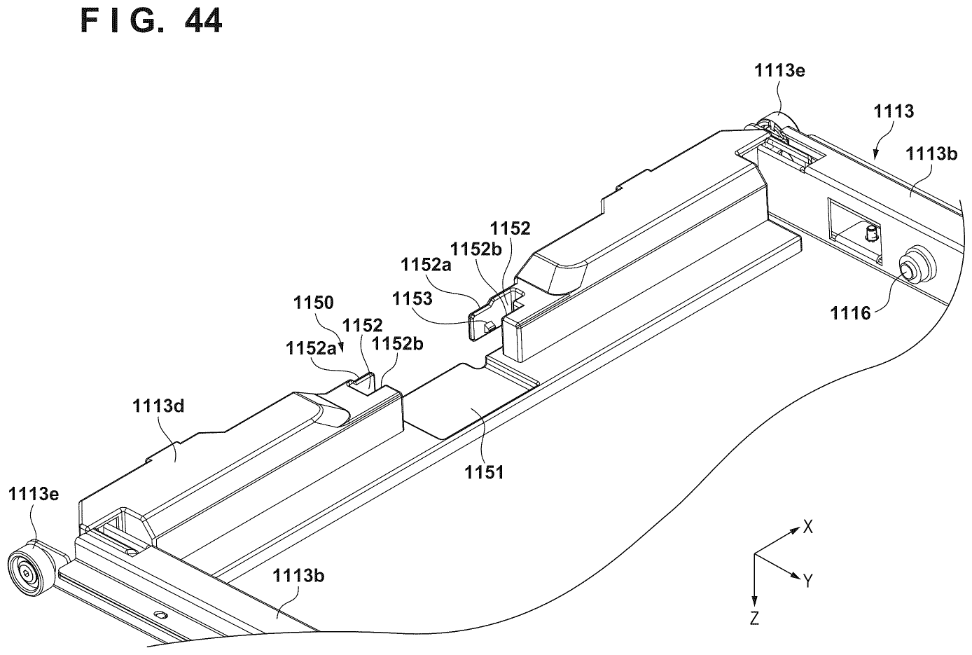

A holding portion 1150 that holds the connecting portion 1202 of the container 1200 is formed at the central portion of the rear wall portion 1113d in the X direction. The structure of the connecting portion 1202 and the holding portion 1150 will be described with reference to FIGS. 42 to 44 in addition to FIGS. 37 and 41. FIG. 42 is a front view of the connecting portion 1202 viewed in the Y direction. FIG. 43 is a view of the tray 1110 with the container 1200 placed thereon viewed from the side of the rear wall portion 1113d in the Y direction. FIG. 44 is a perspective view of the periphery of the holding portion 1150.

The holding portion 1150 includes a concave portion 1151 that is recessed downward from the upper surface of the rear wall portion 1113d in the Z direction, and engaging portions 1152 formed on both sides of the concave portion 1151 in the X direction. Each engaging portion 1152 is a groove extended in the Z direction and having a depth in the X direction, and is formed by vertical walls 1152a and 1152b apart in the Y direction. Left and right engaging portions 1250 of the connecting portion 1202 are inserted into the engaging portions 1152 in the Z direction, and the remaining part of the connecting portion 1202 is arranged on the concave portion 1151. The engaging portions 1250 are plate-shaped members projecting to both sides of the connecting portion 1202 in the X direction.

The holding portion 1150 positions the connecting portion 1202 with respect to the tray 1110 in the X, Y, and Z directions. Also, since each engaging portion 1152 includes the pair of vertical walls 1152a and 1152b apart in the Y direction, displacement of the engaging portions 1250 in the Y direction is regulated. As a result, displacement of the connecting portion 1202 in the Y direction is regulated by the engaging portions 1152 with respect to the tray 1110.

The engaging portions 1250 are the side portions of the connecting portion 1202 and are arranged on the lower side. The connecting portion 1202 substantially has a convex shape projecting upward on the XZ plane and has a convex shape projecting in the Y direction on the XY plane. The Z-direction width of the engaging portion 1152 equals that of the engaging portion 1250, and the connecting portion 1202 projects upward in the Z direction from the periphery of the holding portion 1150. The user can thus easily pinch the connecting portion 1202 and easily detach the connecting portion 1202 from the concave portion 1151. When exchanging the container 1200 in the tray 1110, the convenience of the exchange work can be improved.

Also, an engaging portion 1153 is formed on the vertical wall 1152a of each engaging portion 1152. The engaging portion 1153 is a projection projecting from the vertical wall 1152a in the Y direction. Each engaging portion 1250 includes an engaging portion 1251 that engages with the engaging portion 1153. The engaging portion 1251 is formed as a hole extending through the engaging portion 1250 in the Y direction or a concave portion recessed in the Y direction.

When attaching the container 1200 to the tray 1110, the lower surfaces of the engaging portions 1250 contact the surfaces (tilting surfaces) of the engaging portions 1153 during the process of insertion of the engaging portions 1250 into the engaging portions 1152. Thus, the vertical walls 1152a of the engaging portions 1152 are elastically displaced to the rear side in the Y direction. When insertion of the engaging portions 1250 into the engaging portions 1152 progresses, the engaging portions 1153 reach the engaging portions 1251. Thus, the vertical walls 1152a return to the original positions, and the engaging portions 1153 engage with the engaging portions 1251.

The engaging direction between the engaging portion 1153 and the engaging portion 1251 is the Z direction, and this is different from the attachment/detachment direction (Y direction) of the tray 1110 to/from the storage portion 1101. This can prevent the connecting portion 1202 from falling from the holding portion 1150 at the time of attachment/detachment of the tray 1110.

### (Path Connection Structure)

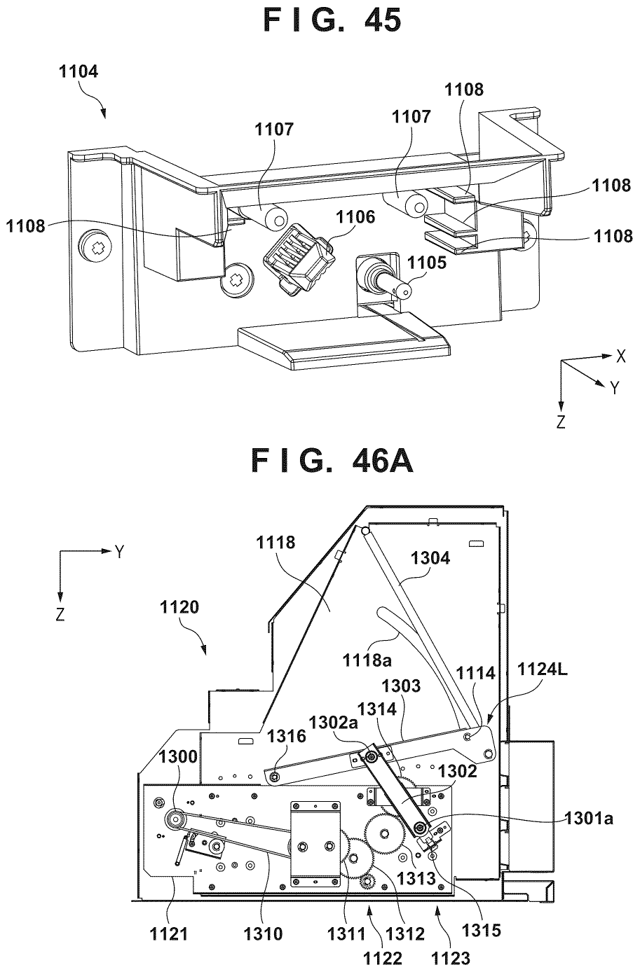

The connection structure between the connecting portion 1202 of the container 1200 and the connecting unit 1104 of the storage portion 1101 will be described with reference to FIGS. 35, 42, and 45. FIG. 45 is a perspective view of the connecting unit 1104. The connecting portion 1202 of the container 1200 is connected to the connecting unit 1104 by attaching the tray 1110 with the container 1200 mounted to the storage portion 1101 and pushing it to the far side. Conversely, when the tray 1110 with the container 1200 mounted is drawn from the storage portion 1101 to the near side, the connection between the connecting portion 1202 and the connecting unit 1104 is canceled.

The connecting portion 1202 is formed by, for example, molding a resin member such as polypropylene. The connecting portion 1202 is provided with a connecting hole 1210, an electrical connecting portion 1220, a plurality of positioning holes 1230, and fitting portions 1240.

The connecting unit 1104 includes a tube connecting pipe 1102 (FIG. 35) extended to the outside of the storage portion 1101, and a tube to be connected to a buffer tank is connected to the tube connecting pipe 1102. These form an ink path. The ink contained in the container 1200 is supplied to a printhead 108 via the buffer tank.

The connecting hole 1210 is an opening portion of the path that is open in the Y direction and communicates with the inside of the container portion 1201. The center axis of the connecting hole 1210 is parallel to the Y direction. An introduction pipe 1105 of the connecting unit 1104 is connected to the connecting hole 1210 in the Y direction. The introduction pipe 1105 communicates with the tube connecting pipe 1102, and the ink in the container 1200 is discharged via the connecting hole 1210 and the introduction pipe 1105.

Note that a structure configured to prevent ink leakage can be provided inside the connecting portion 1202. This structure may be a valve structure or seal structure that maintains a closed state before the introduction pipe 1105 is inserted into the connecting hole 1210 and opens when the introduction pipe 1105 is inserted.

In this embodiment, in the connecting portion 1202, a peripheral portion 1211 of the connecting hole 1210 is recessed in the Y direction as a whole, and the connecting hole 1210 opens at a position where it projects in the Y direction with respect to the peripheral portion 1211. Thus, the periphery of the connecting hole 1210 is surrounded by a wall portion formed by the peripheral portion 1211, and protectability of the connecting hole 1210 is improved. For example, user's touch on the connecting hole 1210 by mistake is suppressed. Also, when the container 1200 falls by mistake, degradation such as damage or deformation of the connecting hole 1210 caused by collision is suppressed. A peripheral rib that is provided to surround the connecting hole 1210 and project in the Y direction may be formed on the peripheral portion 1211.

An electrical connecting portion 1106 of the connecting unit 1104 is inserted into the electrical connecting portion 1220 in the Y direction and structurally connected and electrically connected to it. The electrical connecting portion 1220 includes a circuit board and an electrical connecting terminal. The circuit board includes a memory that stores information of the container 1200, and the like. By the electrical connection of the electrical connecting portion 1220 and the electrical connecting portion 1106, a control unit 961 can read out the information in the memory.

A shaft member 1107 of the connecting unit 1104 is inserted into each positioning hole 1230. The connecting portion 1202 and the connecting unit 1104 are positioned to each other. In this embodiment, two sets of positioning holes 1230 and shaft members 1107 are provided apart in the X direction, and the connecting hole 1210 and the introduction pipe 1105 are arranged between these in the X direction. This improves positioning accuracy of the connecting hole 1210 to the introduction pipe 1105 in the X direction.

In this embodiment, the type of container 1200 to be stored in each storage portion 1101 (or the type of ink to be contained) is predetermined. The fitting portions 1240 structurally prevent the container 1200 of a different type from being erroneously attached to the storage portion 1101.

The fitting portions 1240 are formed on the connecting portion 1202 divisionally in the X direction. The fitting portions 1240 project in the same length in the X direction and each have a concave-convex structure in which a plurality of projecting portions 1241 having a substantially rectangular shape and parallelly extending in the-Y direction are arrayed. Sealing portions 1243 are arranged in a predetermined pattern on valley portions 1242 that are concave portions between the projecting portions 1241 in the fitting portion 1240. The sealing portion 1243 is a portion that closes the valley portion 1242, and the arrangement pattern of the sealing portions 1243 changes depending on the type of container 1200.

Fitting portions 1108 to be fitted in the fitting portions 1240 are provided on the connecting unit 1104. The valley portions 1242 are sealed by arranging the sealing portions 1243, and the concave and convex portions in the arrangement pattern of the concave-convex structure of each fitting portion 1240 are reverse to those in the array pattern of the concave-convex structure of the corresponding fitting portion 1108 that is the connection target. When connecting the connecting portion 1202 to the connecting unit 1104, if the type of container 1200 matches, fitting between the concave-convex structures of the fitting portions 1108 and the concave-convex structures of the fitting portions 1240 is permitted. On the other hand, if the type of container 1200 does not match, the concave-convex structures of the fitting portions 1108 are not adapted to the concave-convex structures of the fitting portions 1240, and fitting is impossible. Hence, connection of a wrong container 1200 to the connecting unit 1104 is suppressed.

### (Other Trays)

The tray 1110 and the tray 1111 basically have the same structure. The tray 1110 has a structure for stirring ink in the container 1200, but not the tray 1111. For this reason, the tray 1111 does not include the placement member 1112 (and engaging portions) and the lock mechanism 1131.

### (Driving Unit and Stirring of Liquid)

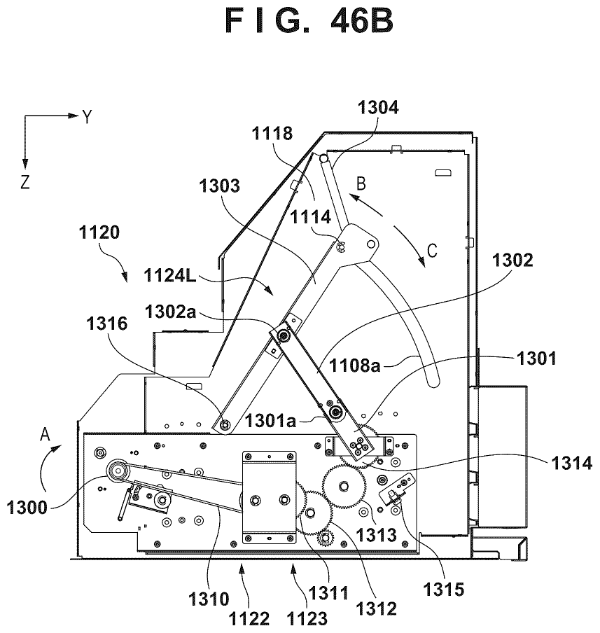

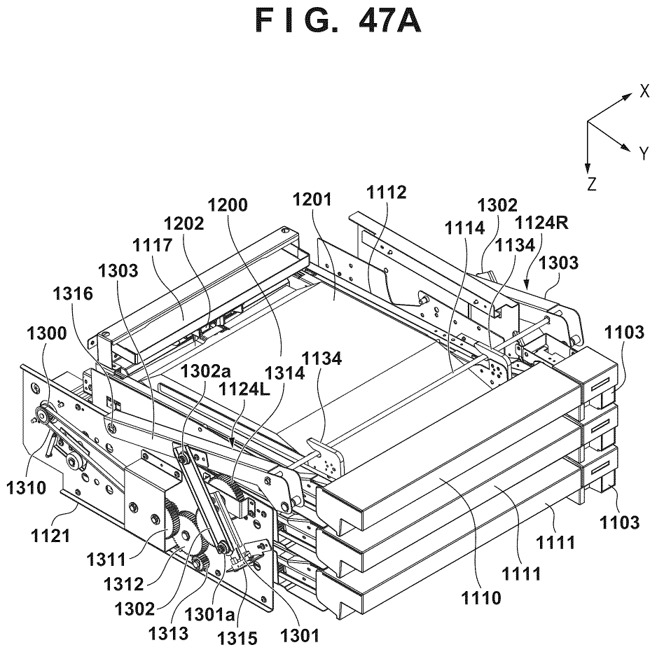

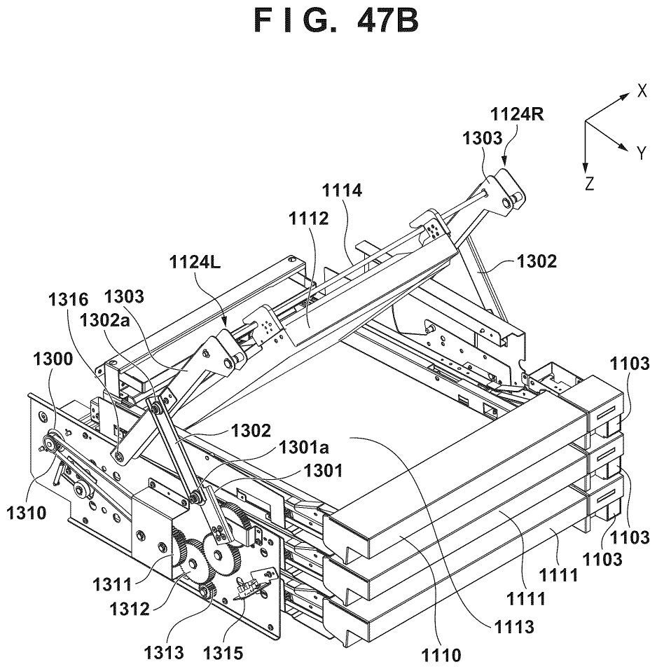

In this embodiment, the container 1200 placed on the tray 1110 is rotated, thereby stirring the ink contained in the container 1200. In this embodiment, the container 1200 is rotated by rotating the placement member 1112. The configuration of the driving unit 1120 that rotates the placement member 1112 will be described with reference to FIG. 34 and FIGS. 46A to 47B. FIGS. 46A and 46B and FIGS. 47A and 47B are operation explanatory views of the driving unit 1120.

FIGS. 46A and 47A show the state of the driving unit 1120 when the placement member 1112 is located at an initial position. FIGS. 46B and 47B show the state of the driving unit 1120 when the placement member 1112 is located at a maximum rotation position from the initial position. The rotation operation from the initial position to the maximum rotation position is called a tilting operation, and the rotation operation from the maximum rotation position to the initial position is called a recovery operation. In a tilting posture, the liquid in the container portion 1201 of the container 1200 readily flows to the lower side (an end portion on the side of the connecting portion 1202). The recovery operation is an operation of returning the posture of the container 1200 to the original posture (initial position).

The initial position is a position at which the tray 1110 can be inserted/removed into/from the storage portion 1101, and the entire tray 1110 and the container 1200 are in a substantially horizontal posture (the side of the connecting portion 1202 is lightly lower). The maximum rotation position is a position at which the rotation amount of the placement member 1112 is maximum and, in this embodiment, it is a position about 45° from the initial position, and the container portion 1201 of the container 1200 is in the tilting posture. At the maximum rotation position, the tray 1110 cannot be inserted/removed into/from the storage portion 1101. Concerning the posture of the container portion 1201 of the container 1200, the container portion 1201 is close to horizontal at the initial position as compared to the maximum rotation position.

The driving unit 1120 is provided for each of the two storage portions 1101 of the uppermost stage. The driving unit 1120 includes a driving source 1300, a driving mechanism 1122 that rotates the placement member 1112 by the driving force of the driving source 1300, and a biasing member 1304.

The driving source 1300 is, for example, a stepping motor. In the drawings, the main body of the driving source 1300 is hidden behind a base plate 1121, and only a part thereof is shown. The rotation amount of the placement member 1112 can be controlled by the rotation amount of the driving source 1300. The driving source 1300 may be a DC motor. In this case, to control the rotation amount, a rotation amount sensor such as a rotary encoder may be provided.

The driving mechanism 1122 is a driving force transmission mechanism that rotates the placement member 1112 by the driving force of the driving source 1300, and is a conversion mechanism that converts the driving force of the driving source 1300 into the rotary motion of the placement member 1112. In this embodiment, the driving mechanism 1122 includes a gear device 1123, and a pair of link mechanisms 1124R and 1124L. The configuration of the driving mechanism 1122 is merely an example, and it may be a mechanism of another method.

The driving source 1300 and the gear device 1123 are mounted on the base plate 1121 arranged on one side portion of the storage portion 1101 in the X direction. The rotation force of the driving source 1300 is transmitted to the gear device 1123 via a belt transmission mechanism 1310. The gear device 1123 includes a gear 1311 that is rotated by the belt transmission mechanism 1310, a gear 1312 that meshes with the gear 1311, a gear 1313 that meshes with the gear 1312, and a gear 1314 that meshes with the gear 1313.

The pair of link mechanisms 1124R and 1124L are divisionally arranged on the side portions of the storage portion 1101 in the X direction. The link mechanism 1124L is arranged on the side of the driving source 1300, and the link mechanism 1124R is arranged on the opposite side. The link mechanism 1124L is a mechanism on the driving side, and the link mechanism 1124R is a mechanism on the driven side. These basically have the same configuration and form a crank mechanism to be described below.

The link mechanisms 1124R and 1124L each include arm members 1301 to 1303. The arm member 1301 rotates around one end portion thereof as the rotation center, and the other end portion is rotatably connected to one end portion of the arm member 1302 via a shaft 1301a. One end portion of the arm member 1301 of the link mechanism 1124L is coaxially fixed to the gear 1314 and rotates together with the gear 1314. One end portion of the arm member 1301 of the link mechanism 1124R is supported to be free to rotate, although not illustrated.

The other end portion of the arm member 1302 is rotatably connected to the intermediate portion of the arm member 1303 via a shaft 1302a. A pair of side plates 1118 are arranged on both side portions of the storage portion 1101 in the X direction. One end portion of the arm member 1303 is rotatably supported on the side plate 1118 via a shaft 1316. The shaft 1316 is located on the same axis as the rotation centerline C1(FIG. 37) so that the rotation of the placement member 1112 synchronizes with the rotation of the arm member 1303.

A guide hole 1118a that has an arc shape and defines the swing track of a swing shaft 1114 is formed in the side plate 1118. The swing shaft 1114 is extended across the storage portion 1101 in the X direction. The swing shaft 1114 is disposed between the other end portions of the arm members 1303 of the link mechanisms 1124R and 1124L.

In a state in which the tray 1110 is attached to the storage portion 1101, the swing shaft 1114 engages with the engaging member 1134. Since the engaging member 1134 has a C shape open to one side (rear side) in the Y direction, at the time of attachment/detachment of the tray 1110, the swing shaft 1114 does not hinder it. When the tray 1110 is attached to the storage portion 1101, the swing shaft 1114 engages with the engaging member 1134 in the Z direction. When the tray 1110 is detached from the storage portion 1101, the engagement between the swing shaft 1114 and the engaging member 1134 is canceled.

The biasing member 1304 is provided between the other end portion of the arm member 1303 of the link mechanism 1124L and the adjacent side plate 1118. The biasing member 1304 is an elastic member such as a coil spring and generates a biasing force to the arm member 1303 in a direction in which the placement member 1112 is located at the maximum rotation position. A similar biasing member may be provided between the other end portion of the arm member 1303 of the link mechanism 1124R and the adjacent side plate 1118.

In FIG. 46B, if the driving source 1300 is one-directionally driven in the direction of an arrow A, the rotary motion of the motor shaft is converted into the swing motion of the swing shaft 1114 via the driving mechanism 1122, and the swing shaft 1114 is reciprocally continuously operated in the directions of arrows B and C. Along with the operation of the swing shaft 1114, the placement member 1112 and the container 1200 set in it rotate, and the ink contained in the container 1200 is stirred. As handling to the stirring, the placement member 1112 may be rotated continuously between the initial position and the maximum rotation position, or may be stopped at the maximum rotation position or the initial position for a predetermined time and rotated.

The biasing member 1304 is configured to bias the placement member 1112 to the maximum rotation position. As for the rotation of the placement member 1112 from the initial position to the maximum rotation position, the driving force of the driving source 1300 is minimum, and power consumption can be reduced. A sensor 1315 is a senor that detects the posture of the placement member 1112. The sensor 1315 is an optical sensor configured to detect the position of the arm member 1301, and is arranged to detect the arm member 1301 when the placement member 1112 is at the initial position.

When exchanging the container 1200, the placement member 1112 can be held at the initial position by exciting the driving source 1300 in a state in which the placement member 1112 is located at the initial position. This enables the insertion/removal operation of the tray 1110. The sensor 1315 is not limited to an optical sensor, and an encoder sensor that detects an angle or a sensor of another method of directly detecting the placement member 1112 may be used.

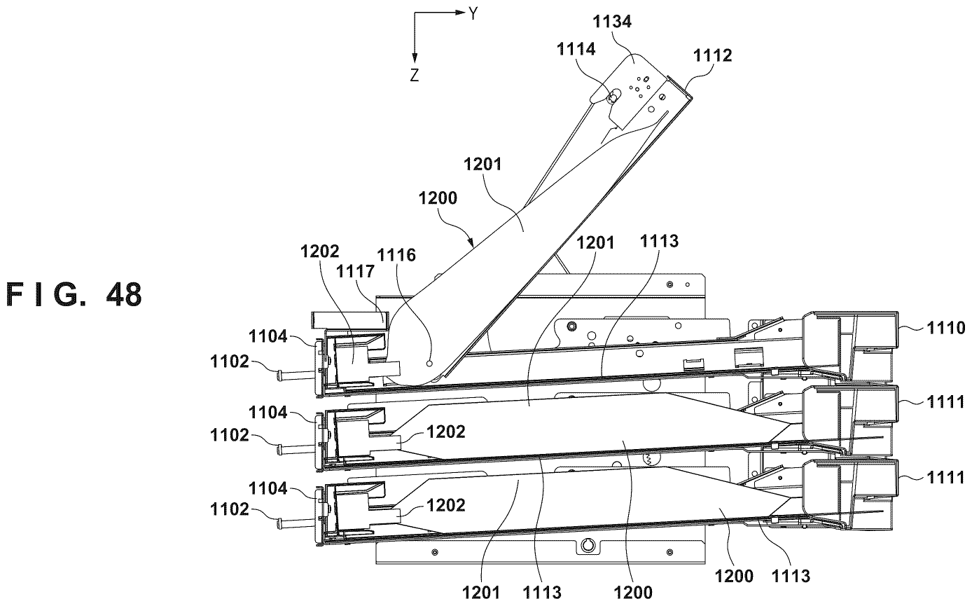

The posture of the container 1200 at the time of stirring will be described. FIG. 48 is a view showing the posture of the container 1200 at the maximum rotation position. According to the configuration of this embodiment, the container portion 1201 of the container 1200 is rotated with respect to the connecting portion 1202, and the connecting portion 1202 itself substantially stands still. More specifically, the rotation centerline C1of the placement member 1112 is apart from the connecting portion 1202 in the Y direction and passes through the container portion 1201. Hence, the container 1200 does not rotate as a whole, and the container portion 1201 rotates such that the container 1200 is bent with respect to the rotation centerline C1as the boundary. Also, the connecting portion 1202 is held by the holding portion 1150, and additionally, a regulating member 1117 that regulates the displacement of the connecting portion 1202 is provided above the connecting portion 1202. The regulating member 1117 regulates the displacement of the connecting portion 1202 in a direction (the Z direction in this embodiment) crossing the connection direction (the Y direction in this embodiment) between the connecting portion 1202 and the connecting unit 1104. Because of the existence of the regulating member 1117, even if the connecting portion 1202 is going to rise upward during the stirring operation, the displacement is regulated as it abuts against the regulating member 1117.

With this structure, the connecting portion 1202 itself substantially stands still and, therefore, the connecting unit 1104 also stands still. The tube connected to the tube connecting pipe 1102 of the connecting unit 1104 is not repetitively deformed. This also has little effect on the connection state between the connecting portion 1202 and the connecting unit 1104. It is therefore possible to suppress fatigue of a member that forms such a path.

### (Example of Processing)

An example of processing in a case where the liquid supply apparatus 1100 is controlled by a control unit 303 will be described. Concerning the stirring operation according to this embodiment, an example of processing executed by the control unit 303 will be described. Like the ninth embodiment, in this embodiment as well, the moving stroke of the swing shaft 1114 is not changed between the tilting operation and the recovery operation, but the operation time is changed. The time of the recovery operation is shorter than that of the tilting operation. More specifically, the time required for the placement member 1112 to move from the maximum rotation position to the initial position is shorter than the time required for the placement member 1112 to move from the initial position to the maximum rotation position in the reverse operation. When the time of the recovery operation is relatively short, the fluidity of the liquid, particularly, the color material inside the container portion 1201 can be increased. When the time of the tilting operation is relatively long, the color material that has started flowing by the recovery operation can be diffused to a more distant point. After the diffusion of the color material by the recovery operation is performed to the more distant point, movement by the weight of the color material is performed in the next tilting operation. Hence, the stirring efficiency of the liquid in the container portion 1201 can be improved.

An operation time T11 of the tilting operation is, for example, 0.3 sec or more and 0.8 sec or less. The ratio of the operation time T11 of the tilting operation to an operation time T12 of the recovery operation is a ratio in the range of, for example, 1.5:1.0 to 3.0:1.0. In this embodiment, since the container 1200 is attached to the storage portion 1101 in such a posture that the connecting portion 1202 is tilted downward in the Z direction, the stirring efficiency can be improved by making the operation time T12 of the recovery operation shorter. In addition, when the operation time T11 of the tilting operation is set to 0.3 sec or more, color material movement by the weight is sufficiently be performed.

As an example, the operation times T11 and T12 are adjusted by changing the driving condition of the motor 1300 between tilting operation and the recovery operation. In this embodiment, the operation times are adjusted by the rotation speed of the motor 1300. In the recovery operation, the rotation speed of the motor 1300 is made higher than in the tilting operation. When the rotation speed of the motor 1300 is made low in the tilting operation, the load of the motor 1300 decreases, and power consumption can be reduced.

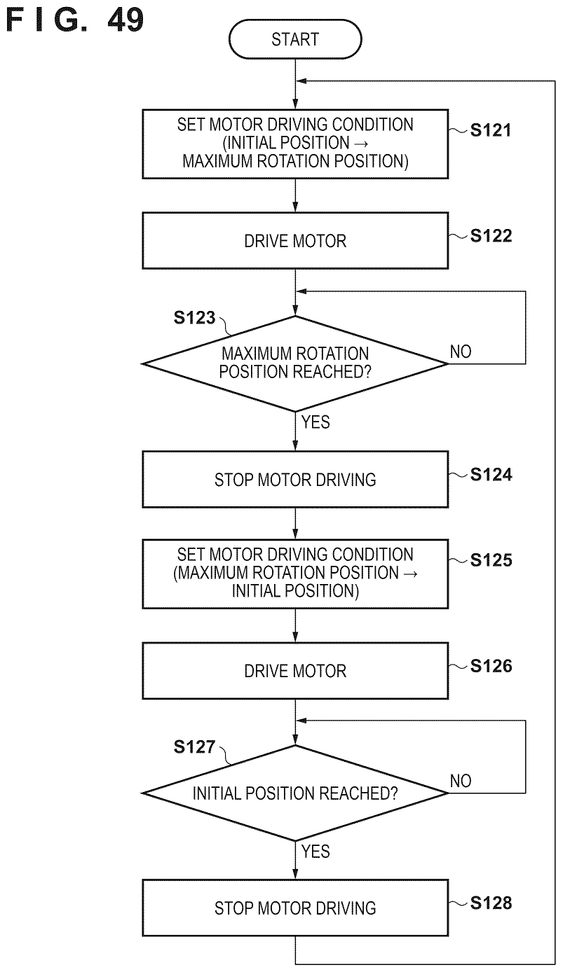

FIG. 49 is a flowchart showing an example of processing of the control unit 303 associated with the stirring operation according to this embodiment, and this is started in, for example, step S2 of FIG. 26. In the example of the processing shown in FIG. 49, the processing is assumed to be started when the placement member 1112 is located at the initial position, and the processing is repetitively executed until it is determined in step S3 of FIG. 26 that an end condition is satisfied.

In step S121, the driving condition of the motor 1300 is set. Here, a rotation speed V11 of the motor 1300 in the tilting operation is set. In step S122, the motor 1300 is driven based on the driving condition set in step S121. The placement member 1112 moves to a state shown in FIG. 47B or 48, and the liquid in the container portion 1201 flows to the side of the connecting portion 1202.

In step S123, it is determined whether the placement member 1112 reaches the maximum rotation position. This determination can be done based on the rotation amount of the motor 1300 or the driving time of the motor 1300. Upon determining that the placement member 1112 reaches the maximum rotation position, the process advances to step S124.

In step S124, driving of the motor 1300 is stopped. In step S125, the driving condition of the motor 1300 is set. Here, a rotation speed V12 (>V11) of the motor 1300 in the recovery operation is set. In step S126, the motor 1300 is driven based on the driving condition set in step S125. The placement member 1112 moves to a state shown in FIG. 41 or 47A, and the liquid in the container portion 1201 flows.

In step S127, it is determined whether the placement member 1112 reaches the initial position. This determination can be done based on the rotation amount of the motor 1300 or the driving time of the motor 1300. Upon determining that the placement member 1112 reaches the initial position, the process advances to step S128. In step S128, driving of the motor 1300 is stopped.

The above-described processing is repetitively executed until it is determined in step S3 of FIG. 26 that the end condition is satisfied. Upon determining that the end condition is satisfied, the processing shown in FIG. 49 may be ended after the placement member 1112 moves to the initial position.

### <Modification of 11th Embodiment>

In the processing shown in FIG. 49, driving of the motor 1300 is stopped in steps S124 and S128. However, the rotation speed may be switched without stopping driving.

In this embodiment, as described above, since the container 1200 is attached to the storage portion 1101 in such a posture that the connecting portion 1202 is tilted downward in the Z direction, the stirring efficiency can be improved by making the operation time T12 of the recovery operation longer. In this viewpoint, the stirring efficiency can be improved if the rotation speed V12 is lower.

In the processing shown in FIG. 49, the rotation speeds V11 and V12 have been exemplified as the driving condition of the motor 1300. However, the difference of the driving condition between the tilting operation and the recovery operation may be the difference of the average rotation speed.

In the processing shown in FIG. 49, the operation times T11 and T12 are adjusted by changing the driving condition of the motor 1300 but may be structurally changed by, for example, the mechanism of the driving unit 1120.

The operation direction of the lock member 1133 engaging with or disengaging from the engaging member 1134 in the operation of the lock mechanism 1131 is not limited to the above-described example. Instead of rotating in the rotation direction RR or RL, the lock member 1133 may rotate using the Z direction as the rotation axis or slide in the Y direction.

In addition, the operation form of unlocking the lock mechanism 1131 is not limited to the above-described example. In place of an operation form of unlock by the unlock member 1137 along with the insertion operation of the tray 1110, the lock mechanism 1131 may be unlocked along with the lock operation of the operation member 1103.

Also, the configuration of setting the container 1200 in the tray 1110 is not limited to the above-described configuration. For example, in the rear wall portion 1113d, only the peripheral part of the holding portion 1150 need not be recessed in the Z direction. The whole region of the rear wall portion 1113d may be at the same height as the height of the engaging portions 1250. Even in this configuration, in a state in which the container 1200 is arranged on the tray 1110, the connecting portion 1202 projects in then Z direction on the periphery of the holding portion 1150. Hence, the user can hold the projecting connecting portion 1202.

Also, the tray 1110 may have a shape projecting upward in the Z direction, and the connecting portion 1202 may have a concave shape corresponding to the projecting shape or a through hole shape and may be guided in attachment. In this case, for example, a plurality of guide structures may be provided, and these may be apart from each other in the X direction.

In addition, the engaging portions 1251 may be provided at positions different from the engaging portions 1250 in the connecting portion 1202. In this case, for example, the engaging portions 1251 may be provided on the lower portion or on the side surface portions such that, for example, these hardly impede the operation of the user.

In addition, the engaging portions 1152 and the engaging portions 1250 may be provided at different portions. For example, these may be provided on both sides of the tray 1110 in the X direction. Alternatively, a plurality of engaging portions may be provided in the Z direction. This can increase the engaging force and stabilize these.

Also, the engaging portions 1153 may have a configuration other than that of the embodiment. For example, a structure including an elastic member such as a spring may be provided on the rear wall portion 1113d, and this may be engaged in guiding. Alternatively, a movable member that can engage with the engaging portion 1251 may be provided on the rear wall portion 1113d and engaged by a user operation after guide.

Also, the engaging portion 1153 and the engaging portion 1251 may be provided on a part of one surface or the other surface of the rear wall portion 1113d and the connecting portion 1202 in the X direction, and the engaging portion 1152 may engage by displacing in the X direction at the time of guide. Additionally, a structure in which the engaging portion 1251 is displaced to engage at the time of guide may be provided.

The placement member 1112 may rotate from the initial position close to a horizontal posture to the lower side. This can improve the efficiency of stirring a pigment that has sedimentability and settles down around the connecting portion 1202. In this configuration, the tray 1110 is attached/detached to/from the storage portion of the lowermost stage among the plurality of storage portions 1101 arranged in the vertical direction, and the ink in the container 1200 mounted on the tray 1110 may be stirred. The rotation direction of the placement member 1112 may be not the up/down direction but the left/right direction. The placement member 1112 may be stopped at a plurality of rotation positions.

Also, as the configuration for rotating the placement member 1112, the placement member 1112 may be rotated only by the arm member 1303, a rotation cam may be used, or another mechanism such as a mechanism using a linear actuator may be used.

### 12th Embodiment

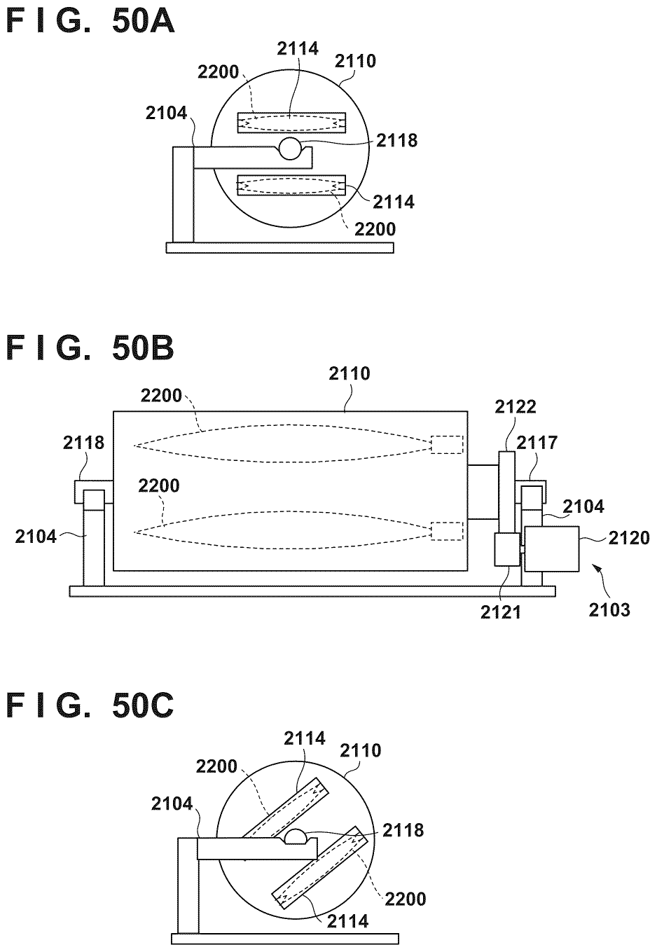

In the 11th embodiment, the container portion 1201 is rotated with respect to the connecting portion 1202. Like the stirring unit 100 according to the first embodiment, the entire container 1200 may be rotated in the stirring operation. FIGS. 50A to 50C are views showing an example of the configuration.

In the example shown in FIGS. 50A to 50C, storage portions 2114 of two stages are provided on the upper and lower sides of a drum 2110 having a cylindrical shape. Each storage portion 2114 forms a slot extending in the axial direction of the drum 2110, and a container 2200 is stored there. The container 2200 may be stored via a tray.

The drum 2110 includes a shaft 2117 at the rear end and a shaft 2118 at the front end in the axial direction, and each of these is axially supported by a bearing 2104. The bearing 2104 is a beam portion extending horizontally and is configured to rotatably support the shaft 2117 or 2118. At the initial position of the drum 2110 shown in FIG. 50A, the beam portion and the shafts 2117 and 2118 are located between the storage portions 2114 of the two stages and are configured not to largely impede insertion/removal of the container 2200 into/from the storage portions 2114.

A driving unit 2103 rotates the drum 2110, thereby changing the posture of the container 2200 between an initial position shown in FIG. 50A and a maximum rotation position shown in FIG. 50C. The driving unit 2103 includes a motor 2120 that is a driving source, a gear 2121 fixed to the output shaft of the motor 2120, and a gear 2122 fixed to the drum 2110, and the drum 2110 is rotated by driving the motor 2120. Control is performed such that the operation time of a rotation operation from the maximum rotation position to the initial position is shorter than the operation time of a rotation operation from the initial position to the maximum rotation position.

### <Other Embodiments>

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2024-190075, filed Oct. 29, 2024, and No. 2024-192416, Oct. 31, 2024, which are hereby incorporated by reference herein in their entirety.

What is claimed is:

1. A liquid supply apparatus comprising:
a holding unit configured to hold a container that contains a liquid;
a stirring unit configured to stir the liquid; and
a control unit configured to control the stirring unit based on air temperature information.

2. The apparatus according to claim 1, wherein
the holding unit is configured to detachably hold the container.

3. The apparatus according to claim 1, wherein
the control unit is configured to acquire, as the air temperature information, a detection result of a detection unit configured to detect an air temperature.

4. The apparatus according to claim 1, wherein
the control unit is configured to select a stirring condition from a plurality of stirring conditions based on the air temperature information and control the stirring unit based on the selected stirring condition.

5. The apparatus according to claim 4, wherein
the plurality of stirring conditions include a first stirring condition and a second stirring condition of stirring performance lower than the first stirring condition.

6. The apparatus according to claim 5, wherein
the control unit is configured to
select the second stirring condition if the air temperature information is not less than a predetermined temperature, and
select the first stirring condition if the air temperature information is less than the predetermined temperature.

7. The apparatus according to claim 5, wherein
the control unit is configured to
select the second stirring condition if a state in which the air temperature information is not less than a predetermined temperature continues for a first time, and
select the first stirring condition if a state in which the air temperature information is less than the predetermined temperature continues for a second time.

8. The apparatus according to claim 5, wherein
a stirring operation of the stirring unit is an operation of repeating a pressing operation and a pressing relaxing operation for the container, and
in the plurality of stirring conditions, at least one of a count, an execution rate, and a frequency of the operation is different.

9. The apparatus according to claim 5, wherein
a stirring operation of the stirring unit is an operation of rotating the container, and
in the plurality of stirring conditions, at least one of a count, an execution rate, and a period of the operation is different.

10. The apparatus according to claim 1, further comprising a connecting unit connected to the container and configured to form a path to flow out the liquid from the container,
wherein the stirring unit comprises a driving unit configured to change a posture of the container,
the driving unit performs a first operation of changing the posture of the container and a second operation that is an operation of returning the posture of the container to an original posture, and
an operation time of the first operation and an operation time of the second operation are different.

11. The apparatus according to claim 10, wherein
the driving unit comprises a motor as a driving source, and
a rotation speed of the motor in the first operation is different from the rotation speed of the motor in the second operation.

12. The apparatus according to claim 10, wherein
the first operation is an operation of changing the posture of the container such that the liquid contained in the container flows to an end portion of the container, and
the operation time of the first operation is shorter than the operation time of the second operation.

13. The apparatus according to claim 10, wherein
the container has flexibility,
the first operation is a pressing operation for the container;
the second operation is a pressing relaxing operation for the container, and
the operation time of the first operation is shorter than the operation time of the second operation.

14. The apparatus according to claim 13, further comprising a support unit including a placement surface on which the container is placed and configured to support the container,
the stirring unit includes a pressing portion arranged facing the placement surface,
the pressing operation is an operation of moving the pressing portion from a first position to a second position,
the pressing relaxing operation is an operation of moving the pressing portion from the second position to the first position,
the first position is a position farther apart from the placement surface than the second position, and
the second position is a position to press the container to a side of the placement surface.

15. The apparatus according to claim 13, wherein
the driving unit is configured to alternately repeat the pressing operation and the pressing relaxing operation.

16. The apparatus according to claim 13, wherein
the container includes a container portion having flexibility, and a connecting portion provided at one end portion of the container portion and connected to the connecting unit, and
in the pressing operation, the container portion is pressed at a portion between the one end portion of the container portion and the other end portion of the container portion.

17. The apparatus according to claim 10, wherein
the first operation is an operation of changing the posture of the container such that the liquid contained in the container flows to an end portion of the container, and
the operation time of the second operation is shorter than the operation time of the first operation.

18. The apparatus according to claim 10, wherein
the first operation is an operation of rotating at least a part of the container from a first position to a second position,
the second operation is an operation of rotating at least the part of the container from the second position to the first position, and
the operation time of the second operation is shorter than the operation time of the first operation.

19. The apparatus according to claim 10, wherein
the container includes a container portion having flexibility, and a connecting portion provided at one end portion of the container portion and connected to the connecting unit,
the first operation is an operation of rotating the container portion from a first position to a second position with respect to the connecting portion,
the second operation is an operation of rotating the container portion from the second position to the first position with respect to the connecting portion, and
the operation time of the second operation is shorter than the operation time of the first operation.

20. The apparatus according to claim 19, wherein
the first position is a position at which the container portion is close to a horizontal posture as compared to the second position.

21. The apparatus according to claim 19, wherein the container is placed on a tray and detachably stored in the holding unit,
the tray comprises:
a tray main body; and
a placement member which is rotatably supported by the tray main body and on which the container portion is placed, and
the driving unit is configured to rotate the placement member.

22. A system comprising a liquid discharge apparatus configured to discharge a liquid to a medium, and a liquid supply apparatus configured to supply the liquid from a liquid container to the liquid discharge apparatus,
wherein the liquid supply apparatus comprises:
a holding unit configured to hold a container that contains the liquid;
a stirring unit configured to stir the liquid; and
a control unit configured to control the stirring unit based on air temperature information.

23. A control method of a liquid supply apparatus including a holding unit configured to hold a container that contains a liquid, and a stirring unit configured to stir the liquid, the method comprising:
controlling the stirring unit based on air temperature information.

24. A non-transitory computer-readable storage medium that stores a program configured to cause a computer to execute a control method of a liquid supply apparatus including a holding unit configured to hold a container that contains a liquid, and a stirring unit configured to stir the liquid, the method comprising:
controlling the stirring unit based on air temperature information.
